(19) United States
(12) Patent Application Publication
(10) Pub. No.: US 2026/0370804 A1
(43) Pub. Date: Nov. 19, 2026

(54) DECODING METHOD, ENCODING METHOD, AND STORAGE MEDIUM

(71) Applicant: GUANGDONG OPPO MOBILE TELECOMMUNICATIONS CORP., LTD., Dongguan (CN)

(72) Inventors: Lai ZHANG, Dongguan (CN); Fan WANG, Dongguan (CN); Yue YU, Dongguan (CN)

(21) Appl. No.: 19/721,102

(22) Filed: Jun. 26, 2026

Related U.S. Application Data
(63) Continuation of application No. PCT/CN2023/142901, filed on Dec. 28, 2023.

(51) Int. Cl. H04N 19/105; H04N 19/159; H04N 19/176; H04N 19/192; H04N 19/52; H04N 19/70

(52) U.S. Cl. CPC H04N 19/105; H04N 19/159; H04N 19/176; H04N 19/192; H04N 19/52; H04N 19/70

(57) ABSTRACT

A decoding method is provided. First syntax element information is determined by parsing. At least one first block vector candidate for a current block is determined when the first syntax element information indicates that a template matching prediction (TMP)-based prediction mode is to be applied to the current block, where the at least one first block vector candidate is determined according to a first type of candidate determined based on template matching and/or a second type of candidate determined based on a merge candidate. At least one second block vector candidate is determined based on the at least one first block vector candidate, where the at least one second block vector candidate includes a relocated block vector constructed for a first candidate in the at least one first block vector candidate. A prediction value for the current block is determined based on the at least one second block vector candidate.

### CROSS-REFERENCE TO RELATED APPLICATION(S)

This application is a continuation of International Application No. PCT/CN2023/142901, filed Dec. 28, 2023, the disclosure of which is hereby incorporated by reference in its entirety.

### TECHNICAL FIELD

Embodiments of the disclosure relate to the field of video coding technology, and in particular, to a decoding method, an encoding method, and a storage medium.

### BACKGROUND

In the related art, for Intra template matching prediction (IntraTMP), prediction can be completed through template matching within a predefined search region, where the search region can depend on factors such as the position and the size of a current block. In IntraTMP with merge candidates technology, it is proposed that a merge list is constructed to serve as candidate blocks for a search process, and motion information of neighbouring coded blocks is utilized, which effectively improves performance of IntraTMP search, thereby improving encoding efficiency.

However, candidate block vectors in the above IntraTMP technology are derived based on template matching or a merge list, which results in low diversity of candidate block vectors, thus affecting coding efficiency.

### SUMMARY

In a first aspect, a decoding method is provided in embodiments of the disclosure. The method is applied to a decoder. The method includes the following. A bitstream is parsed to determine first syntax element information. At least one first block vector candidate for a current block is determined when the first syntax element information indicates that a template matching prediction (TMP)-based prediction mode is to be applied to the current block, where the at least one first block vector candidate is determined according to a first type of candidate determined based on template matching and/or a second type of candidate determined based on a merge candidate. At least one second block vector candidate is determined based on the at least one first block vector candidate, where the at least one second block vector candidate includes a relocated block vector constructed for a first candidate in the at least one first block vector candidate. A prediction value for the current block is determined based on the at least one second block vector candidate.

In a second aspect, an encoding method is provided in embodiments of the disclosure. The method is applied to an encoder. The method includes the following. A prediction mode to be applied to a current block is determined, and first syntax element information is determined according to the prediction mode to be applied to the current block, where the first syntax element information indicates whether a template matching prediction (TMP)-based prediction mode is to be applied to the current block. At least one first block vector candidate for the current block is determined when the prediction mode for the current block is the TMP-based prediction mode, where the at least one first block vector candidate is determined according to a first type of candidate determined based on template matching and/or a second type of candidate determined based on a merge candidate. At least one second block vector candidate is determined based on the at least one first block vector candidate, where the at least one second block vector candidate includes a relocated block vector constructed for a first candidate in the at least one first block vector candidate. A prediction value for the current block is determined based on the at least one second block vector candidate.

In a third aspect, a non-transitory computer-readable storage medium is provided in embodiments of the disclosure. The computer-readable storage medium stores a computer program and a bitstream. When executed by a processor, the computer program causes the processor to implement the encoding method of the second aspect to generate the bitstream.

### BRIEF DESCRIPTION OF THE DRAWINGS

FIG. 1 is a block diagram of an optional hybrid encoding framework provided in embodiments of the disclosure.

FIG. 2 is schematic diagram I illustrating optional template matching in Intra template matching prediction (IntraTMP) technology provided in embodiments of the disclosure.

FIG. 3 is a schematic diagram of illustrating optional determination of a matching block of a current block provided in embodiments of the disclosure.

FIG. 4A is a schematic diagram I illustrating an optional template type in IntraTMP technology provided in embodiments of the disclosure.

FIG. 4B is a schematic diagram II illustrating an optional template type in IntraTMP technology provided in embodiments of the disclosure.

FIG. 4C is a schematic diagram III illustrating an optional template type in IntraTMP technology provided in embodiments of the disclosure.

FIG. 4D is a schematic diagram IV illustrating an optional template type in IntraTMP technology provided in embodiments of the disclosure.

FIG. 4E is a schematic diagram V illustrating an optional template type in IntraTMP technology provided in embodiments of the disclosure.

FIG. 4F is a schematic diagram VI illustrating an optional template type in IntraTMP technology provided in embodiments of the disclosure.

FIG. 5A is schematic diagram II illustrating optional template matching in IntraTMP technology provided in embodiments of the disclosure.

FIG. 5B is schematic diagram III illustrating optional template matching in IntraTMP technology provided in embodiments of the disclosure.

FIG. 6 is a schematic diagram illustrating optional positions of neighbouring candidates and non-neighbouring candidates for a current block provided in embodiments of the disclosure.

FIG. 7 is schematic diagram I illustrating optional auto-relocated block vectors provided in embodiments of the disclosure.

FIG. 8 is schematic diagram II illustrating optional auto-relocated block vectors provided in embodiments of the disclosure.

FIG. 9 is a schematic diagram illustrating optional IntraTMP fusion prediction provided in embodiments of the disclosure.

FIG. 10 is a schematic structural diagram illustrating an optional filter provided in embodiments of the disclosure.

FIG. 11 is a schematic structural diagram illustrating optional determination of filter coefficients provided in embodiments of the disclosure.

FIG. 12 is a schematic block diagram of an optional encoder provided in embodiments of the disclosure.

FIG. 13 is a schematic block diagram of an optional decoder provided in embodiments of the disclosure.

FIG. 14 is a schematic network architectural diagram of an optional coding system provided in embodiments of the disclosure.

FIG. 15 is a schematic flowchart of an optional decoding method provided in embodiments of the disclosure.

FIG. 16 is a schematic flowchart of an optional encoding method provided in embodiments of the disclosure.

FIG. 17 is a schematic structural diagram of an optional decoder provided in embodiments of the disclosure.

FIG. 18 is a schematic diagram illustrating an optional hardware structure of a decoder provided in embodiments of the disclosure.

FIG. 19 is a schematic structural diagram of an optional encoder provided in embodiments of the disclosure.

FIG. 20 is a schematic diagram illustrating an optional hardware structure of an encoder provided in embodiments of the disclosure.

FIG. 21 is a schematic structural diagram of an optional coding system provided in embodiments of the disclosure.

### DETAILED DESCRIPTION

To facilitate more comprehensive understanding of the features and technical content of embodiments of the disclosure, a detailed explanation of the implementation of embodiments of the disclosure is given below in conjunction with accompanying drawings. The accompanying drawings are for illustration only rather than limiting embodiments of the disclosure.

Unless otherwise defined, all technical and scientific terms used in the disclosure have the same meanings as those commonly understood by those skilled in the technical field that the disclosure relates to. The terminology used in the disclosure is intended only for describing embodiments of the disclosure rather than limiting the disclosure.

In the following illustration, “some embodiments” describes a subset of all possible embodiments. However, it should be understood that, “some embodiments” can be the same subset or different subsets of all possible embodiments and can be combined with each other without conflict.

It should also be pointed out that, terms “first/second/third” used in embodiments of the disclosure are merely for distinguishing similar objects and do not represent a specific order of the objects. It can be understood that, the specific order or sequence of “first/second/third” is interchangeable when allowed, so that embodiments of the disclosure described herein can be implemented in an order other than that illustrated or described herein.

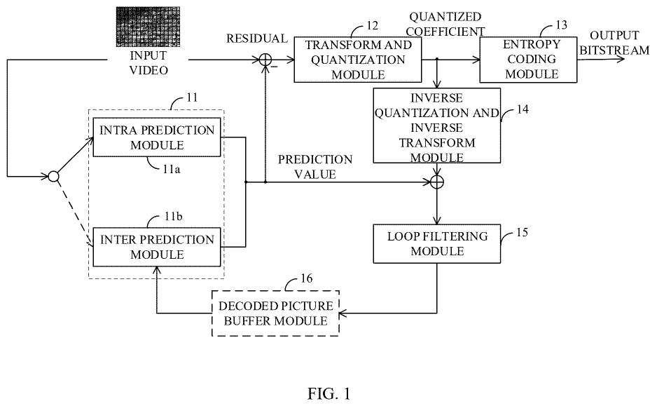

Currently, a block-based hybrid encoding framework is applied in general video coding standards. Each picture or sub-picture or frame in a video is partitioned into square largest coding units or coding tree units (CTUs) of the same size (such as 256×256, 128×128, 64×64, etc.). Each largest coding unit or CTU can be partitioned into rectangular coding units (CUs) according to rules. A CU may be partitioned into prediction units, transform units, and the like. Specifically, as illustrated in FIG. 1, the hybrid encoding framework includes a prediction module 11, a transform and quantization module 12, an entropy coding module 13, an inverse quantization and inverse transform module 14, a loop filtering module 15, and a decoded picture buffer module 16. The prediction module 11 can include an intra prediction module 11a and an inter prediction module 11b, where the inter prediction module 11b can include a motion estimation module and a motion compensation module. Since there is strong correlation between neighbouring samples in a picture of a video, in video coding technology, spatial redundancy between neighbouring samples is removed by applying an intra prediction method. In addition, since there is strong similarity between neighbouring pictures in a video, in video coding technology, temporal redundancy between neighbouring pictures is removed by applying an inter prediction method, thereby improving encoding efficiency.

The basic flow of a video coder is as follows. At an encoding end, a picture is partitioned into blocks, intra prediction or inter prediction is applied to a current block to generate a prediction block for the current block, an original block of the current block is subtracted by the prediction block to obtain a residual block, transform and quantization is performed on the residual block to obtain a quantized coefficient matrix, and entropy coding is performed on the quantized coefficient matrix to output the result into a bitstream. At a decoding end, intra prediction or inter prediction is applied to the current block to generate a prediction block for the current block. On the other hand, the bitstream is parsed to obtain the quantized coefficient matrix, inverse quantization and inverse transform are performed on the quantized coefficient matrix to obtain a residual block, and addition is performed on the prediction block and the residual block to obtain a reconstructed block. The reconstructed blocks form a reconstructed picture, and loop filtering is performed on the reconstructed picture on a picture basis or block basis to obtain a decoded picture. At the encoding end, operations similar to those at the decoding end need to be performed to obtain the decoded picture. The decoded picture can serve as a reference picture for inter prediction of subsequent pictures. Block partitioning information and mode information or parameter information such as prediction, transform, quantization, entropy coding, and loop filtering determined by the encoding end, if necessary, need to be output into the bitstream. At the decoding end, the same block partitioning information and mode information or parameter information such as prediction, transform, quantization, entropy coding, and loop filtering as those at the encoding end is determined by parsing the bitstream and analyzing according to existing information, thereby ensuring that the decoded picture obtained at the encoding end is the same as the decoded picture obtained at the decoding end. The decoded picture obtained at the encoding end is also commonly referred to as a reconstructed picture. During prediction, the current block can be partitioned into prediction units, and during transform, the current block can be partitioned into transform units, where partitioning into prediction units can be different from partitioning into transform units. The above is the basic flow of a video coder under a block-based hybrid encoding framework. With development of technology, some modules or steps of this framework or flow may be optimized. Embodiments of the disclosure are applicable to the basic flow of a video coder under the block-based hybrid encoding framework, but are not limited to such framework and flow.

In addition, in embodiments of the disclosure, a current block (CB) can be a current CU, a current prediction unit, or a current transform unit, etc. Due to the need for parallel processing, a picture can be partitioned into slices, etc., and slices in the same picture can be processed in parallel, that is, there is no data dependency between the slices. “Frame” is a commonly used term, and it can generally be understood that one frame is one picture. The frame described in embodiments of the disclosure can also be replaced by “picture” or “slice”, etc.

Digital video compression technology mainly refers to compressing huge digital video data for ease of transmission and storage. That is, digital video compression technology is a technology in which storage space and transmission bandwidth is saved by reducing the amount of video data. Video data typically occupies a large amount of space, and with compression technology, file size can be effectively reduced while keeping quality loss imperceptible to human eyes. With proliferation of Internet videos and increasing demand for higher video definition, although a considerable amount of video data can be saved in existing digital video compression standards, there is still need for pursuit of better digital video compression technology to reduce bandwidth and traffic pressure for digital video transmission.

Video compression generally relies on specific coding standards. Common video coding standards include H.264/advanced video coding (AVC), H.265/high efficiency video coding (HEVC), video processor 9 (VP9), AOmedia video 1 (AV1), and the like. These standards define algorithms and specifications for video compression, thereby ensuring compatibility of video across different devices. Video compression technology is mainly classified into intra-frame compression and inter-frame compression. Intra-frame compression relies on coding of a single video frame, whereas inter-frame compression utilizes similarity between frames. In inter-frame compression, motion compensation is a key technology. By detecting motion in a neighbouring frame and predicting positions of samples based on motion information, data volume can be reduced while maintaining video quality. Quantization is a process of mapping sample values in a picture or video onto a smaller set, thereby reducing the representation range of data. Entropy coding refers to optimizing the coding process by utilizing statistical information in data, to further reduce data volume. Typically, there are spatial and temporal correlations between neighbouring samples in a video. By means of a compression algorithm, these correlations are exploited to reduce data redundancy through prediction and differential coding. With compression technology, users are usually allowed to select different resolutions and bit rates while maintaining acceptable quality. As such, it is conducive to better adaptation to different requirements during storage and transmission. Certain applications have high requirements on real-time performance of video transmission, such as video conferencing, real-time surveillance, and the like. Therefore, some compression standards and technologies focus on providing low-latency solutions. Generally speaking, digital video compression technology has been widely applied in the multimedia field, which not only influences efficiency of video storage and transmission, but also has positive impact on user experience of video applications.

Video compression includes multiple modules, such as intra prediction (spatial domain) and/or inter prediction (temporal domain) for reducing or removing inherent redundancy in videos, transform and quantization as well as inverse quantization and inverse transform of residual information, loop filtering for improving subjective and objective reconstruction quality, and entropy coding. Mainstream video compression standards mostly describe block-based compression technologies. A video slice, a picture, or a sequence of pictures is partitioned into basic units of CTUs, and CTUs are partitioned into blocks in units of CUs. An intra block is predicted by using neighbouring samples around the block as reference, while for an inter block, reference is made to spatial neighbouring block information and reference information in other pictures. Compared with a prediction signal, residual information is transformed, quantized, and entropy coded on a block basis and then encoded into a bitstream. These technologies are described in standards and implemented in various fields related to video compression. Internationally, current mainstream standards include H.264/AVC, H.265/HEVC standard, H.266/versatile video coding (VVC), and extensions of these standards, etc. Video devices can implement these technologies to achieve more efficient video coding, transmission, and storage.

In some embodiments, digital video is video recorded in digital form, which consists of digital pictures. Each picture consists of several rows and several columns of samples, and each sample is represented by a digitized numerical value. To express colours observed by human eyes, a series of different colour models have been defined mathematically, including RGB, YUV, etc. To map these colour models onto corresponding mathematical expressions, different colour spaces have emerged with regard to different processing methods and storage formats for different colour data. A colour space is a specific form of colour organization, and a colour space defines a way to represent and organize colour information. Different colour spaces use different coordinate systems or parameters to describe colours, which facilitates representation, editing, analysis, and processing of colours.

### 1) Intra Template Matching Prediction (IntraTMP) Technology

IntraTMP technology is a special intra-prediction technology, which is also referred to as IntraTMP for short, and is a special intra-prediction coding tool mainly applied to screen content coding. IntraTMP is implemented mainly through the following procedure: some of reconstructed samples neighbouring a current coding block are selected as a template, the most similar template is searched for within a given reconstructed region of a current picture, and a reconstructed block corresponding to the most similar template is used as a matching block and then used as a prediction block for the current coding block. The template for the coding block is usually chosen from a neighbouring reconstructed region of the current coding block.

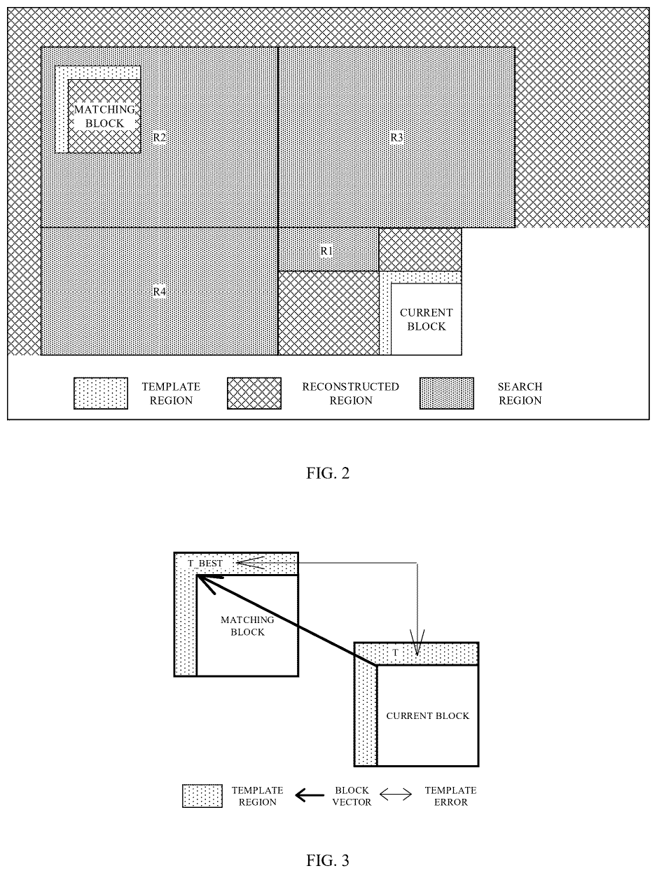

Exemplarily, taking the neighbouring reconstructed region of the current block as an example, as illustrated in FIG. 2, a region filled with grid represents the reconstructed region. In the reconstructed region, R1, R2, R3, and R4 are search regions. Matching block searching is carried out sequentially in the regions R1 to R4. A neighbouring region of the current block serves as a first template (T), and a neighbouring region of a matching block (which can also be referred to as a “reference block”) is a second template (i.e., “reference-block template” or “matching template”, T_BEST). As illustrated in FIG. 3, both an encoder and a decoder search within a predefined search range in the current picture based on a template (T) for the coding block to determine a matching template (T_BEST) with the minimum template error value, and then use a reconstructed block (Ref Block) corresponding to the matching template as the prediction block for the current coding block (Cur Block). The degree of similarity between templates is represented by the magnitude of the template error value, where a smaller template error value corresponds to a higher degree of similarity. In embodiments of the disclosure, the template error value can be a sum of absolute difference (SAD), a sum of absolute transformed difference (SATD), a mean square error (MSE), a sum of squared differences (SSD), a mean absolute deviation (MAD), a mean squared deviation (MSD), a normalized cross-correlation (NCC), etc., which is not specifically limited herein.

Exemplarily, taking the SAD as an example, the template error value in this case is as follows:

$$SAD ( {T}_{i} ) = {\sum }_{m = 0}^{M - 1} \vert {T}_{i , m} - {T}_{m} \vert , m = 0 , 1 , … , M - 1 \qquad ( 1 )$$

Here, Ti represents the template used in the search process, and M represents the number of samples in the template.

It should be noted that, in IntraTMP technology, neighbouring reconstructed samples of the current block are used as a template when searching for the matching template within the predefined search region. The neighbouring reconstructed samples can be top reference samples, top-left reference samples, top-right reference samples, left reference samples, and bottom-left reference samples of the current block, etc. Therefore, with regard to availability of these neighbouring reconstructed samples, the template can be classified into different template types and a corresponding template type can be determined.

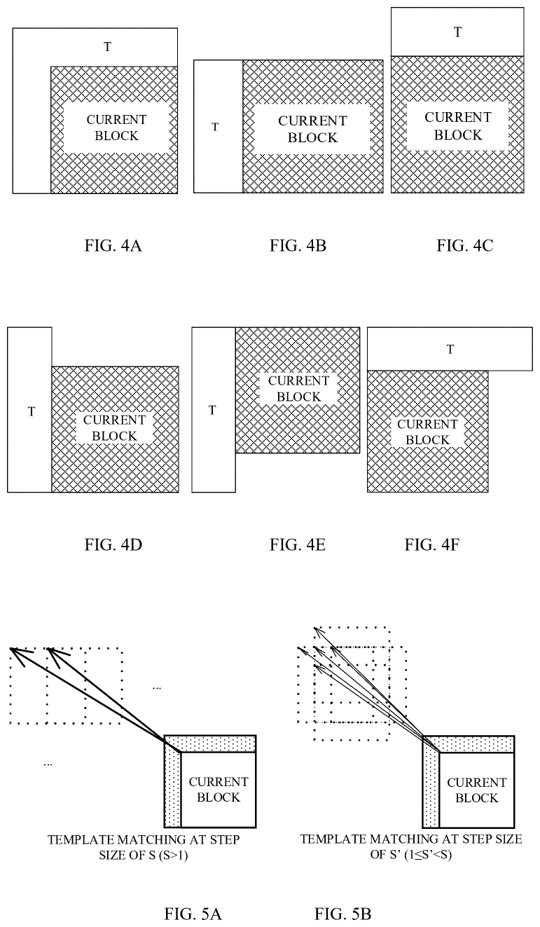

It should also be noted that, the template type can be represented by refTemplate Type. FIGS. 4A, 4B, 4C, 4D, 4E, 4F are schematic diagrams illustrating template types in IntraTMP technology. As illustrated in FIGS. 4A, 4B, 4C, 4D, 4E, 4F, a block filled with grid represents the current block, and the neighbouring region of the current block serves as the template T. Here, six template types are illustrated.

Exemplarily, the six template types are as follows. If the top-left reference samples, the top reference samples, and the left reference samples are all available, the value of refTemplate Type is 1, and the template shape is as illustrated in FIG. 4A. If only the left reference samples are available, the value of refTemplate Type is 2, and the template shape is as illustrated in FIG. 4B. If only the top reference samples are available, the value of refTemplate Type is 3, and the template shape is as illustrated in FIG. 4C. If only the left reference samples and the top-left reference samples are available, the value of refTemplate Type is 4, and the template shape is as illustrated in FIG. 4D. If only the left reference samples and the bottom-left reference samples are available, the value of refTemplate Type is 5, and the template shape is as illustrated in FIG. 4E. If only the top reference samples and the top-right reference samples are available, the value of refTemplate Type is 6, and the template shape is as illustrated in FIG. 4F.

In IntraTMP technology, the coder (that is, encoder/decoder) indicates, via a flag intra_tmp_flag, whether the current coding block is encoded by applying an IntraTMP mode. If the current coding block is encoded by applying the IntraTMP mode, the same template matching procedure is performed at a decoding end to obtain the same prediction block at the decoding end, rather than additionally encode block vector information directed to the matching block from the current coding block. The following provides examples to illustrate IntraTMP technology.

### 2) IntraTMP Adaptation for Camera-Captured Content Technology

On the basis of the conventional IntraTMP technology, in IntraTMP adaptation for camera-captured content technology, template matching at a step size of S (i.e., template matching is performed every S samples horizontally and vertically, where S>1) is proposed (as illustrated in FIG. 5A). For instance, in the search region, a matching block is searched for through sub-sampling in both horizontal and vertical directions, instead of searching for a matching block sample by sample through raster scan. For example, if a current block vector for template matching is (X0, Y0), then the next block vector for template matching is (X0+S, Y0), and the vertical coordinate of a block vector for template matching in the next row is Y0+S. After template matching is completed, refinement is performed around the best-matching block within a certain range (as illustrated in FIG. 5B, template matching is performed at a smaller step size S′), thereby optimizing the matching result. With such technology, it is possible to significantly reduce complexity of the IntraTMP mode while maintaining high encoding efficiency.

### 3) IntraTMP Multi-Candidate Technology

In IntraTMP multi-candidate technology, N candidate matching blocks are found in a reference region through template matching, in other words, a candidate block list with a length of N is constructed, and candidate matching blocks in the list can be sorted according to template error values thereof relative to the current block. According to indexes, a specific candidate block is selected from the list as a final prediction block. For a coding block to which IntraTMP multi-candidate technology is applied, after an IntraTMP flag intra_tmp_flag is decoded to be true, intra_tmp_idx is decoded, where the syntax element intra_tmp_idx can indicate the index of the selected candidate block.

intra_tmp_flag
if(intra_tmp_flag)
{
intra_tmp_idx
}

Exemplarily, a template matching procedure for constructing the candidate block list is as follows.

In a first step, a first round of searching is carried out at a certain step size, e.g., horizontal and vertical step sizes of 4, to find N best-matching blocks with certain intervals (the first N blocks with the minimum template error values).

In a second step, a second round of searching is carried out in neighbouring regions of the N matching blocks found in the first step. These neighbouring regions can be set to be multiple non-overlapping regions based on the step size in the first step, to find M best-matching blocks from these regions (which may include the matching block(s) found in the first step).

The encoder and the decoder adopt the same constructing procedure to obtain consistent candidate block lists.

intra_tmp_idx can be encoded through fixed-length coding or variable-length coding, for example, through truncated binary coding.

A variable-length coding method is as follows. A smaller index (a smaller intra_tmp_idx value) corresponds to a smaller template error value of a corresponding candidate block and higher probability of being selected, and shorter codewords can be assigned to intra_tmp_idx with a smaller value, for example, as illustrated in Table 1:

TABLE 1

| | |
|---|---|
| intra_tmp_idx | Binary code |

| | | |
|---|---|---|
| 0 | 1 | |
| 1 | 0 | 1 |
| 2 | 0 | 0 |
| Bin index | 0 | 1 |

If the maximum value N of intra_tmp_idx is relatively large, codewords of the same length can be assigned to intra_tmp_idx with larger values. For example, N=15, as illustrated in Table 2:

TABLE 2

| Intra_tmp_idx | Binary code | | | | |
|---|---|---|---|---|---|
| 0 | 1 | 1 | | | |
| 1 | 1 | 0 | 0 | | |
| 2 | 1 | 0 | 1 | | |
| 3~6 | 0 | x | x | x | |
| 7~14 | 0 | x | x | x | x |

In Table 2 above, x can be obtained through truncated binary coding.

4) IntraTMP with Merge Candidates

In IntraTMP with merge candidates technology, it is proposed that the search process or candidate block vector list for IntraTMP can be expanded based on block vectors for neighbouring blocks of a current coding block. For example, a merge list is constructed for the current coding block with reference to a method for merge list construction in intra block copy (IBC), and the list includes motion information such as block vectors for neighbouring blocks. When performing IntraTMP searching (intra template matching), searching is firstly performed at a certain step size to obtain a candidate block vector list for the first round, which may include N block vectors having the smallest template error values in this round of searching. The candidate block vector list and the merge list are merged to obtain a larger candidate block vector list. The second round of IntraTMP searching can be performed based on the new list (for example, template matching is performed within a neighbouring region of a candidate block vector), to obtain a final IntraTMP candidate block vector list consisting of M block vectors having the smallest template error values in the whole search process.

In addition, candidate block vectors obtained through different processes (for example, obtained from different search regions or obtained from the merge list) can be identified by indexes. Block vectors with different indexes can have neighbouring regions of different sizes during the second round of searching.

### 5) IBC Technology

IBC is an intra prediction technology in which prediction samples are obtained based on block matching. IBC is similar to inter prediction in that prediction is implemented based on a block vector directed to a reference block from a current block. The difference lies in that a reference block in inter prediction comes from a reconstructed picture that has been encoded, while a reference block in IBC comes from a reconstructed part of a current picture. Block vector information needs to be transmitted via a bitstream. Therefore, similar to intra prediction, IBC includes an IBC-advanced motion vector prediction (AMVP) mode and an IBC-Merge mode.

In the IBC-AMVP mode, a prediction block vector is obtained from a constructed merge candidate block vector list. The reference block for the current block and a corresponding final block vector are obtained through procedures such as hash search and full search. The final block vector is encoded based on the prediction block vector, thereby improving encoding efficiency.

In the IBC-Merge mode, prediction is performed based on a constructed merge candidate block vector list. The best merge candidate is selected from the list through encoding procedures such as SATD and RDO, and a block vector for the merge candidate is inherited to obtain a reference block, thereby completing prediction. An index of the merge candidate in the list, rather than the block vector itself, is encoded, thereby improving encoding efficiency.

The merge candidate block vector list can include coding information such as coded blocks at neighbouring and non-neighbouring positions, a history-encoded block, a temporal coded block, an average of candidate block vectors, etc. After the merge candidate list is constructed, the list can be rearranged according to template error values of all candidates in the list. The template error value may be obtained according to a template error value, for example, SAD value, between a reference block template for each candidate and a current block template.

The merge candidate block vector list can include information such as a local illumination compensation (LIC) flag. If an LIC flag for a certain candidate is true, prediction is performed by applying IBC-LIC technology, when the candidate is selected for the current block.

On the basis of the IBC-Merge mode, there is an IBC-merge mode with block vector difference (MBVD) mode. For a BV obtained from a merge candidate, a BVD can be determined according to an offset and a direction, to refine the original BV. For example, if the direction is “up”, the magnitude of the offset is k, and the original BV is BV0=(x0, y0), then the new BV0′ after applying the BVD can be expressed as: BV0′=(x0, y0−k).

### 6) Non-Neighbouring Candidates for Inter-Merge

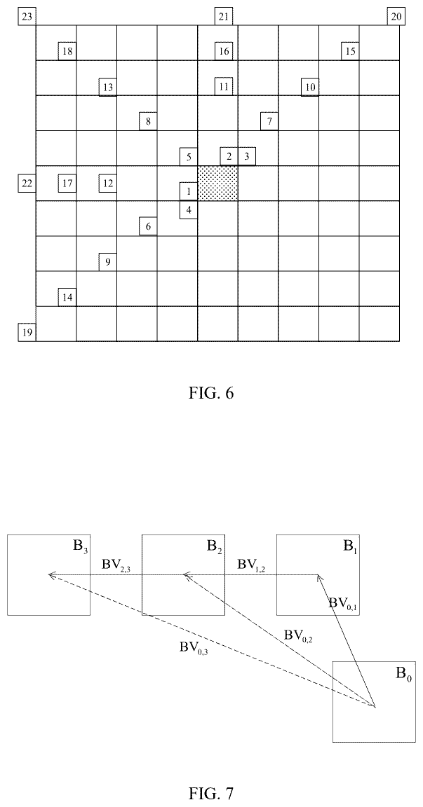

For an inter-coding block for a merge mode, non-neighbouring candidates can be added when constructing a merge list. Non-neighbouring samples are selected based on the size of the current block and used for attempting to construct merge candidates. Positions of the non-neighbouring samples and the current block are illustrated in FIG. 6. In FIG. 6, the dot-filled block is the current block, and candidates at positions marked 1~5 are referred to as neighbouring candidates, while the rest are referred to as non-neighbouring candidates.

### 7) Auto-Relocated Block Vector Prediction (AR-BVP)

In AR-BVP technology, a method of constructing a new block vector based on a block vector for a reference block is proposed. As illustrated in FIG. 7, a guiding block vector (guiding BV) is determined for a current coding block B₀, and a reference block B₁ is determined according to the block vector. If the reference block B₁ has a block vector BV_{1,2} (a motion vector corresponding to a block with the maximum similarity or a motion vector corresponding to a block with the best matching template within the surrounding region of B1), a new block vector BV_{0,2}=BV_{0,1}+BV_{1,2} can be constructed as a candidate block vector for the current coding block. Recursively (termination conditions: a certain recursion depth is reached, a block error corresponding to the new block vector constructed is less than a threshold, a preset region is exceeded, a maximum recursion time is satisfied, etc., which can be extended in the specification), a reference block Bn can be determined according to BV_{0,n}, and if Bₙ has a block vector BV_{n,n+1}, a new block vector BV_{0,n+1}=BV_{0,1}+BV_{1,2}+ . . . +BV_{n,n+1} can be constructed.

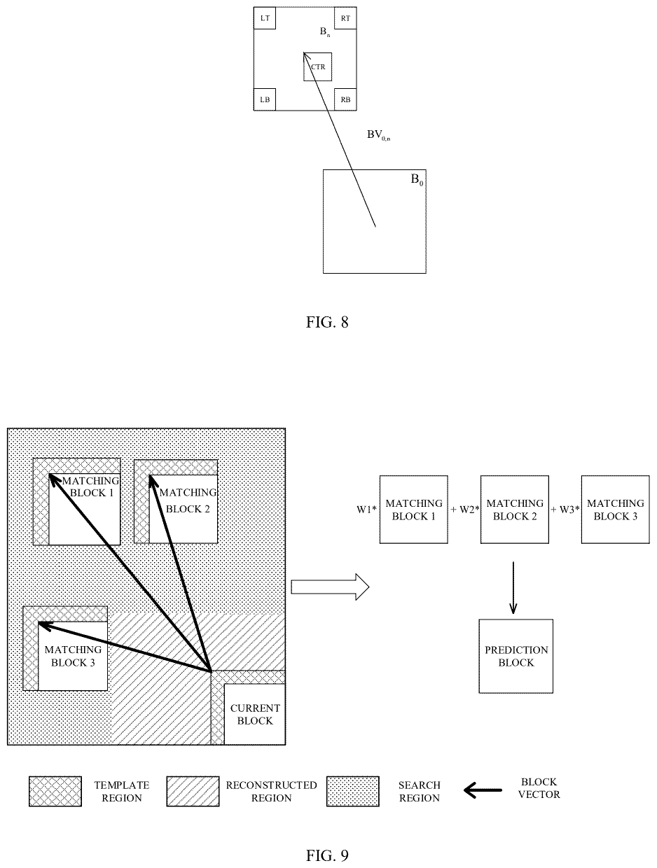

When determining the block vector BV_{n,n+1} corresponding to the reference block Bn, multiple positions can be checked. For example, as illustrated in FIG. 8, whether a coded block predicted by applying an IBC or IntraTMP mode exists at the center (CTR), top-left (LT), top-right (RT), bottom-left (LB), and bottom-right (RB) of the reference block is checked in sequence, and if such block exists, a block vector stored for the block is taken as the block vector BV_{n,n+1}.

### 8) IntraTMP Fusion Prediction Technology

Through intra template matching, template error values between reconstructed blocks at different positions and the current block can be obtained. These reconstructed blocks can be represented by block vectors directed to the reconstructed blocks from the current block. A candidate block vector list is constructed to record block vectors with smaller template error values during template matching. Based on conditions such as block vector distances and template error values, one or more block vectors are selected from the candidate block vector list, and reconstructed blocks that the one or more block vectors are directed to are used as matching blocks for the current block. A weight value is determined for each matching block, and then weighted fusion is performed on the matching blocks according to the weight values for the matching blocks to obtain a final prediction block, thereby realizing IntraTMP fusion prediction. The specific process is illustrated in FIG. 9, where a grid-filled region represents a template region, a slash-filled region represents a reconstructed region, a dot-filled region represents a search region, and an arrow represents a block vector. For the current block, after matching block 1, matching block 2, and matching block 3 are determined according to different block vectors, weighted fusion may be performed on matching block 1, matching block 2, and matching block 3 according to weight value W1, weight value W2, and weight value W3, so as to obtain a prediction block for the current block.

It should be noted that, the number of matching blocks to-be-fused can be a fixed value or determined based on a magnitude relationship of the template error values of the matching blocks. For example, for N available matching blocks, a threshold is set as Threshold=minSAD<<1, where minSAD is the minimum value among the template error values of the matching blocks. Only matching blocks whose template error values are less than or equal to the threshold are selected for fusion. With this method, matching blocks for fusion can be determined.

After the matching blocks for fusion are determined, a weight for each matching block can use preset fixed values or be determined through calculation based on template error values or template derivation.

### 9) IntraTMP Filtering Technology

A matching block (also referred to as reference block) obtained through intra template matching is typically used directly as a prediction block for a current block. Filtering can be performed on the prediction block to improve prediction performance. Whether filtering is to be performed on the prediction block for the current block can be indicated via a block-level flag. The filter can take various forms. One possible filter form is illustrated below:

PredC=c0C+c1N+c2S+c3E+c4W+c5B (2)

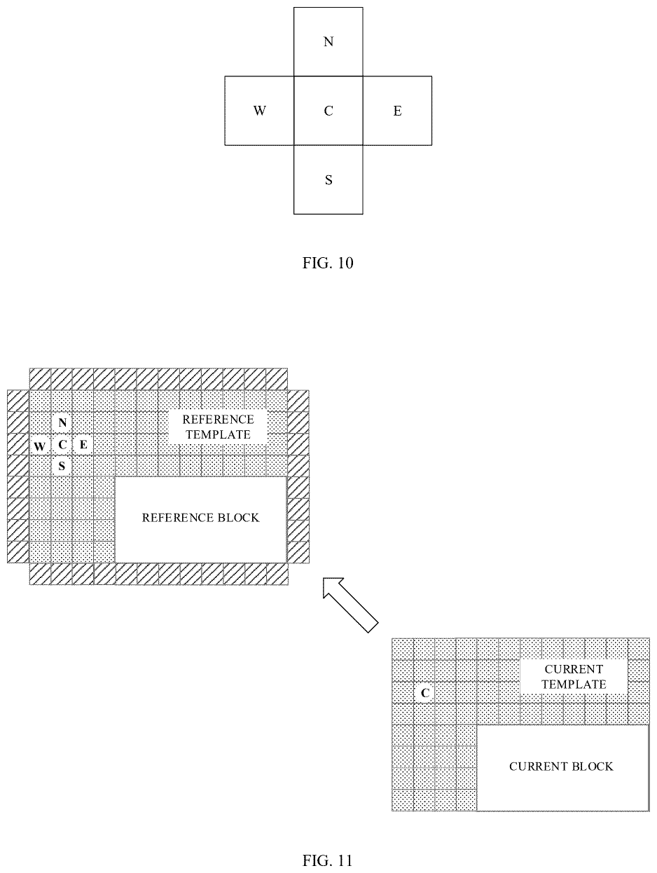

C is a sample on which filtering is to be performed, Nis an upper sample of sample C, S is a lower sample of sample C, W is a left sample of sample C, and E is a right sample of sample C, as illustrated in FIG. 10. B (Bias) is a fixed value, for example, B is the median of the sample range. c0 to c5 are filter coefficients.

In a possible implementation, a method for training filter coefficients is based on a reference-block template and a current-block template. For example, a template region can be a reconstructed region of 4 rows neighbouring the top of the current block and 4 columns neighbouring the left of the current block. For the reference block, one additional row on each side (top, bottom, left, and right) of the template region is also needed as reference. As illustrated in FIG. 11, if part of the additional region is not yet encoded, it can be copied from the template region. In FIG. 11, the slash-filled regions represent regions of additional rows on the top, the bottom, the left, and the right of the reference template region.

In a possible implementation, a method for training filter coefficients is to calculate a set of coefficients that minimizes an MSE between the filtered reference-block template and the current-block template.

If IntraTMP filtering is applied to the current block to perform filtering on the prediction block obtained directly from the reference block, one possible approach is to perform filtering on each sample in the prediction block from left to right and from top to bottom, and the filtered value is used as the prediction value.

### 10) Template Derivation-Based IntraTMP Fusion Technology

In IntraTMP fusion prediction, multiple reference blocks can be obtained through intra template matching, and weighted fusion can be performed on the reference blocks. Weight values are typically predefined fixed values or calculated based on template errors corresponding to the reference blocks. For example, the template error values corresponding to the reference blocks are SAD1 to SADn, and then one way for calculating the weights is illustrated below:

$$SADi = ( SADi == 0 ) ? 1 : SADi \qquad ( 3 )$$

$$SUM = {\sum }_{i = 1}^{n} {SAD}_{i} \qquad ( 4 )$$

$$Wi = ( SUM - SADi ) / ( ( n - 1 ) * SUM ) \qquad ( 5 )$$

n is the total number of reference blocks, and Wi is a weight value corresponding to a reference block with a template error value of SADi. A prediction block after weighted fusion can be expressed below:

$$Pred = {\sum }_{i = 1}^{n} Wn * Predn \qquad ( 6 )$$

The template derivation-based IntraTMP fusion method adopts a method like the method for training filter coefficients, to obtain weights for fusion prediction through training based on reference-block templates and a current-block template. For example, weighted fusion is performed by using 5 reference blocks, which is illustrated below:

$$pred = {\sum }_{n = 0}^{4} {w}_{n} * {refBlock}_{n} + {w}_{5} * Bias \qquad ( 7 )$$

Another way to determine the weights is to calculate a set of coefficients that minimizes an MSE between a fused reference-block template and the current-block template.

11) Adaptive Reordering of Merge Candidates with Template Matching (ARMC-TM)

ARMC-TM technology is mainly applied for inter prediction. In this technology, it is proposed that during construction of a merge list for an inter-predicted block, an error, such as SAD, between a template for each merge candidate and a template for a current block can be calculated, and different merge candidates are reordered according to the errors. A merge candidate located earlier in the list corresponds to a shorter index codeword, thereby improving encoding efficiency. When motion information of a certain merge candidate is bi-prediction, a template for the candidate can also be obtained through bi-prediction.

In addition, in this technology, it is also proposed to divide a merge candidate list into multiple sub-lists, and candidates in each sub-list can be reordered. To reduce complexity, reordering may not be performed on a specific sub-list. For example, if a current sub-list is not the first sub-list but is the last sub-list, reordering is not performed on the current sub-list.

### 12) Template-Based Intra Mode Derivation (TIMD) Technology

In TIMD technology, an L-shaped region of reconstructed samples neighbouring a current block is used as a template, and prediction samples for the template region under different intra-prediction modes are calculated by traversing prediction modes in a most probable mode (MPM) list, to obtain template error values between prediction samples and the reconstructed samples under different intra-prediction modes, which are represented by SATD. The optimal intra-prediction mode is selected based on the template error values. At a decoding end, the intra-prediction mode is determined through the same derivation procedure, thereby reducing the number of bits required to encode mode information.

### 13) Combined Inter and Intra Prediction (CIIP) Technology

In CIIP technology, a prediction block for a current block is obtained by combining intra prediction and inter prediction and performing weighted averaging on an intra-prediction block and an inter-prediction block. In enhanced compression model (ECM), CIIP is combined with template-based prediction technology, and different weights are assigned to various regions to improve prediction accuracy. Specifically, the intra-prediction block (pred_intra) is obtained based on a TIMD mode, while the inter-prediction block (pred_inter) is obtained based on a template-based merge mode. The weights (wIntra, wInter) are determined based on an intra-prediction mode derived and positions of samples to-be-predicted. The final prediction block (Pred) is calculated as follows:

Pred=(wIntra*pred_intra+wInter*pred_inter+4)>>3 (8)

wIntra and wInter are determined by an intra-prediction mode (intra_dir) derived from TIMD. ECM has 65 intra angular prediction modes (2≤intra_dir<=66). If 2≤intra_dir<34, the current block is vertically quartered; if 34<=intra_dir<=66, the current block is horizontally quartered. Weight values (wIntra, wInter) for each region are illustrated in Table 3.

TABLE 3

| Region index | (wIntra, wInter) |
|---|---|
| 0 | (6, 2) |
| 1 | (5, 3) |
| 2 | (3, 5) |
| 3 | (2, 6) |

In particular, if intra_dir=0 or 1, partitioning of a region into sub-regions is skipped. wIntra and wInter can be selected from (3, 1), (2, 2), and (1, 3) based on coding types (intra or inter) for two coding blocks located at the left and the top.

### 14) LIC Technology

LIC technology is a block-level linear transform technology. Motion information between a current block and a reference block is MV. In the LIC technology, it is considered that there is a linear relationship between a prediction block for the current block and the reference block, which can be expressed as follows:

Pred=α·ref+β (9)

α and β can be derived from samples in a reconstructed region neighbouring the current block and samples in a reconstructed region neighbouring the reference block, and obtained through methods such as least squares.

In addition, a threshold threshold can be set. Different linear parameters can be selected according to the magnitude relationship between a reference-block sample and the threshold, as expressed below:

$$\{ \begin{matrix}Pred = {α}_{1} \cdot ref + {β}_{1} , & ref <= threshold \\ Pred = {α}_{2} \cdot ref + {β}_{2} , & else\end{matrix} \qquad ( 10 )$$

### 15) Multi-Mode IBC-LIC Technology

In multi-mode IBC-LIC technology, an IBC-LIC method is classified into several sub-methods according to a template region used for deriving linear parameters and the number of linear transform models. In an example, IBC-LIC is classified into the following four sub-methods:
1. Using L-shaped template region, single model;
2. Using left template region, single model;
3. Using right template region, single model;
4. Using L-shaped template region, two models (different models are selected according to a threshold in order for linear transform).

A specific IBC-LIC sub-method can be selected by encoding an index.

As can be seen, in the related art, with IntraTMP, prediction can be completed through template matching within a predefined search region, where the search region can depend on factors such as the position and the size of a current block. In IntraTMP with merge candidates technology, it is proposed that a merge list is constructed to serve as candidate blocks for a search process. However, candidate block vectors in the above IntraTMP technology are derived based on template matching or a merge list, which results in low diversity of candidate block vectors, thus affecting coding efficiency.

Based on this, a decoding method is provided in embodiments of the disclosure. The method includes the following. A bitstream is parsed to determine first syntax element information. At least one first block vector candidate for a current block is determined when the first syntax element information indicates that a template matching prediction (TMP)-based prediction mode is to be applied to the current block, where the at least one first block vector candidate is determined according to a first type of candidate determined based on template matching and/or a second type of candidate determined based on a merge candidate. At least one second block vector candidate is determined based on the at least one first block vector candidate, where the at least one second block vector candidate includes a relocated block vector constructed for a first candidate in the at least one first block vector candidate. A prediction value for the current block is determined based on the at least one second block vector candidate.

In some implementations, determining the at least one second block vector candidate based on the at least one first block vector candidate includes: determining first candidates from the at least one first block vector candidate, where the first candidates are all or some candidates in the at least one first block vector candidate; and performing relocated block vector construction on the first candidates to obtain the at least one second block vector candidate.

In some implementations, performing relocated block vector construction on the first candidates to obtain the at least one second block vector candidate includes: determining, from the first candidates, guiding block vectors that satisfy a first preset condition; and adding relocated block vectors corresponding to the guiding block vectors to the at least one second block vector candidate.

In some implementations, the method further includes: for any current guiding block vector in the guiding block vectors, determining a relocated block vector corresponding to the current guiding block vector according to a current reference block and/or a current block corresponding to the current guiding block vector; and determining, from the relocated block vectors corresponding to the guiding block vectors for a current round, a guiding block vector for a next round that satisfies the first preset condition, to obtain a next updated at least one second block vector candidate until the guiding block vector for the next round satisfies a second preset condition, and taking the last updated at least one second block vector candidate as the at least one second block vector candidate.

In some implementations, determining the relocated block vector corresponding to the current guiding block vector according to the current reference block and/or the current block corresponding to the current guiding block vector includes: offsetting the current guiding block vector according to the current reference block and/or the current block, to obtain a guiding block offset vector corresponding to the current guiding block vector; and determining the relocated block vector corresponding to the current guiding block vector based on the guiding block offset vector.

In some implementations, the guiding block offset vector includes one or more of: a first guiding block offset vector, where the first guiding block offset vector indicates a first candidate reference block located at a center position of the current reference block; a second guiding block offset vector, where the second guiding block offset vector indicates a second candidate reference block located at a top-left position of the current reference block; a third guiding block offset vector, where the third guiding block offset vector indicates a third candidate reference block located at a bottom-left position of the current reference block; a fourth guiding block offset vector, where the fourth guiding block offset vector indicates a fourth candidate reference block located at a top-right position of the current reference block; or a fifth guiding block offset vector, where the fifth guiding block offset vector indicates a fifth candidate reference block located at a bottom-right position of the current reference block.

In some implementations, determining the relocated block vector corresponding to the current guiding block vector based on the guiding block offset vector includes: determining a current guiding block offset vector from the guiding block offset vector; and when the current guiding block offset vector is available, determining a relocated block vector corresponding to the current guiding block offset vector according to a block vector for a candidate reference block corresponding to the current guiding block offset vector, where the relocated block vector corresponding to the current guiding block offset vector is one of the relocated block vectors corresponding to the current guiding block vector; or when the current guiding block offset vector is unavailable, skipping the current guiding block offset vector and determining a next guiding block offset vector from the guiding block offset vector.

In some implementations, determining the relocated block vector corresponding to the current guiding block offset vector according to the block vector for the candidate reference block corresponding to the current guiding block offset vector includes: when a bi-predictive IBC mode is to be applied to the candidate reference block, determining a first reference block vector and a second reference block vector corresponding to the candidate reference block; performing vector addition on the first reference block vector and the current guiding block vector to determine a first relocated block vector corresponding to the current guiding block offset vector; and performing vector addition on the second reference block vector and the current guiding block vector to determine a second relocated block vector corresponding to the current guiding block offset vector.

In some implementations, the method further includes: determining that the current guiding block offset vector is available when one or more of the following conditions are satisfied: the current guiding block offset vector exists; a candidate reference block indicated by the current guiding block offset vector is reconstructed; a template cost value corresponding to the current guiding block offset vector is less than or equal to a first threshold; the candidate reference block indicated by the current guiding block offset vector is within a preset range; or a prediction mode for the candidate reference block indicated by the current guiding block offset vector is an IBC mode or a TMP mode; or determining that the current guiding block offset vector is unavailable when one or more of the following conditions are satisfied: the current guiding block offset vector does not exist; the candidate reference block indicated by the current guiding block offset vector is not reconstructed; the template cost value corresponding to the current guiding block offset vector is greater than the first threshold; the candidate reference block indicated by the current guiding block offset vector is not within the preset range; or the prediction mode for the candidate reference block indicated by the current guiding block offset vector is not an IBC mode or a TMP mode.

In some implementations, the first preset condition includes one or more of: a template cost value corresponding to a guiding block vector is less than or equal to a second threshold, where the second threshold is obtained according to template cost values corresponding to block vectors added in the at least one first block vector candidate and/or the at least one second block vector candidate; a reference block corresponding to the guiding block vector is reconstructed; a reference block corresponding to the guiding block vector does not exceed a search range for TMP; or the reference block corresponding to the guiding block vector does not exceed a search range for an IBC mode.

In some implementations, the second preset condition includes one or more of: the next round exceeds or reaches an iteration threshold; the number of guiding block vectors for the next round is less than or equal to a third threshold; a template cost value corresponding to each of at least one guiding block vector in the guiding block vectors for the next round is greater than or equal to a fourth threshold; or a number of the next updated at least one second block vector candidate corresponding to the next round is greater than or equal to a maximum list-length threshold.

In some implementations, the at least one first block vector candidate includes any one of: a first type of candidate, where the first type of candidate is determined by performing template matching within a preset search range corresponding to the current block; a second type of candidate, where the second type of candidate is determined by merging block vectors corresponding to one or more candidate blocks having similar motion to the current block; or a third type of candidate, where the third type of candidate is determined based on the first type of candidate and the second type of candidate.

In some implementations, determining the at least one first block vector candidate for the current block includes: determining the first type of candidate, and taking the first type of candidate as the at least one first block vector candidate; and determining the first type of candidate includes: searching within a preset search range at a preset step size to obtain first matching block vectors; determining, from the first matching block vectors, a first block vector having the smallest template cost; and determining the first type of candidate according to the first block vector.

In some implementations, determining the at least one first block vector candidate for the current block includes: determining the second type of candidate, and taking the second type of candidate as the at least one first block vector candidate; and determining the second type of candidate includes: determining the second type of candidate according to second block vectors, where a matching block corresponding to each of the second block vectors has similar motion to the current block.

In some implementations, determining the prediction value for the current block based on the at least one second block vector candidate includes: parsing a bitstream to determine second syntax element information; performing template matching on second candidates in the at least one second block vector candidate to obtain at least one third block vector candidate; and determining the prediction value for the current block according to a TMP-based prediction mode to be applied to the current block indicated by the second syntax element information and the at least one third block vector candidate.

In some implementations, parsing the bitstream to determine the first syntax element information includes: when a value of the first syntax element information is a first value, determining that the TMP-based prediction mode is to be applied to the current block; or when the value of the first syntax element information is a second value, determining that the TMP-based prediction mode is not to be applied to the current block.

An encoding method is further provided in embodiments of the disclosure. The method is applied to an encoder. The method includes the following. A prediction mode to be applied to a current block is determined, and first syntax element information is determined according to the prediction mode to be applied to the current block, where the first syntax element information indicates whether a template matching prediction (TMP)-based prediction mode is to be applied to the current block. At least one first block vector candidate for the current block is determined when the prediction mode for the current block is the TMP-based prediction mode, where the at least one first block vector candidate is determined according to a first type of candidate determined based on template matching and/or a second type of candidate determined based on a merge candidate. At least one second block vector candidate is determined based on the at least one first block vector candidate, where the at least one second block vector candidate includes a relocated block vector constructed for a first candidate in the at least one first block vector candidate. A prediction value for the current block is determined based on the at least one second block vector candidate.

In some implementations, determining the at least one second block vector candidate based on the at least one first block vector candidate includes: determining first candidates from the at least one first block vector candidate, where the first candidates are all or some candidates in the at least one first block vector candidate; and performing relocated block vector construction on the first candidates to obtain the at least one second block vector candidate.

In some implementations, performing relocated block vector construction on the first candidates to obtain the at least one second block vector candidate includes: determining, from the first candidates, guiding block vectors that satisfy a first preset condition; and adding relocated block vectors corresponding to the guiding block vectors to the at least one second block vector candidate.

A non-transitory computer-readable storage medium is further provided in embodiments of the disclosure. The computer-readable storage medium stores a computer program and a bitstream. When executed by a processor, the computer program causes the processor to implement the above encoding method to generate the bitstream.

In this way, no matter whether it is at an encoding end or a decoding end, on one hand, by constructing a relocated block vector for each first candidate block vector in the first block vector candidate list to determine the second block vector candidate list, further refinement or adjustment of the first candidate block vectors in the first block vector candidate list is achieved. As such, it is possible to improve diversity of candidate block vectors, improve accuracy in describing motion information, and improve accuracy of motion estimation. In addition, by determining the first block vector candidate list according to the first candidate list constructed based on the template matching technology and/or the second candidate list constructed based on the merge candidate technology, diversity of candidate lists can be improved, which is beneficial for subsequent extension of candidate block vectors. As such, appropriate block vectors can be selected more effectively during coding, which improves diversity of candidate block vectors, reduces transmission of redundant information, and thus improves coding efficiency.

Embodiments of the disclosure will be described in detail below in conjunction with the accompanying drawings.

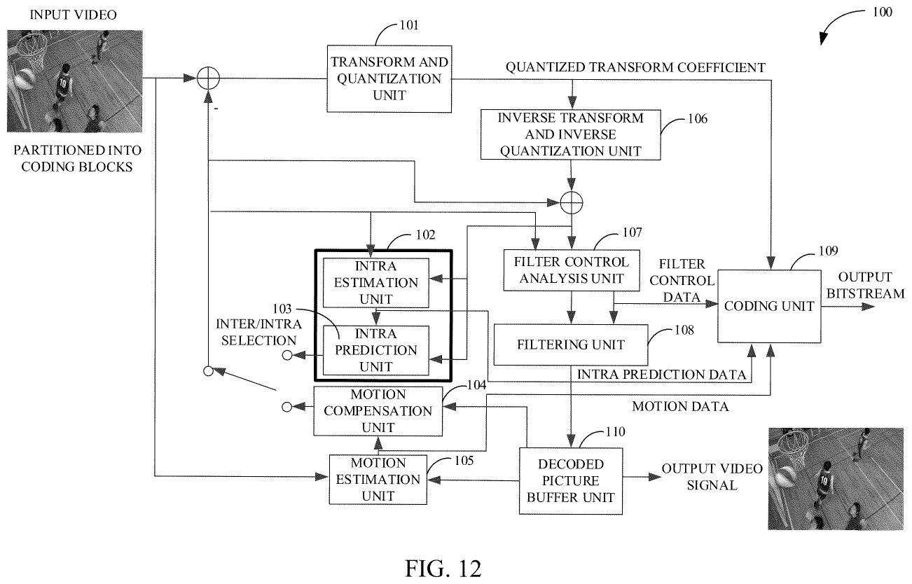

FIG. 12 is a schematic block diagram of an encoder provided in embodiments of the disclosure. As illustrated in FIG. 12, the encoder 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, a coding unit 109, a decoded picture buffer unit 110, and the like. The filtering unit 108 can implement deblocking filtering and sample adaptive offset (SAO) filtering. The coding unit 109 can implement header information encoding and context-based adaptive binary arithmetic coding (CABAC). For an input original video signal, one video coding block can be obtained through partitioning of a CTU. Then, for residual sample information obtained after intra prediction or inter prediction, the video coding block is transformed by the transform and quantization unit 101, including transforming the residual information from the sample domain to the transform domain, and the obtained transform coefficients are quantized, so as to further reduce bit rate. The intra estimation unit 102 and the intra prediction unit 103 are used to perform intra prediction on the coding block. Specifically, the intra estimation unit 102 and the intra prediction unit 103 are used to determine an intra prediction mode to-be-used to encode the coding block. The motion compensation unit 104 and the motion estimation unit 105 are used to perform inter prediction encoding on the received coding block relative to one or more blocks in one or more reference pictures, to provide temporal prediction information. The motion estimation performed by the motion estimation unit 105 is a process of generating a motion vector, where the motion vector can be used to estimate motion of the coding block. The motion compensation unit 104 is used to perform motion compensation based on the motion vector determined by the motion estimation unit 105. After the intra prediction mode is determined, the intra prediction unit 103 is used to provide the selected intra prediction data to the coding unit 109, and the motion estimation unit 105 is used to send the calculated motion vector data to the coding unit 109. In addition, the inverse transform and inverse quantization unit 106 is used for reconstruction of the coding block. A residual block is reconstructed in the sample domain, and blocking artifacts of the reconstructed residual block are removed by the filter control analysis unit 107 and the filtering unit 108, and then the reconstructed residual block is added to a prediction block for a picture in the decoded picture buffer unit 110, to generate a reconstructed coding block. The coding unit 109 is used to encode various coding parameters and quantized transform coefficients. In the CABAC-based encoding algorithm, the context can be based on neighbouring coded blocks, and the coding unit 109 can be used to encode information indicating the determined intra prediction mode and output a bitstream of the video signal. The decoded picture buffer unit 110 is used to store reconstructed coding blocks in order for prediction reference. As the picture encoding progresses, reconstructed coding blocks will be continuously generated, and these reconstructed coding blocks will be stored into the decoded picture buffer unit 110.

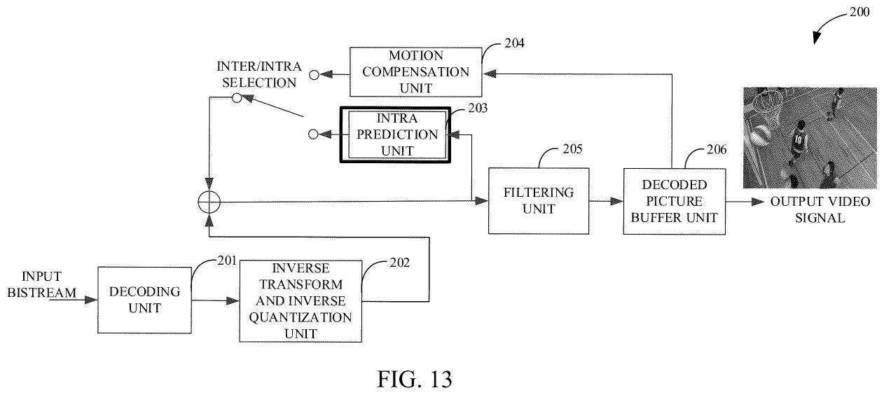

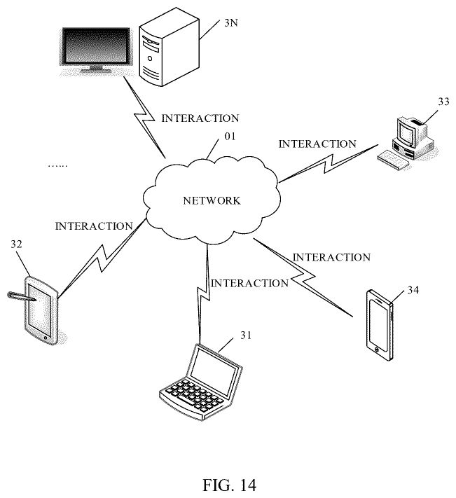

FIG. 13 is a schematic block diagram of a decoder provided in embodiments of the disclosure. As illustrated in FIG. 13, the decoder 200 includes a decoding unit 201, an inverse transform and inverse quantization unit 202, an intra prediction unit 203, a motion compensation unit 204, a filtering unit 205, a decoded picture buffer unit 206, and the like. The decoding unit 201 can implement header information decoding and CABAC. The filtering unit 205 can implement deblocking filtering and SAO filtering. After the input video signal is encoded (as illustrated in FIG. 14), the bitstream of the video signal is output. The bitstream is input into the decoder 200. First, decoded transform coefficients are obtained by the decoding unit 201. The decoded transform coefficients are processed by the inverse transform and inverse quantization unit 202, so as to generate a residual block in the sample domain. The intra prediction unit 203 can be used to generate prediction data of the current video coding block based on the determined intra prediction mode and data from the previous decoded block of the current frame or picture. The motion compensation unit 204 is used to determine prediction information for the coding block by analyzing motion vectors and other associated syntax elements, and use the prediction information to generate a prediction block of the video coding block that is being decoded. The decoded video block is formed by summing the residual block from the inverse transform and inverse quantization unit 202 and the corresponding prediction block generated by the intra prediction unit 203 or the motion compensation unit 204. The blocking artifacts of the decoded video signal are removed by the filtering unit 205, which can improve quality of the video. The decoded video block is then stored into the decoded picture buffer unit 206. The decoded picture buffer unit 206 is used to store reference pictures used for subsequent intra prediction or motion compensation, and is also used to output the video signal, that is, the restored original video signal is obtained.

In addition, FIG. 14 is a schematic diagram illustrating a network architecture of a coding system provided in embodiments of the disclosure. As illustrated in FIG. 14, the network architecture includes one or more electronic devices 31 to 3N and a communication network 01. The electronic devices 31 to 3N can perform video interaction with each other via the communication network 01. During implementation, the electronic devices can be various types of devices with video coding functions. For example, the electronic devices can include smartphones, tablet computers, personal computers, personal digital assistants (PDAs), navigation devices, digital telephones, video telephones, televisions, sensing devices, servers, etc., which is not specifically limited in embodiments of the disclosure.

Embodiments of the disclosure provide a network architecture of a video coding system that includes a decoding method and an encoding method. The decoder or the encoder in embodiments of the disclosure can be the above-mentioned electronic device. That is, the electronic device in embodiments of the disclosure has a video coding function, and can generally include a video encoder (i.e., encoder) and a video decoder (i.e., decoder).

It should also be noted that, embodiments of the disclosure are mainly applied to the intra prediction part and/or inter prediction part illustrated in FIG. 12 (represented by bold outlined boxes) and the intra prediction part and/or inter prediction part illustrated in FIG. 13 (represented by bold outlined boxes). That is, embodiments of the disclosure can be applied to an encoder, or can be applied to a decoder, or can even be applied to both an encoder and a decoder.

It should also be noted that, when embodiments of the disclosure are applied to the encoder illustrated in FIG. 12, the “current block” specifically refers to a coding block on which prediction is currently to be performed. When embodiments of the disclosure are applied to the decoder illustrated in FIG. 13, the “current block” specifically refers to a coding block on which prediction is currently to be performed.

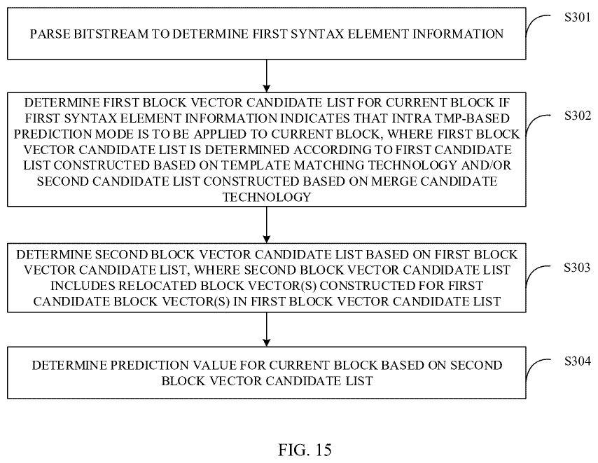

In an embodiment of the disclosure, FIG. 15 is a schematic flowchart of a decoding method provided in embodiments of the disclosure. As illustrated in FIG. 15, the method can include S301 to S304.

S301, a bitstream is parsed to determine first syntax element information.

It should be noted that, the decoding method in embodiments of the disclosure is applied to a decoder. In addition, the decoding method can specifically refer to a method for extending intra template matching candidates. In an IntraTMP-based prediction mode, the decoding method is mainly aimed at improvement of technology for constructing a candidate list, and more specifically, may be an IntraTMP technology-based prediction method, so as to solve the problem of low diversity of candidate block vectors in the related art which affects decoding efficiency.

In embodiments of the disclosure, the decoder parses the bitstream to determine the first syntax element information. The first syntax element information indicates whether an IntraTMP-based prediction mode is to be applied to the current block.

In some embodiments of the disclosure, the bitstream can be parsed to determine the first syntax element information in S301 as follows. If a value of the first syntax element information is a first value, determine that the IntraTMP-based prediction mode is to be applied to the current block. Alternatively, if the value of the first syntax element information is a second value, determine that the IntraTMP-based prediction mode is not to be applied to the current block.

It should be noted that, in embodiments of the disclosure, the first value is different from the second value, and the first value and the second value each can be in a parameter form or in a numerical form. Specifically, the first syntax element information can be a parameter written in a profile, or can be a value of a flag, which is not specifically limited herein.

Exemplarily, for the first value and the second value, the first value can be set to 1, and the second value can be set to 0; alternatively, the first value can be set to 0, and the second value can be set to 1; alternatively, the first value can be set to true, and the second value can be set to false; alternatively, the first value can be set to false, and the second value can be set to true. However, no specific limitation is imposed herein.

In embodiments of the disclosure, taking a flag signalled in the bitstream as an example, assuming that the first value is set to 1 (true) and the second value is set to 0 (false), if the value of the first syntax element information is 0 (false), then it can be determined that the IntraTMP-based prediction mode is not to be applied to the current block, i.e., the decoding method in embodiments of the disclosure does not need to be performed; if the value of the first syntax element information is 1 (true), then it can be determined that the IntraTMP-based prediction mode is to be applied to the current block, i.e., the decoding method in embodiments of the disclosure may need to be performed.

It can be understood that, if the value of the first syntax element information is the first value, it is determined that the IntraTMP-based prediction mode is to be applied to the current block, and as such, redundant information is reduced through intra template matching, thereby realizing compression. If the value of the first syntax element information is the second value, it is determined that the IntraTMP-based prediction mode is not to be applied to the current chroma block, which can avoid or limit the use of intra template matching, thereby improving decoding stability or avoiding performance issues in some specific cases.

S302, if the first syntax element information indicates that the IntraTMP-based prediction mode is to be applied to the current block, a first block vector candidate list for the current block is determined, where the first block vector candidate list is determined according to a first candidate list constructed based on a template matching technology and/or a second candidate list constructed based on a merge candidate technology.

In embodiments of the disclosure, if the first syntax element information indicates that the IntraTMP-based prediction mode is to be applied to the current block, the decoder determines the first block vector candidate list for the current block.

In embodiments of the disclosure, the construction of the first block vector candidate list relies on two key information sources, which are respectively as follows:

1) First candidate list: the first candidate list is obtained by searching for a block most similar to the current block within a reference picture through the template matching technology. With the template matching technology, the most similar block can be found by comparing blocks in terms of sample values or other features, and the first candidate list is generated, which includes multiple block vectors obtained through template matching.

2) Second candidate list: the merge candidate technology may also be applied for the construction of the first block vector candidate. In video coding, the merge technology generally refers to merging information of neighbouring blocks or other blocks to reduce redundancy and improve coding efficiency. With the merge candidate technology, the second candidate list including multiple merge block vectors can be constructed.

It can be understood that, the first block vector candidate list is obtained by combining the first candidate list and the second candidate list constructed based on the two technologies. The first block vector candidate list includes multiple possible block vectors for use in subsequent motion prediction. With the above design, advantages of the template matching technology and the merge candidate technology are fully utilized to provide more comprehensive and diverse block vector options, thereby improving efficiency and quality of video decoding.

In some embodiments of the disclosure, the first block vector candidate list includes any one of: a first candidate list, a second candidate list, or a third candidate list. The first candidate list is determined by performing intra template matching within a preset search range corresponding to the current block. The second candidate list is determined by merging block vectors corresponding to one or more candidate blocks having similar motion to the current block. The third candidate list is determined based on the first candidate list and the second candidate list.

In embodiments of the disclosure, the first candidate list is determined by performing intra template matching within a preset search range corresponding to the current block. That is, the system (decoder) performs intra template matching within a predefined search range, to find a block most similar to the current block and thus construct the first candidate list.

Exemplarily, the decoder searches within the preset search range corresponding to the current block. The purpose of searching is to find a block most similar to the current block, so as to obtain information related to motion of the current block. During searching, an intra template matching technology is typically applied, which includes comparing the current block and each block within the search range in terms of sample values or other features, so as to find the most similar block. For each similar block found, a block vector for the block is calculated, i.e., a motion vector for describing motion of the current block relative to a block found in a reference picture, and these block vectors constitute elements of the first candidate list. The purpose of the first candidate list is to provide diverse motion vector options. Due to different search ranges and changes of similar blocks, the first candidate list may include multiple block vectors, which represent different motion hypotheses. Each candidate block vector generally corresponds to a template error, which represents a difference between the current block and a reference block. A smaller template error means that the candidate block vector is more likely to be an optimal choice. In a subsequent decoding process, the decoder may select an optimal block vector from the first candidate list, where the selection is usually made according to a minimum template error value or other optimization criteria.

It can be understood that, the first candidate list is a list including multiple candidate block vectors generated by searching for similar blocks within an intra search range and calculating block vectors, so as to provide options of different motion hypotheses. The construction of such list is part of motion estimation in video decoding, and helps improve accuracy of motion estimation of the current block.

In embodiments of the disclosure, the second candidate list is determined by merging block vectors corresponding to one or more candidate blocks having similar motion to the current block. The manner for merging may involve neighbouring blocks, history buffer blocks, and the like, and the second candidate list is obtained by merging the block vectors.

Exemplarily, in video decoding, there may exist other blocks having similar motion to the current block. These blocks can come from neighbouring regions, history buffers, or other similarity criteria. The construction of the second candidate list involves merging the block vectors corresponding to the candidate blocks having similar motion. The purpose of merging is to provide a wider variety of motion information, which is more conducive to prediction of the motion of the current block. With regard to merging, different technologies can be applied, such as block vector averaging, motion compensation, and the specific merging strategy may depend on system design and video decoding standards. The results of merging form the elements of the second candidate list. Each element is a block vector, which describes a motion vector for a combination of blocks having similar motion to the current block. The construction of the second candidate list aims to provide more diverse and more adaptive motion vector options. By merging motion information from different blocks, it is more conducive to adaptation to complex scenarios and motion changes. In a subsequent decoding process, the system may select an optimal block vector from the second candidate list, where the selection is usually made according to a minimum template error value or other optimization criteria.

It can be understood that, with regard to the construction of the second candidate list, by merging block vectors corresponding to candidate blocks of similar motion, it is possible to provide more comprehensive motion information, so as to enhance modeling and prediction of the motion of the current block. The construction of such list is part of motion estimation in video decoding, and helps improve decoding efficiency and video quality.

In embodiments of the disclosure, the third candidate list is determined based on the first candidate list and the second candidate list. This means that when constructing the third candidate list, information from the former two may be combined, which comprehensively takes results of intra template matching and motion merging into consideration.

Exemplarily, the third candidate list is constructed firstly based on the first candidate list. The first candidate list is determined by performing intra template matching within a preset search range corresponding to the current block. This means that the first candidate list includes a set of candidate block vectors found based on the template matching technology. The third candidate list is also based on the second candidate list. The second candidate list is determined by merging block vectors corresponding to one or more candidate blocks having similar motion to the current block. This means that the second candidate list includes a set of candidate block vectors obtained based on the merging technology. The purpose of the third candidate list is to comprehensively utilize information from the first candidate list and information from the second candidate list, so as to provide more comprehensive and more diverse motion vector options. As such, it is possible to enhance modeling and prediction of the motion of the current block. By combining the first candidate list and the second candidate list, the third candidate list aims to provide more diverse and more adaptive motion vector options, which is of great significance for coping with different scenarios and motion characteristics. In a subsequent decoding process, the system may select an optimal block vector from the third candidate list, where the selection is usually made according to a minimum template error value or other optimization criteria.

It can be understood that, the third candidate list is constructed in order to provide richer and more diverse motion vector options by combining information from different sources, thereby improving performance of video decoding. In this way, it helps predict motion more accurately in different scenarios, thereby improving decoding efficiency and video quality.

It can be understood that, on one hand, by comprehensively applying intra template matching and merging technology, accuracy of motion estimation of the current block can be improved. In Intra template matching, spatial similarity is taken into consideration, while in merging technology, richer motion information can be obtained from neighbouring blocks. On one hand, by combining different candidate lists, it helps adapt to different scenarios and motion characteristics. Intra template matching is more suitable for static or slowly varying regions, while merging technology may be more effective for regions with fast motion or dynamic changes. On one hand, by comprehensively taking different candidate lists into consideration, a block vector can be selected more effectively, thereby improving efficiency of video decoding. By reducing a residual between a block and a reference block, it helps reduce a bit rate. With the comprehensive method in which multiple information sources are adopted, complex scenarios, such as fast motion, richly textured regions, etc. can be better handled. In general, the above process aims to fully utilize different technologies and information, so as to improve video decoding performance, reduce distortion, and provide better visual quality. However, the specific effect also depends on implementation details and application scenarios.

In some embodiments of the disclosure, with regard to the first block vector candidate list, there can be the following cases.

Case 1: if the first block vector candidate list is the first candidate list, the first candidate block vector includes: all candidate block vectors in the first candidate list; or M candidate block vectors having the smallest template costs in the first candidate list, where M is a positive integer and M≥1.

It can be understood that, on one hand, all candidate block vectors in the first candidate list are taken into consideration, and as such, more comprehensive motion vector options are provided, which helps simulate and predict motion of a video block more accurately during decoding, thereby improving decoding efficiency and video quality. On the other hand, by limiting the number of candidate block vectors taken into consideration, it helps reduce computational burden, especially for the case of limited computational resources. By selecting M candidate block vectors having the smallest template costs, it is possible to maintain decoding efficiency to a certain extent and reduce computational complexity.

Case 2: if the first block vector candidate list is the second candidate list, the first candidate block vector includes: all candidate block vectors in the second candidate list; or N candidate block vectors having the smallest template costs in the second candidate list, where N is a positive integer and N≥1.

Case 3: if the first block vector candidate list is the third candidate list, the first candidate block vector includes: all candidate block vectors in the first candidate list and all candidate block vectors in the second candidate list; or M candidate block vectors having the smallest template costs in the first candidate list and all candidate block vectors in the second candidate list; or all candidate block vectors in the first candidate list and N candidate block vectors having the smallest template costs in the second candidate list; or M candidate block vectors having the smallest template costs in the first candidate list and N candidate block vectors having the smallest template costs in the second candidate list; or H candidate block vectors having the smallest template costs among candidate block vectors obtained by merging all candidate block vectors in the first candidate list with all candidate block vectors in the second candidate list, where H is a positive integer and H≥1.

More specifically, if the first block vector candidate list is the third candidate list, the decoder can firstly construct the first candidate list, then construct the second candidate list, perform relocated block construction on first candidate block vectors in the second candidate list to obtain an updated second candidate list, and then merge the updated second candidate list with the first candidate list, so as to obtain a final second block vector candidate list.

It can be understood that, on one hand, all candidate block vectors in the first candidate list and the second candidate list are provided, and as such, more motion information is included, which helps improve comprehensiveness and accuracy of motion estimation, thereby improving efficiency and quality of video decoding. On one hand, by limiting the number of candidate block vectors in the first candidate list, computational burden can be reduced to a certain extent. However, all candidate block vectors in the second candidate list are retained, which provides more motion information. On one hand, all candidate block vectors in the first candidate list are provided, whereas computational complexity is reduced by limiting the number of candidate block vectors in the second candidate list. In addition, the optimal candidate block vector(s) in the second candidate list are still taken into consideration. On one hand, in such combination manner in which the numbers of candidate block vectors in both of the two lists are limited, it is possible to control computational complexity more finely. In addition, the candidate block vector having the smallest template costs in the two lists are retained. On one hand, by merging the candidate block vectors in the two lists and selecting H candidate block vectors having the smallest template costs obtained after merging, information from the two lists is integrated. This is conducive to more comprehensive and accurate motion estimation. To summarize, the advantages of these selection manners is to provide different trade-off choices, so as to meet different requirements of a decoding system in aspects such as computational burden, motion estimation accuracy, and real-time performance. By selecting the most suitable manner for a specific application scenario, it helps optimize performance of video decoding.

S303, a second block vector candidate list is determined based on the first block vector candidate list, where the second block vector candidate list includes a relocated block vector(s) constructed for a first candidate block vector(s) in the first block vector candidate list.

In an embodiment of the disclosure, with regard to the composition of the second block vector candidate list, there can be the following cases.

Case 1: block vectors in the first candidate list (a list obtained through template matching), and relocated block vectors corresponding to first candidate block vectors in the first candidate list.

Case 2: block vectors in the second candidate list (a Merge list), and relocated block vectors corresponding to first candidate block vectors in the second candidate list.

Case 3: block vectors in the first candidate list (a list obtained through template matching), block vectors in the second candidate list (a Merge list), and relocated block vectors corresponding to first candidate block vectors in the second candidate list.

Case 4: block vectors in the first candidate list (a list obtained through template matching), block vectors in the second candidate list (a Merge list), and relocated block vectors corresponding to first candidate block vectors in the first candidate list.

Case 5: block vectors in the first candidate list (a list obtained through template matching), block vectors in the second candidate list (a Merge list), relocated block vectors corresponding to first candidate block vectors in the second candidate list, and relocated block vectors corresponding to first candidate block vectors in the first candidate list.

It should be noted that, the above-listed composition of the second block vector candidate list is only exemplary, and other manners can also be included in practice, and no limitation is imposed thereon in embodiments of the disclosure.

S304, a prediction value for the current block is determined based on the second block vector candidate list.

In some embodiments of the disclosure, the implementation of determining the prediction value for the current block based on the second block vector candidate list in S304 can include S3041 to S3043.

S3041, a bitstream is parsed to determine second syntax element information.

In embodiments of the disclosure, the second syntax element information indicates an IntraTMP-based prediction mode to be applied to the current block. Exemplarily, the second syntax element information can be intra_tmp_flag.

S3042, template matching is performed on second candidate block vectors in the second block vector candidate list to obtain a third block vector candidate list.

In some embodiments of the disclosure, template matching can be performed on each second candidate block vector in the second block vector candidate list to obtain the third block vector candidate list in S3042 as follows. For any second candidate block vector in the second candidate block vectors, a neighbouring region of the second candidate block vector is determined according to index flag information for the second candidate block vector; search in the neighbouring region of the second candidate block vector at a preset step size to obtain second matching block vectors corresponding to the second candidate block vector; a third block vector having the smallest template cost is determined from the second matching block vectors corresponding to the second candidate block vector; and the third block vector candidate list is determined according to the third block vector corresponding to the second candidate block vector.

In embodiments of the disclosure, for a second candidate block vector, a corresponding neighbouring region is determined according to index flag information for the second candidate block vector, and the neighbouring region is a region in which searching is performed within a certain range around the second candidate block vector. Within the determined neighbouring region, searching is performed at a preset step size. The step size can be distances in a horizontal direction and a vertical direction, which are used for sampling possible positions of second matching block vectors within the neighbouring region. Further, within the neighbouring region, searching is performed at the preset step size, to obtain a second matching block vector matched with the second candidate block vector, which is a block found within the neighbouring region that best matches the second candidate block vector. Then, for the second matching block vector, template matching is performed to determine a third block vector having the smallest template cost, for example, searching is performed within a template region around the second matching block vector to find the best matching block. Further, the determined third block vector having the smallest template cost is added to the third block vector candidate list, where the list includes an optimal third block vector corresponding to each second candidate block vector.

In embodiments of the disclosure, the index flag information may include the position, the size, and other related information of the second candidate block vector in a picture or a video picture, and such information can be used to determine the range of the neighbouring region.

In embodiments of the disclosure, the index flag information obtained is used to calculate or define the neighbouring region of the second candidate block vector. The neighbouring region can be a rectangular region or a region of another shape centered on the second candidate block vector. Searching and template matching are performed within the neighbouring region calculated according to the index flag information, so as to find the optimal third block vector.

Exemplarily, if the index flag includes position information, the neighbouring region can be defined by taking the position as a center. If the index flag includes block size information, the neighbouring region can be defined by taking the block size into account on the basis of the position information. According to other possible related information, such as picture structure, motion direction, etc., further adjustment is performed on the neighbouring region.

It should be understood that, determination of the neighbouring region of the second candidate block vector is a process of dynamic calculation according to the specific index flag information, which helps ensure that a search range is adapted to different video contents and motion characteristics, thereby improving accuracy of template matching.

It can be understood that, on one hand, by performing refined searching and template matching within the neighbouring region of the second candidate block vector, the third block vector can be estimated more accurately, thereby improving overall accuracy of motion estimation. On one hand, for each second candidate block vector, the neighbouring region is dynamically determined according to the index flag information for the second candidate block vector, which helps adapt to changes of different video contents and motion characteristics. As such, an algorithm can be more versatile, and can have good performance in different scenarios. On one hand, searching at a preset step size can be performed within a relatively large neighbouring region, but after the second matching block vector is obtained, the third block vector having the smallest template cost is typically located within a relatively small region, thereby reducing a range for further search and thus improving search efficiency. On one hand, by determining the third block vector having the smallest template cost through template matching within a neighbouring region of the second matching block vector, it facilitates refining matching results and ensuring that motion estimation is more accurate. In summary, in the above process, accuracy and robustness of motion estimation are improved through multiple rounds of searching and matching, which helps improve effectiveness of video decoding.

S3043, the prediction value for the current block is determined according to an IntraTMP-based prediction mode to be applied to the current block indicated by the second syntax element information and the third block vector candidate list.

In embodiments of the disclosure, the IntraTMP-based prediction mode to be applied to the current block can be: an IntraTMP fusion prediction technology, an IntraTMP multi-candidate technology, etc., and no limitation is imposed thereon in embodiments of the disclosure.

In embodiments of the disclosure, by using a result of template matching and the prediction mode, the content of the current block is estimated by matching and predicting information of neighbouring blocks, which helps improve video decoding efficiency and compression performance, especially for the case where scenario changes are relatively slight.

It can be understood that, on one hand, by performing template matching on the second candidate block vectors in the second block vector candidate list, the third block vector candidate list is obtained. Through such a multi-round searching process, it helps select the best matching block vector from candidate blocks, thereby improving prediction accuracy. On one hand, for generation of the third block vector candidate list, matching results of multiple candidate blocks are taken into account, thereby improving robustness to noise and interference. By integrating multiple candidate block vectors, influence of a single matching result can be reduced. On one hand, by using the IntraTMP-based prediction mode in combination with the third block vector candidate list, the content of the current block can be estimated more accurately, thereby improving video decoding efficiency and compression performance. The prediction value is generated based on multiple rounds of template matching and accurate block vector selection, which helps improve video quality and reduce estimation errors, such that a decoded picture is more similar to an original picture.

In some embodiments of the disclosure, the decoding method further includes the following. The bitstream is parsed to determine a residual value of the current block. A reconstructed value of the current block is determined according to the prediction value for the current block and the residual value of the current block.

In embodiments of the disclosure, the decoder reads corresponding information from a video bitstream, which includes an encoding mode, a motion vector, a prediction mode, and the like. The decoder calculates the prediction value for the current block according to the information obtained by parsing. The prediction value is obtained based on technologies such as motion estimation and prediction mode, and represents an estimation of the content of the current block. Then, the residual value of the current block, i.e., a difference between an original block and a prediction block, is calculated. The reconstructed value of the current block is calculated according to the prediction value and the residual value of the current block. The reconstructed value is obtained by adding the residual value to the prediction value, and is used to approximate the content of the original block.

It can be understood that, on one hand, the residual value is one of key pieces of information transmitted during decoding, and by predicting the original block and transmitting only the difference, the size of the bitstream can be reduced, thereby achieving video compression. On one hand, at a decoding end, by performing addition on the prediction value and the residual value, the original block can be reconstructed more efficiently, thereby reducing computation overhead and storage overhead required for decoding. On one hand, through appropriate addition on the prediction value and the residual value, it is possible to maintain video quality while achieving compression, such that a decoded picture is similar to an original picture.

In embodiments of the disclosure, a decoding method is provided. The method includes the following. The bitstream is parsed to determine the first syntax element information. If the first syntax element information indicates that the IntraTMP-based prediction mode is to be applied to the current block, the first block vector candidate list for the current block is determined, where the first block vector candidate list is determined according to the first candidate list constructed based on the template matching technology and/or the second candidate list constructed based on the merge candidate technology. The second block vector candidate list is determined based on the first block vector candidate list, where the second block vector candidate list at least includes the relocated block vector(s) constructed for the first candidate block vector(s) in the first block vector candidate list. The prediction value for the current block is determined based on the second block vector candidate list. On one hand, by constructing a relocated block vector for each first candidate block vector in the first block vector candidate list to determine the second block vector candidate list, further refinement or adjustment of the first candidate block vectors in the first block vector candidate list is achieved. As such, it is conducive to diversity of candidate block vectors, accuracy in describing motion information, and accuracy of motion estimation. On the other hand, by determining the first block vector candidate list according to the first candidate list constructed based on the template matching technology and/or the second candidate list constructed based on the merge candidate technology, diversity of candidate lists can be improved, which is beneficial for subsequent extension of candidate block vectors. As such, appropriate block vectors can be selected more effectively during decoding, which improves diversity of candidate block vectors, reduces transmission of redundant information, and thus improves decoding efficiency.

It can be understood that, by means of the first candidate list constructed based on the template matching technology and/or the second candidate list constructed based on the merge candidate technology, prediction of the content of the current block can be performed more accurately, which helps estimate the content of the block more precisely in video prediction and reduce prediction errors. For generation of the first block vector candidate list, multiple factors are taken into account, which include the template matching technology and merge candidate technology. Through such comprehensive consideration, it helps adapt to different video scenarios, and as such, a prediction mode is more flexible and adaptive. During generation of the first block vector candidate list, through multiple rounds of searching and matching, it is possible to better capture motion relationships between blocks, thereby reducing overhead during prediction and improving prediction efficiency. With a more accurate prediction value, an original block can be reconstructed more accurately at a decoding end, thereby improving video quality. This helps reduce distortion and maintain a high-quality visual experience. By using the second block vector candidate list, especially the relocated block vectors, motion information of the current block can be represented more effectively, thereby achieving better compression performance while maintaining video quality. In general, through the above process, it is possible to improve prediction accuracy, adapt to different scenarios, reduce prediction overhead, improve video quality, and optimize overall compression performance.

In some embodiments of the disclosure, the implementation of determining the second block vector candidate list based on the first block vector candidate list in S303 can include S3031~S3032.

S3031, first candidate block vectors are determined from the first block vector candidate list, where the first candidate block vectors are all or some candidate block vectors in the first block vector candidate list.

S3032, relocated block vector construction is performed on the first candidate block vectors to obtain the second block vector candidate list.

In some embodiments of the disclosure, the implementation of performing relocated block vector construction on the first candidate block vectors to obtain the second block vector candidate list in S3032 can include S401~S404.

S401, guiding block vectors for a current round that satisfy a first preset condition are determined from the first candidate block vectors.

In some embodiments of the disclosure, the first preset condition includes one or more of the following conditions: a template cost value corresponding to a guiding block vector is less than or equal to a second threshold, where the second threshold is obtained according to template cost values corresponding to block vectors added in the first block vector candidate list and/or the second block vector candidate list; a reference block corresponding to the guiding block vector is reconstructed; a reference block corresponding to the guiding block vector does not exceed a search range for IntraTMP; or the reference block corresponding to the guiding block vector does not exceed a search range for an IBC mode.

In embodiments of the disclosure, determination of the second threshold depends on the template cost values corresponding to the block vectors added in the first block vector candidate list and/or the second block vector candidate list. Such relationship may be used to dynamically adjust the second threshold according to previous searching and matching results, so as to adapt to specific conditions of a current video picture.

Exemplarily, related information is obtained from the block vectors added in the first block vector candidate list and/or the second block vector candidate list. For each block vector added, a template cost value corresponding to the block vector during template matching is obtained. The template cost values corresponding to the block vectors added may be comprehensively taken into consideration by obtaining a comprehensive reference value by means of an average value, a weighted average value, or other statistical means. The second threshold is dynamically adjusted based on the comprehensive reference value.

It should be understood that, through the above mechanism, the system can adaptively determine the second threshold at runtime according to actual needs, which can better cope with different video pictures and motion scenarios, thereby improving performance and adaptability of a template matching prediction mode.

In embodiments of the disclosure, in video coding, intra template matching prediction usually involves searching for a block similar to a block to-be-decoded within a current picture. To avoid unnecessary computation and improve search efficiency, the search range may be limited to a certain region, and such region is the search range for IntraTMP. Therefore, “the reference block corresponding to the guiding block vector does not exceed the search range for IntraTMP” means that under the IntraTMP mode, for a reference block indicated by a guiding block vector, a search range for the reference block is subject to a certain limitation, so as to ensure that regions that are too distant or irrelevant will not be searched during template matching, thereby improving search efficiency and accuracy.

In embodiments of the disclosure, the search range for the IBC mode represents a limited region for searching for similar blocks within a current picture. Such limitation of search range helps reduce search space and improve decoding efficiency, and is generally based on some prior knowledge or statistical information. Therefore, “the reference block corresponding to the guiding block vector does not exceed the search range for the IBC mode” means that when applying the IBC mode, for a reference block indicated by a guiding block vector, the search range for the reference block is limited, so as to ensure that the search range will not be too wide when performing block copy within the current picture, thereby improving search efficiency.

It can be understood that, on one hand, the second threshold in the first preset condition is obtained by taking template cost values corresponding to added block vectors into consideration, which helps control accuracy of template matching, avoid unnecessary computation, and select block vectors with smaller template costs, thereby improving decoding efficiency. On one hand, if the reference block corresponding to the guiding block vector is reconstructed in a previous decoding process, repeated computation can be avoided, and thus redundant operations can be reduced, thereby improving decoding efficiency. On one hand, the search range for the reference block is limited so as not to exceed the search range for IntraTMP or the IBC mode. This helps reduce the search space, increase search speed, and on the other hand, ensure that the selected reference block is within an appropriate range, thereby improving decoding performance.

S402, relocated block vectors corresponding to the guiding block vectors for the current round are added to a current second block vector candidate list, to obtain an updated current second block vector candidate list.

In embodiments of the disclosure, the relocated block vectors corresponding to the guiding block vectors for the current round are added to the current second block vector candidate list to update the list. Generally, the current second block vector candidate list may contain multiple block vectors, and each block vector corresponds to a different reference block. By adding the relocated block vectors corresponding to the guiding block vectors for the current round to the current second block vector candidate list, more block vector options can be taken into consideration, so as to improve matching accuracy and effect.

It can be understood that, by using information of the guiding block vectors and the relocated block vectors previously obtained, block vector options can be taken into consideration more comprehensively, which helps improve matching accuracy. By adding more block vectors to a candidate list, it is possible to provide more options for subsequent template matching or other prediction processes, thereby increasing the probability of finding the best match.

It should be noted that, the current second block vector candidate list may further include all or some of block vectors inherited from the first block vector candidate list.

S403, for any current guiding block vector in the guiding block vectors for the current round, a relocated block vector(s) corresponding to the current guiding block vector is determined according to a current reference block and/or a current block corresponding to the current guiding block vector.

In some embodiments of the disclosure, the implementation of determining the relocated block vector corresponding to the current guiding block vector according to the current reference block and/or the current block corresponding to the current guiding block vector in S403 can include S4031~S4032.

S4031, the current guiding block vector is offset according to the current reference block and/or the current block, to obtain a guiding block offset vector(s) corresponding to the current guiding block vector.

In embodiments of the disclosure, a guiding block vector is offset based on information of the current reference block and/or the current block. Such offset may be caused by motion of an object or scenario changes. By calculating the offset, better adaptation to motion and changes in a video can be achieved. A vector obtained after offsetting is referred to as a guiding block offset vector. Such vector can describe a displacement relative to a guiding block, which helps determine a position of a block more accurately.

It should be understood that, by considering the offset, the position of the current block relative to a reference picture can be estimated more accurately, thereby improving accuracy of position estimation. Objects in a video may have motion and changes, and through the offsetting process, it can help a model better adapt to these changes.

In some embodiments of the disclosure, the guiding block offset vector includes one or more of: a first guiding block offset vector, a second guiding block offset vector, a third guiding block offset vector, a fourth guiding block offset vector, or a fifth guiding block offset vector. The first guiding block offset vector indicates a first candidate reference block located at a center position of the current reference block. The second guiding block offset vector indicates a second candidate reference block located at a top-left position of the current reference block. The third guiding block offset vector indicates a third candidate reference block located at a bottom-left position of the current reference block. The fourth guiding block offset vector indicates a fourth candidate reference block located at a top-right position of the current reference block. The fifth guiding block offset vector indicates a fifth candidate reference block located at a bottom-right position of the current reference block.

In embodiments of the disclosure, the first guiding block offset vector can be represented by CTR, the second guiding block offset vector can be represented by LT, the third guiding block offset vector can be represented by LB, the fourth guiding block offset vector can be represented by RT, and the fifth guiding block offset vector can be represented by RB.

In embodiments of the disclosure, the first guiding block offset vector is used to guide the decoder to look up a reference block at a center position corresponding to the current reference block. With the setting of the second guiding block offset vector, the decoder can be guided to take a reference block at a top-left position into consideration. The third guiding block offset vector can be used to guide the decoder to take a reference block at a bottom-left position into consideration. The fourth guiding block offset vector helps the decoder take a reference block at a top-right position into consideration. The fifth guiding block offset vector can be used to guide the decoder to take a reference block at a bottom-right position into consideration. With the setting of these guiding block offset vectors, it is conducive to exploring possible reference block positions more comprehensively within a search region, so as to improve accuracy and adaptability of motion estimation. In practice, the setting of these guiding block offset vectors can be adjusted according to characteristics and requirements of a scenario.

S4032, the relocated block vector corresponding to the current guiding block vector is determined based on the guiding block offset vector.

In some embodiments of the disclosure, the relocated block vector corresponding to the current guiding block vector can be determined based on the guiding block offset vector in S4032 as follows. A current guiding block offset vector is determined from the guiding block offset vector. If the current guiding block offset vector is available, a relocated block vector corresponding to the current guiding block offset vector is determined according to a block vector for a candidate reference block corresponding to the current guiding block offset vector, where the relocated block vector corresponding to the current guiding block offset vector is one of the relocated block vectors corresponding to the current guiding block vector. Alternatively, if the current guiding block offset vector is unavailable, the current guiding block offset vector is skipped and proceed to determining a next guiding block offset vector from the guiding block offset vector.

In some embodiments of the disclosure, determine that the current guiding block offset vector is available if one or more of the following conditions are satisfied: the current guiding block offset vector exists; a candidate reference block indicated by the current guiding block offset vector is reconstructed; a template cost value corresponding to the current guiding block offset vector is less than or equal to a first threshold; the candidate reference block indicated by the current guiding block offset vector is within a preset range; or a prediction mode for the candidate reference block indicated by the current guiding block offset vector is an IBC mode or an IntraTMP mode. Alternatively, determine that the current guiding block offset vector is unavailable if one or more of the following conditions are satisfied: the current guiding block offset vector does not exist; the candidate reference block indicated by the current guiding block offset vector is not reconstructed; the template cost value corresponding to the current guiding block offset vector is greater than the first threshold; the candidate reference block indicated by the current guiding block offset vector is not within the preset range; or the prediction mode for the candidate reference block indicated by the current guiding block offset vector is not an IBC mode or an IntraTMP mode.

In embodiments of the disclosure, “the current guiding block offset vector exists” means that during processing in the current round, the guiding block offset vector is already generated by means of an algorithm, which is generally obtained through template matching or other technologies.

In embodiments of the disclosure, “the candidate reference block indicated by the current guiding block offset vector is reconstructed” means that the current guiding block offset vector indicates a candidate reference block used for the current round, and the reference block may have been reconstructed in previous processing or obtained through other means.

In embodiments of the disclosure, “the template cost value corresponding to the current guiding block offset vector is less than or equal to the first threshold” means that performance of the current guiding block offset vector in template matching is determined to be good enough, and the template cost value of the current guiding block offset vector is less than or equal to a preset threshold. The threshold is generally determined according to application requirements and performance considerations.

In embodiments of the disclosure, “the candidate reference block indicated by the current guiding block offset vector is within the preset range” refers to ensuring that the position of the candidate reference block is within a preset search range. The search range can be determined according to factors such as prior knowledge and picture resolution.

In embodiments of the disclosure, the prediction mode for the candidate reference block indicated by the current guiding block offset vector is the IBC mode or the IntraTMP mode, which ensures that a specified prediction mode is applied to the candidate reference block, which may be a bi-predictive IBC mode or an IntraTMP mode.

In embodiments of the disclosure, based on the above conditions, if the current guiding block offset vector satisfies these conditions, then the vector is considered to be “available” and can be used for subsequent processing steps, such as block reconstruction, block vector list update, etc. The purpose of this process is to select a candidate block with better performance in template matching, so as to improve overall prediction accuracy.

It can be understood that, on one hand, when a series of conditions are satisfied, it is possible to ensure that a candidate reference block corresponding to a selected guiding block offset vector meets requirements in all aspects, including template matching cost, position, prediction mode, etc. As such, it is conducive to improving reconstruction accuracy of a block, thereby improving overall video decoding performance. On one hand, by selectively using a guiding block offset vector that satisfies the conditions, computational complexity of subsequent processing is reduced. Block vectors and candidate reference blocks that do not satisfy the conditions can be excluded, thereby optimizing overall performance of an algorithm. On one hand, by excluding unsuitable candidate reference blocks and block vectors, chances of possible errors are reduced, which helps improve stability and reliability. On one hand, by excluding block vectors that do not satisfy the conditions at an early stage, the speed of video decoding is increased. This is especially important for speed-sensitive applications such as real-time video decoding and streaming media transmission. By selectively using high-quality block vectors and candidate reference blocks, decoder resources can be better utilized, thereby optimizing video decoding performance.

In embodiments of the disclosure, the current guiding block offset vector is firstly determined. Guiding block offset vectors are a set of vectors, where each vector represents an offset relative to a position of a current reference block. The guiding block offset vectors herein typically include offsets in multiple directions, for example, top-left, bottom-left, top-right, bottom-right, etc. Then, the relocated block vector corresponding to the current guiding block offset vector is determined according to the block vector for the candidate reference block corresponding to the current guiding block offset vector and the current guiding block offset vector. This process can include two cases.

Case 1: if the current guiding block offset vector is available, then the relocated block vector corresponding to the current guiding block offset vector is determined according to the block vector for the candidate reference block corresponding to the current guiding block offset vector. This relocated block vector can be one of the relocated block vectors corresponding to any current guiding block vector.

Specifically, a position of a reference block can be determined according to the current guiding block offset vector. Based on the position, the block vector for the candidate reference block is obtained, where the block vector is position information relative to the current block. If the guiding block offset vector is available, the relocated block vector corresponding to the current guiding block offset vector is determined according to the block vector for the candidate reference block, where the relocated block vector represents a refinement of the position of the current block relative to the candidate reference block. If there are multiple guiding block offset vectors, proceed to processing of a next guiding block offset vector. This may involve iteratively traversing all guiding block offset vectors, so as to find the most suitable relocated block vector.

Case 2: if the current guiding block offset vector is unavailable, the current guiding block offset vector is skipped, and proceed to determining the next guiding block offset vector among the guiding block offset vectors. This means that in the current case, the current guiding block offset vector is not taken into consideration, and instead, proceed to attempting other available guiding block offset vectors.

It can be understood that, through the above steps, a suitable relocated block vector is found for the current block, so as to predict the position of the current block more accurately, which helps improve accuracy of block vector prediction, especially for the case where there is complex motion.

In some embodiments of the disclosure, the implementation of determining the relocated block vector corresponding to the current guiding block offset vector according to the block vector for the candidate reference block corresponding to the current guiding block offset vector and the current guiding block offset vector can include the following two cases.

Case 1: if a bi-predictive IBC mode is not to be applied to the candidate reference block, vector addition is performed on the block vector for the candidate reference block corresponding to the current guiding block offset vector and the current guiding block vector, to obtain the relocated block vector corresponding to the current guiding block offset vector.

In embodiments of the disclosure, vector addition is performed on the block vector for the candidate reference block corresponding to the current guiding block offset vector and the current guiding block vector. The purpose of such operation is to refine the block vector for the candidate reference block by taking into account offset for the current guiding block vector. Exemplarily, if the block vector for the candidate reference block is represented by BV1 and the current guiding block vector is represented by BV2, then a refined block vector, i.e., the relocated block vector corresponding to the current guiding block offset vector, will be obtained through vector addition BV1+BV2. The result of the vector addition is the relocated block vector corresponding to the current guiding block offset vector.

It should be understood that, in the above process, the block vector for the candidate reference block is refined according to offset information of the current guiding block vector, so as to predict the position of the current block more accurately.

Case 2: if a bi-predictive IBC mode is to be applied to the candidate reference block, a first reference block vector and a second reference block vector corresponding to the candidate reference block are determined. Vector addition is performed on the first reference block vector and the current guiding block vector to determine a first relocated block vector corresponding to the current guiding block offset vector. Vector addition is performed on the second reference block vector and the current guiding block vector to determine a second relocated block vector corresponding to the current guiding block offset vector.

In embodiments of the disclosure, for bi-predictive IBC, each block may have two reference blocks, i.e., a first reference block and a second reference block. Both reference blocks have corresponding block vectors. Therefore, the decoder needs to obtain the first reference block vector and the second reference block vector corresponding to the candidate reference block.

In embodiments of the disclosure, the first relocated block vector=the first reference block vector+the current guiding block vector. The second relocated block vector=the second reference block vector+the current guiding block vector. Through the two vector addition operations, the first relocated block vector and the second relocated block vector corresponding to the current guiding block offset vector are obtained. In this way, the position of the candidate reference block under the bi-predictive IBC mode can be represented more accurately, which helps improve block prediction accuracy.

It can be understood that, on one hand, by applying the bi-predictive IBC mode, reference blocks in two different directions are considered, which helps capture motion information of a target block more accurately. As such, it is possible to improve prediction accuracy, especially for the case where there is complex motion. On one hand, by means of bi-predictive IBC, modeling can be performed in two directions of the target block, and for the scenario where there is complex motion, it is conducive to better adaptation to various motion patterns, thereby improving overall video decoding efficiency. Since motion information of two directions is taken into consideration in bi-predictive IBC, a wider variety of possible motion can be captured, which is possible to better adapt to motion characteristics of different blocks in a video sequence during decoding.

S404, proceed to determining, from the relocated block vectors corresponding to the guiding block vectors for the current round, a guiding block vector for a next round that satisfies the first preset condition, to obtain a next updated second block vector candidate list until the guiding block vector for the next round satisfies a second preset condition, and the last updated second block vector candidate list is taken as the second block vector candidate list.

In embodiments of the disclosure, there may be multiple candidate block vectors among the first candidate block vectors. Firstly, based on the first preset condition, guiding block vectors for the current round that satisfy the condition are selected. The condition may include: a template cost is less than or equal to a certain threshold, a reference block corresponding to a guiding block vector is reconstructed, etc. Further, for the selected guiding block vectors for the current round, corresponding relocated block vectors are generated by means of a corresponding algorithm or rule, and the relocated block vectors generated are added to the current second block vector candidate list to obtain the updated current second block vector candidate list. Then, for the guiding block vectors for the current round, corresponding relocated block vectors are determined according to a reference block and/or the current block. Based on the first preset condition, the guiding block vectors for the next round that satisfy the condition are selected. In each round, through an iterative updating process, a next second block vector candidate list is obtained. This process may be repeated multiple times until the second preset condition is satisfied, i.e., a final second block vector candidate list is obtained.

It should be understood that, the above flow is a process of determining appropriate block vectors according to a preset condition through multiple rounds of iterative selection and updating, so as to generate the final second block vector candidate list, which helps to predict more accurately motion information of the current block during video decoding.

In embodiments of the disclosure, the second preset condition is a termination condition for multiple rounds of iterative selection.

In some embodiments of the disclosure, the second preset condition includes one or more of: the next round exceeds or reaches an iteration threshold; the number of guiding block vectors for the next round is less than or equal to a third threshold; a template cost value corresponding to each of at least one guiding block vector in the guiding block vectors for the next round is greater than or equal to a fourth threshold; or a list length of the next updated second block vector candidate list corresponding to the next round is greater than or equal to a maximum list-length threshold.

In embodiments of the disclosure, the next round exceeds or reaches the iteration threshold, which can ensure that iteration of the next round is performed only after the number of iterations reaches a certain threshold, so as to avoid infinite iteration or stopping iteration prematurely when iterations are insufficient.

In embodiments of the disclosure, the number of guiding block vectors for the next round is less than or equal to the third threshold. This condition is used to limit the number of guiding block vectors selected for each round, which is probably for the purpose of controlling computational complexity and thus preventing selecting too many guiding block vectors.

In embodiments of the disclosure, the template cost value corresponding to each of at least one guiding block vector in the guiding block vectors for the next round is greater than or equal to the fourth threshold. This condition requires that, in the guiding block vectors for the next round, at least one guiding block vector has a template cost at a certain threshold, which helps to ensure that the block vector(s) selected is more relevant. This condition may also require that the guiding block vectors for the next round have at least one guiding block vector whose template cost is sufficiently low, so as to ensure the quality of candidate blocks.

In embodiments of the disclosure, the list length of the next updated second block vector candidate list corresponding to the next round is greater than or equal to the maximum list-length threshold. This condition can ensure that the updated second block vector candidate list for the next round has sufficient information to guarantee that there are enough candidate block vectors for iteration of the next round. This condition may also be used to control the length of a candidate list to prevent the candidate list from being too large, so as to save computational resources or meet other algorithm design requirements.

It should be noted that, the second preset condition listed above is merely an example, and in actual application scenarios, other condition settings can also be included, which is not limited in the disclosure.

It can be understood that, on one hand, through an iterative process, guiding block vectors that satisfy a certain condition can be selected in each round, which may lead to higher accuracy in block vector selection, thereby improving accuracy of motion estimation for the current block. By adding the relocated block vectors corresponding to the guiding block vectors for the current round to the current second block vector candidate list, it helps to concentrate the selected block vectors into the second block vector candidate list, which reduces selection of redundant block vectors, thereby improving computational efficiency. On one hand, by adjusting selection of guiding block vectors and relocated block vectors in each round, such method may have certain flexibility and can better adapt to variation and complexity of motion in a video. By selecting and updating block vectors according to a preset condition(s), it is possible to perform motion estimation more efficiently in terms of computational cost, thereby avoiding processing a large amount of redundant information.

In some embodiments of the disclosure, if the first block vector candidate list is the first candidate list, the first block vector candidate list for the current block can be determined in S302 as follows. The first candidate list is determined, and the first candidate list is taken as the first block vector candidate list. The first candidate list is determined as follows. Search within a preset search range at a preset step size to obtain first matching block vectors. A first block vector having the smallest template cost is determined from the first matching block vectors. The first candidate list is determined according to the first block vector.

In embodiments of the disclosure, the preset search range refers to a search region predefined for finding the best matching block during motion estimation. The size of the search range is usually set according to a coding standard or decoder parameters, which defines a spatial range for finding a matching block in a reference picture. The searching process is completed by calculating similarities between the current block and blocks at various possible positions in the reference picture. To reduce computational complexity, searching is typically performed at a certain step size, where the step size is also pre-set. If a wide search range is adopted, it is conducive to handling significant motions, but computational complexity will be increased. If a narrow search range is adopted, computational burden can be reduced, but it may result in failure to find the best match, especially for the case where there is significant motion.

In embodiments of the disclosure, the preset search range is a parameter that balances decoding performance and computational complexity. By setting the search range appropriately, a video coder can meet performance requirements while maintaining low computational overhead.

In embodiments of the disclosure, the template cost is a metric for measuring similarity between two blocks. After the first matching block vectors are found within the search range, the template cost of each matching block needs to be calculated, and then a block vector having the smallest template cost is selected as the best matching block vector. The template cost is usually calculated by comparing sample values of the current block and sample values of a block at a corresponding position in the reference picture. The common method for template cost calculation includes MSE and SAD. When calculating the template cost, each sample in the two blocks is traversed and a difference therebetween is calculated, and then the sum or sum of squares is obtained. Determining the block vector having the smallest template cost means selecting a reference block within the search range that best matches the current block.

In embodiments of the disclosure, searching is performed within a given search range at a preset step size to find blocks that match the current block. During searching, blocks most similar to the current block are found, and the first matching block vectors are obtained, where the vectors represent positional offsets for the matching blocks found during searching. For the first matching block vectors, template matching costs are calculated in neighbouring regions of the matching blocks. The first block vector having the smallest template cost is found, which represents the best match. According to the first block vector, the first candidate list can be determined. For example, the first block vector and related information of the first block vector are added to the candidate list in order for subsequent processing.

It can be understood that, on one hand, by searching for the best matching block within the preset search range, the motion of the current block can be described more accurately. This helps improve decoding efficiency, because in video compression, motion estimation is intended to reduce redundant information. On one hand, by finding the best match, similarity between neighbouring pictures can be exploited, thereby better utilizing spatial correlation. This helps improve video compression performance and reduce video file size. By estimating motion more accurately, a video decoder can better reconstruct pictures, thereby improving video quality and detail restoration.

In some embodiments of the disclosure, if the first block vector candidate list is the second candidate list, the first block vector candidate list for the current block can be determined in S302 as follows. The second candidate list is determined, and the second candidate list is taken as the first block vector candidate list. The second candidate list is determined as follows. The second candidate list is determined according to second block vectors, where a matching block corresponding to each of the second block vectors has similar motion to the current block.

In embodiments of the disclosure, the matching block corresponding to each of the second block vector is a block that has similar motion to the current block in the first round of search. This means that the second block vectors are selected during the first round of search, which indicates that the matching blocks corresponding to the second block vectors have similar motion to the current block. According to these matching blocks having similar motion, the second candidate list can be constructed. Specifically, the second block vector together with the corresponding matching block thereof typically forms a candidate block pair. The matching block of the candidate block pair has similar motion to the current block, and thus the second block vector can be considered as a potential motion vector. Information of these candidate block pairs is arranged into the second candidate list for use in subsequent steps. The purpose of construction of the second candidate list is to locate more finely blocks having similar motion, so as to improve accuracy of motion estimation. With such a two-round search strategy, it is possible to better adapt to a scenario where there are different motions in a video while ensuring computational efficiency.

In some embodiments of the disclosure, the second candidate list includes one or more of: block vectors corresponding to one or more spatial neighbouring candidate blocks; block vectors corresponding to one or more spatial non-neighbouring candidate blocks; block vectors obtained according to one or more IBC history block vector buffers; an average block vector of one or more existing block vectors in a current second candidate list; one or more block vectors predefined based on the size of the current block; one or more relocated block vectors constructed for the first candidate block vector.

In embodiments of the disclosure, with regard to the block vector corresponding to the spatial neighbouring candidate block, the spatial neighbouring candidate block refers to a block that is spatially neighbouring the current block in a picture space. In video coding or picture processing, “spatial” typically means a neighbouring region in a picture. Therefore, a spatial neighbouring block refers to a block neighbouring the current block in a picture. Selection of neighbouring block(s) typically depends on the specific application scenario and algorithm. For example, four neighbouring blocks of the current block, i.e., a top neighbouring block, a bottom neighbouring block, a left neighbouring block, and a right neighbouring block, can be selected, or more complex spatial neighbour relationships can be utilized. Block vectors (motion vectors) for these neighbouring blocks may be used as references in video decoding or picture processing to improve compression efficiency or perform picture reconstruction.

In embodiments of the disclosure, the spatial non-neighbouring candidate block refers to a block that is not neighbouring the current block in a picture space. For example, some block far away from the current block may be selected as the non-neighbouring candidate block so as to better capture motion and texture information.

In embodiments of the disclosure, the block vector obtained according to the IBC history block vector buffer refers to a block vector obtained according to information stored in the history block vector buffer. In video decoding, IBC is a technology in which a block in a current picture can be directly copied from a block in a previous picture without performing motion estimation. These history block vector buffers store block vector information of previous pictures for use for the current picture. If the information stored in the history block vector buffer is selected for use, the system checks whether there is a block in the buffer similar to the current block, and then directly uses a block vector for the block as the block vector for the current block. As such, it is possible to reduce computational overhead of motion estimation and in some cases, improve decoding efficiency. The actual effect of this method may be affected by factors such as the content of a video sequence, the nature of motion, and the buffer strategy.

In embodiments of the disclosure, the average block vector corresponding to the existing block vectors in the current second candidate list refers to an average block vector obtained from existing block vectors in a second candidate list at a current processing stage. Typically, in order to improve decoding efficiency, the system may consider using some already determined block vectors when processing the current block, and these block vectors may be obtained from previously processed pictures. By averaging these existing block vectors, an average block vector can be obtained, where the average block vector represents an average motion characteristic of the known similar blocks. The purpose of using the average block vector is to improve accuracy and efficiency of motion estimation when there is certain similarity between the current block and the previous blocks.

In embodiments of the disclosure, the block vectors predefined based on the size of the current block refer to a set of block vectors that are predefined according to the size of the current block during decoding or processing. These block vectors are usually predefined according to video decoding standards or specific requirements of applications. Typically, a set of possible block sizes and corresponding block vectors is defined according to certain rules and standards to adapt to motions of different magnitudes. Such predefined block vectors can be used to select an appropriate motion vector for the current block during a motion estimation stage. The purpose of this method is to reduce complexity of motion estimation while providing sufficient flexibility in practical applications by providing a limited set of possibilities.

In embodiments of the disclosure, the relocated block vectors constructed for the first candidate block vector mean a set of block vectors related to the first candidate block vector generated based on the first candidate block vector, and these block vectors are generally referred to as relocated block vectors. The relocated block vectors may be vectors that are obtained by adjusting the first candidate block vector in order to better adapt to motion in a video sequence. Such adjustment may involve spatial neighbouring block(s), non-neighbouring block(s), the history block vector buffer(s), or other information. By adjusting the first candidate block vector, a set of block vectors related to the first candidate block vector can be obtained, and these block vectors may reflect more accurately motion characteristics of the current block, which helps to improve accuracy of motion estimation, thereby improving efficiency of video decoding.

It can be understood that, the foregoing content of the second candidate list provides diversified block vectors. By selecting appropriate block vectors from these sources according to actual needs, it is possible to improve accuracy and stability of motion estimation, so as to improve the effectiveness of video decoding or picture processing.

In some embodiments of the disclosure, determining the second candidate list according to the second block vectors includes S501~S504.

S501, a bitstream is parsed to determine a first maximum list length.

In embodiments of the disclosure, the decoder parses the bitstream to obtain the first maximum list length, which indicates a maximum list length of the second candidate list.

S502, for a current second block vector in the second block vectors, the current second block vector is added to a current second candidate list to obtain an updated current second candidate list.

In embodiments of the disclosure, the decoder firstly selects the current second block vector as a candidate based on previous motion estimation or other algorithms, and adds the selected current second block vector to the current second candidate list. Then, the decoder adds a new current second block vector into the existing second candidate list to obtain the updated current second candidate list.

In some embodiments of the disclosure, the current second block vector can be added to the current second candidate list to obtain the updated current second candidate list in S502 as follows. If the current second block vector satisfies a third preset condition, the current second block vector is added to the current second candidate list to obtain the updated current second candidate list. Alternatively, if the current second block vector does not satisfy the third preset condition, the current second block vector is skipped and proceed to adding a next second block vector to the updated current second candidate list to obtain a next updated second candidate list.

In embodiments of the disclosure, if the third preset condition is satisfied, it may indicate that the current second block vector has some specific attributes or quality such that the current second block vector is qualified to be added to the current second candidate list. Such condition may be intended to ensure that a block vector for updating the list has certain quality or characteristics, so as to improve performance of video decoding. The following are some possible examples of the third preset condition:
1) Quality criterion: a template cost of the current second block vector is lower than a preset threshold, which means that the vector has high matching quality;
2) Motion vector direction: the motion direction or pattern of the current second block vector satisfies a specific motion model or requirement;
3) Stability criterion: a motion estimation result of the current second block vector is relatively consistent with a motion estimation result of a previous picture, and is less susceptible to noise or interference;
4) Reference block quality: the quality of a reference block corresponding to the current second block vector satisfies some preset conditions, such as sharpness, texture, etc., of the reference block in a picture.

It can be understood that, when the third preset condition is satisfied, the current second block vector is added to the current second candidate list, which helps to ensure that block vectors in the list have certain quality and accuracy, thereby improving performance of subsequent video decoding steps, in that it can optimize picture decoding and reconstruction by selecting more reliable and accurate motion information.

In some embodiments of the disclosure, the third preset condition includes one or more of: a reference block corresponding to the current second block vector does not exceed a search range for an IntraTMP mode; the reference block corresponding to the current second block vector does not exceed the size of a picture boundary of the current block; the reference block corresponding to the current second block vector does not exceed the size of a reconstructed region in a current picture; the reference block corresponding to the current second block vector does not exceed the size of a CTU corresponding to the current block; or a template cost value corresponding to the current second block vector is less than or equal to a preset threshold, where the preset threshold is obtained according to template cost values corresponding to block vectors added in the first block vector candidate list and/or the second block vector candidate list.

In embodiments of the disclosure, the third preset condition includes the following two types of restrictions.

### 1) Restriction on Position of Reference Block

The reference block corresponding to the current second block vector does not exceed the search range for the IntraTMP mode, so as to ensure that the selected reference block is within the search range for intra template matching.

The reference block corresponding to the current second block vector does not exceed the size of the picture boundary of the current block, so as to prevent selecting a reference block that is beyond the picture boundary of the current block.

The reference block corresponding to the current second block vector does not exceed the size of the reconstructed region in the current picture, so as to restrict the reference block to within the reconstructed region.

The reference block corresponding to the current second block vector does not exceed the size of the CTU corresponding to the current block, so as to ensure that the reference block is within the CU of the current block.

### 2) Restriction on Template Cost

The template cost corresponding to the current second block vector is less than or equal to the preset threshold, so as to ensure that a template matching cost of the selected block vector is within an acceptable range, thereby preventing low-quality motion estimation. By setting the preset threshold, the system can exclude a block vector whose template matching cost is too large, thereby ensuring that the selected motion vector is of high quality.

It can be understood that, the above conditions help to optimize selection of the reference block, thereby ensuring that good performance can be achieved by using the selected vector and reference block in video coding. By restricting the position, quality, and search range of the reference block, it is conducive to preventing selecting an inappropriate motion vector, thereby improving effectiveness of video decoding.

S503, if the number of second block vectors in the updated current second candidate list is less than the first maximum list length, proceed to adding a next second block vector to the updated current second candidate list to obtain a next updated second candidate list until the number of second block vectors in the next updated second candidate list is equal to the first maximum list length, and the last updated second candidate list is taken as the second candidate list.

S504, if the number of second block vectors in the updated current second candidate list is equal to the first maximum list length, the updated current second candidate list is taken as the second candidate list.

In embodiments of the disclosure, under an initial condition, the number of second block vectors in the updated current second candidate list is less than the first maximum list length. For a next second block vector, whether the next second block vector satisfies the third preset condition is determined. If the next second block vector satisfies the third preset condition, the next second block vector is added to the updated current second candidate list. Whether the number of second block vectors in the updated current second candidate list is still less than the first maximum list length is determined. If the number of second block vectors in the updated current second candidate list is less than the first maximum list length, the above steps are repeated to add a next second block vector until the number of second block vectors in the updated current second candidate list is equal to the first maximum list length.

It should be understood that, the purpose of the above process is to limit the length of the second candidate list, so as to control computational complexity and ensure efficient processing in subsequent steps. By adding second block vectors one by one and determining whether the condition is satisfied, the updated second candidate list can be dynamically constructed, thereby ensuring that the list length is within a controllable range.

It should be noted that, S503 and S504 are parallel schemes, that is, the decoder can perform S503, or can perform S504, and no limitation is imposed thereon in the disclosure.

In embodiments of the disclosure, the decoder parses the bitstream to obtain information that is needed. After parsing the bitstream, the decoder determines the first maximum list length, which is a maximum length allowed for the second candidate list. Further, for the current second block vector among the second block vectors, the decoder adds the current second block vector to the current second candidate list to obtain the updated current second candidate list. Further, if the number of second block vectors in the updated current second candidate list is less than the first maximum list length, the decoder proceeds to the next step; otherwise, the decoder directly uses the updated current second candidate list as the final second candidate list. Then, if the length of the updated current second candidate list has not reached the first maximum list length, the decoder proceeds to adding a next second block vector to the updated current second candidate list to obtain the updated next second candidate list. Further, if the number of second block vectors in the updated current second candidate list is equal to the first maximum list length, the decoder takes the updated current second candidate list as the final second candidate list, where the list includes second block vectors that satisfy the preset condition and can be used in subsequent steps.

It can be understood that, by constructing the second candidate list gradually, the decoder can flexibly control the length of the list and obtain a set of second block vectors that can be used for subsequent processing if the condition is satisfied, thereby improving performance and effectiveness of applications such as video decoding.

In some embodiments of the disclosure, the decoding method further includes the following. Redundancy removal is performed on the second block vectors added in the current second candidate list.

In some embodiments of the disclosure, redundancy removal can be performed on the second block vectors added in the current second candidate list as follows. For any second block vector added in the current second candidate list, the current second block vector is added to the current second candidate list to obtain the updated current second candidate list, if a difference value in a horizontal direction between the current second block vector and the second block vector added is less than or equal to a fifth threshold and a difference value in a vertical direction between the current second block vector and the second block vector added is less than or equal to the fifth threshold; alternatively, the current second block vector is skipped and proceed to adding the next second block vector to the updated current second candidate list to obtain the next updated second candidate list, if the difference value in a horizontal direction between the current second block vector and the second block vector added is greater than the fifth threshold or the difference value in a vertical direction between the current second block vector and the second block vector added is greater than the fifth threshold.

In embodiments of the disclosure, the fifth threshold is a preset value. Exemplarily, the fifth threshold is 0.

In embodiments of the disclosure, any one second block vector added is selected from the current second candidate list, the difference value in a horizontal direction between the current second block vector and the selected second block vector added and the difference value in a vertical direction between the current second block vector and the selected second block vector added are calculated, and whether the difference value in a horizontal direction is less than or equal to the fifth threshold and whether the difference value in a vertical direction is less than or equal to the fifth threshold are determined. If it is determined that the condition is satisfied, that is, both the difference value in a horizontal direction and the difference value in a vertical direction are within the threshold range, the system adds the current second block vector to the current second candidate list to obtain the updated current second candidate list. The above steps are repeatedly performed for other second block vectors added in the current second candidate list.

It can be understood that, through this step, the decoder can further perform selection and update the current second candidate list according to a determination on neighbourhood in a horizontal direction and in a vertical direction, so as to ensure that the second block vectors in the current second candidate list are more consistent or similar in position, which helps to improve stability and quality of applications such as video decoding.

In some embodiments of the disclosure, redundancy removal can be performed on the second block vectors added in the current second candidate list as follows. If the first candidate list is constructed, redundancy removal is performed on the second block vectors added in the current second candidate list according to the first candidate list.

In some embodiments of the disclosure, redundancy removal can be performed on the second block vectors added in the current second candidate list according to the first candidate list as follows. For any second block vector added in the current second candidate list and any first block vector added in the first candidate list, the current second block vector is added to the current second candidate list to obtain the updated current second candidate list, if a difference value in a horizontal direction between the current second block vector and the second block vector added and a difference value in a horizontal direction between the current second block vector and the first block vector added each are less than or equal to a fifth threshold, and a difference value in a vertical direction between the current second block vector and the second block vector added and a difference value in a vertical direction between the current second block vector and the first block vector added each are less than or equal to the fifth threshold; alternatively, the current second block vector is skipped and proceed to adding a next second block vector to the updated current second candidate list to obtain the next updated second candidate list, if the difference value in a horizontal direction between the current second block vector and the second block vector added and the difference value in a horizontal direction between the current second block vector and the first block vector added each are greater than the fifth threshold, or the difference value in a vertical direction between the current second block vector and the second block vector added and the difference value in a vertical direction between the current second block vector and the first block vector added is greater than the fifth threshold.

It can be understood that, the decoder can comprehensively consider a difference between second block vectors and a difference between the second block vector and the first block vector according to a determination on neighbourhood in a horizontal direction and a vertical direction, and further perform selection and update the current second candidate list, which helps to improve stability and quality of applications such as video coding.

In some embodiments of the disclosure, the fifth threshold depends on the size of the current block and/or a vector precision of the current second block vector.

In embodiments of the disclosure, the fifth threshold depends on the size of the current block and/or the vector precision of the current second block vector, which means that the fifth threshold may be adjusted according to the size of a video picture or picture block which is being processed and the precision level of vector representation of the current second block vector. Such correlation may be intended to adapt to processing requirements under different resolutions, picture sizes, or coding settings.

In embodiments of the disclosure, with regard to adjustment of the fifth threshold, there can be the following two cases.

Case 1: with regard to the size of the current block, if the size of a video picture or picture block changes, the fifth threshold may be adjusted accordingly. A larger block may require a larger threshold so as to adapt to differences between large-sized blocks more flexibly. A smaller block may require a smaller threshold so as to detect similarities between small-sized blocks more sensitively.

Case 2: with regard to the vector precision of the current second block vector, vector precision refers to the number of bits or the precision of vector representation. A higher vector precision can lead to a more precise representation, but may also introduce slight differences between neighbouring blocks. Therefore, a threshold related to vector precision may be appropriately decreased under high precision to handle these slight variations, whereas a higher threshold may be needed under low precision.

It can be understood that, by adjusting the fifth threshold, the decoder can adapt flexibly to different video processing requirements under different scenarios and configurations, so as to achieve better performance and quality.

In some embodiments of the disclosure, the decoding method further includes the following. A first reference value is adjusted according to the size of the current block to obtain the fifth threshold. The first reference value is adjusted according to the size of the current block to obtain the fifth threshold as follows. If the size of the current block is greater than or equal to a first preset value, the first reference value is increased to obtain the fifth threshold. Alternatively, if the size of the current block is less than the first preset value, the first reference value is decreased to obtain the fifth threshold.

In embodiments of the disclosure, the first reference value is adjusted based on a condition related to the first preset value, to obtain the fifth threshold. With such adjustment manner, the system may dynamically adjust the threshold according to the size of a currently processed block so as to better adapt to blocks of different sizes. Specifically, there are the following two cases.

Case 1: the size of the current block is greater than or equal to the first preset value. In this case, the decoder increases the first reference value. This means that for a larger block, the decoder wishes to increase tolerance of differences between blocks, and therefore applies a larger fifth threshold.

Case 2: the size of the current block is less than the first preset value. In this case, the decoder decreases the first reference value. This means that for a smaller block, the decoder is more concerned with slight differences between blocks, and therefore applies a smaller fifth threshold.

It can be understood that, with such method for dynamic adjustment, it is conducive to achieving better performance and adaptability on blocks of different sizes. According to the size of a block, the decoder can flexibly adjust the threshold so as to perform matching and processing more effectively.

In some embodiments of the disclosure, the decoding method further includes the following. A second reference value is adjusted according to the vector precision of the current second block vector to obtain the fifth threshold. The second reference value is adjusted according to the vector precision of the current second block vector to obtain the fifth threshold as follows. If the vector precision of the current second block vector is greater than or equal to a second preset value, the second reference value is decreased to obtain the fifth threshold. Alternatively, if the vector precision of the current second block vector is less than the second preset value, the second reference value is increased to obtain the fifth threshold.

In embodiments of the disclosure, adjustment of the fifth threshold may depend on the vector precision of the current second block vector. There are the following two cases.

Case 1: the vector precision of the current second block vector is greater than or equal to the second preset value. In this case, the decoder will decrease the second reference value, thereby obtaining a smaller fifth threshold. This means that the decoder is more concerned with slight differences between blocks for the case where the vector precision is high.

Case 2: the vector precision of the current second block vector is less than the second preset value. In this case, the decoder will increase the second reference value, thereby obtaining a larger fifth threshold. This means that the system is more tolerant of differences between blocks for the case where the vector precision is low.

It can be understood that, with such dynamic adjustment method, it helps to achieve better performance and adaptability under different vector precision conditions. By adjusting the threshold according to the vector precision, the decoder can handle more flexibly vectors of different precision, so as to better match characteristics between blocks. As such, it is conducive to improving robustness and performance of the decoder.

In some embodiments of the disclosure, if the first block vector candidate list is the third candidate list, the first block vector candidate list for the current block can be determined in S302 as follows. The first candidate list is determined and the second candidate list is determined. The third candidate list is determined according to the first candidate list and the second candidate list, and the third candidate list is taken as the first block vector candidate list. The third candidate list is determined according to the first candidate list and the second candidate list as follows. K first block vectors in the first candidate list are merged with L second block vectors in the second candidate list to obtain the third candidate list, where K and L each are a positive integer, K≥1, and L≥1.

In some embodiments of the disclosure, the implementation of merging K first block vectors in the first candidate list with L second block vectors in the second candidate list to obtain the third candidate list can include the following two cases.

Case 1: P candidate block vectors having the smallest template costs are determined from the K first block vectors and the L second block vectors, where P is a positive integer and 1≤P≤K+L. The third candidate list is determined according to the P candidate block vectors.

In embodiments of the disclosure, given K first block vectors and L second block vectors, in order to determine P candidate block vectors having the smallest template costs, it is typically necessary to perform template matching or other cost calculation operations on the K first block vectors and L second block vectors. Exemplarily, for each combination of first block vector and second block vector, a template matching cost or other related cost values of the combination is calculated. P combinations having the smallest costs are selected from all combinations, which may involve arrangement or other selection algorithms to ensure that the selected P combinations have the smallest costs. Based on the selected P combinations, the third candidate list is constructed, where the list includes the P candidate block vectors having the smallest template costs. The above process involves calculating and selecting vector combinations to find the P combinations having the smallest costs, and then using the P combinations as part of the third candidate list.

Case 2: for a j^{th} candidate block vector among the K first block vectors and the L second block vectors, the j^{th} candidate block vector is added to a current third candidate list to obtain an updated current third candidate list, where j is a positive integer and 1≤j≤K+L. If the number of candidate block vectors in the updated current third candidate list is less than a second maximum list length, proceed to adding a (j+1)^{th} candidate block vector to the updated current third candidate list to obtain a next updated third candidate list until the number of candidate block vectors in the next updated third candidate list is equal to the second maximum list length, and the last updated third candidate list is taken as the third candidate list. Alternatively, if the number of candidate block vectors in the updated current third candidate list is equal to the second maximum list length, the updated current third candidate list is taken as the third candidate list.

It can be understood that, on one hand, by selecting P candidate block vectors having the smallest template costs, it is possible to ensure that candidate block vectors in the current third candidate list are spatially similar to an actual scenario, thereby improving picture quality. On one hand, by taking the combinations of K first block vectors and L second block vectors into consideration, it helps to improve matching diversity, such that the algorithm can cope with different scenarios and motion situations. On one hand, by adjusting the fifth threshold, the size of the current block and the vector precision of the second block vectors are taken into account, so that the selected candidate blocks can better adapt to picture blocks of different sizes and precision, thereby improving adaptability of the algorithm. On one hand, when generating the current third candidate list, by controlling the list length, it is possible to avoid excessive redundant information, thereby improving efficiency and speed of the algorithm. In summary, with the above process, it helps to select an optimal set of candidate blocks from multiple candidate block vectors taken into consideration, thereby providing better input for subsequent steps so as to perform picture processing and decoding more accurately.

In some embodiments of the disclosure, the decoding method further includes the following. Redundancy removal is performed on candidate block vectors added in the current third candidate list.

In some embodiments of the disclosure, redundancy removal can be performed on the candidate block vectors added in the current third candidate list as follows. For any first block vector and any second block vector added in the current third candidate list, the j^{th} candidate block vector is added to the current third candidate list to obtain the updated current third candidate list, if a difference value in a horizontal direction between the j^{th} candidate block vector and the second block vector is less than or equal to a fifth threshold, a difference value in a vertical direction between the j^{th} candidate block vector and the second block vector is less than or equal to the fifth threshold, a difference value in a horizontal direction between the j^{th} candidate block vector and the first block vector is less than or equal to a sixth threshold, and a difference value in a vertical direction between the j^{th} candidate block vector and the first block vector is less than or equal to the sixth threshold, where the first block vector is from the first candidate list, and the second block vector is from the second candidate list; alternatively, the j^{th} candidate block vector is skipped and proceed to adding the (j+1)^{th} candidate block vector to the updated current third candidate list to obtain the next updated third candidate list, if the difference value in a horizontal direction between the j^{th} candidate block vector and the second block vector is greater than the fifth threshold, or the difference value in a vertical direction between the j^{th} candidate block vector and the second block vector is greater than the fifth threshold, or the difference value in a horizontal direction between the j^{th} candidate block vector and the first block vector is greater than the sixth threshold, or the difference value in a vertical direction between the j^{th} candidate block vector and the first block vector is greater than the sixth threshold.

In embodiments of the disclosure, for any first block vector and any second block vector added in the current third candidate list, two thresholds, which are the fifth threshold and the sixth threshold, are set in a horizontal direction and in a vertical direction. If the difference value in a horizontal direction and the difference value in a vertical direction between the j^{th} candidate block vector and the second block vector each are less than or equal to the fifth threshold, and the difference value in a horizontal direction and the difference value in a vertical direction between the j^{th} candidate block vector and the first block vector is less than or equal to the sixth threshold, proceed to adding the j^{th} candidate block vector to the current third candidate list. Otherwise, if the difference value in a horizontal direction and the difference value in a vertical direction between the j^{th} candidate block vector and the second block vector each are greater than the fifth threshold, or the difference value in a horizontal direction and the difference value in a vertical direction between the j^{th} candidate block vector and the first block vector each are greater than the sixth threshold, the j^{th} candidate block vector is skipped, and proceed to adding the next candidate block vector to the updated current third candidate list. For any first block vector and any second block vector added, by iterating such process, candidate block vectors satisfying a matching condition can be selected, thereby gradually constructing the updated current third candidate list. By setting two thresholds, control over the matching process is enhanced, thereby making the algorithm more flexible and adaptable to different scenarios and motion situations.

It can be understood that, on one hand, by setting difference value thresholds in a horizontal direction and a vertical direction, selection can be performed finely on candidate block vectors in the third candidate list. As such, candidate block vectors that do not meet a specific condition can be excluded, thereby improving matching accuracy. By introducing the fifth threshold and the sixth threshold, the risk of false matching caused by factors such as picture noise or motion blur can be reduced. With such design of difference values, it is possible to better adapt to different picture scenarios and motion situations, thereby making matching results more reliable. On one hand, by adjusting the fifth threshold and the sixth threshold, it is possible to flexibly adapt to different scenarios and requirements. With such adjustability, the algorithm can have good performance under different conditions, and thus have wider applicability. By finely controlling the matching condition, it is more likely to perform matching still robustly under poor picture quality or partial occlusion by means of an algorithm, thereby improving robustness of the algorithm. In summary, through the above steps, it is beneficial to improving accuracy, robustness, and adaptability of the matching process, such that in subsequent steps, further processing can be performed based on information that is more reliable, thereby improving the effectiveness of video decoding and picture processing.

In some embodiments of the disclosure, the fifth threshold depends on the size of the current block and/or a block-level flag for a reference block indicated by the j^{th} candidate block vector.

In embodiments of the disclosure, the fifth threshold depends on the size of the current block and/or the block-level flag for the reference block indicated by the j^{th} candidate block vector, which means that the threshold may be adjusted according to the size of the current block or the block-level flag for the reference block. Specifically, the block-level flag typically indicates the type of the reference block, which may include an intra-block and an inter-block, etc. The two types of blocks have different characteristics in motion estimation and compensation. In practical applications, to adapt to different types of blocks, the fifth threshold can be adjusted according to information in the block-level flag, so as to better adapt to the characteristics of different block types.

For example, for an intra-block, since it usually has greater similarity and lower motion variation, a larger fifth threshold may be selected to be more tolerant of differences in a horizontal direction and a vertical direction. For an inter-block, since it may have more significant motion, a smaller fifth threshold may be needed to reduce the risk of false matching.

It can be understood that, by considering the size of the current block and the block-level flag for the reference block, accuracy and robustness of matching can be better balanced in different scenarios, thereby improving adaptability of an algorithm.

In some embodiments of the disclosure, the decoding method further includes the following. A third reference value is adjusted according to the size of the current block to obtain the sixth threshold. The third reference value is adjusted according to the size of the current block to obtain the sixth threshold as follows. The third reference value is increased to obtain the sixth threshold if the size of the current block is greater than or equal to a third preset value. The third reference value is decreased to obtain the sixth threshold if the size of the current block is less than the third preset value.

In embodiments of the disclosure, if the size of the current block is greater than or equal to the third preset value, the sixth threshold is obtained by increasing the third reference value; conversely, if the size of the current block is less than the third preset value, the sixth threshold is obtained by decreasing the third reference value. With such an adjustment mechanism, it is beneficial to flexibility of the sixth threshold for blocks of different sizes, so as to better adapt to blocks of different sizes. For example, for a smaller block, a more demanding matching condition may be needed, and therefore the sixth threshold is decreased to limit differences; whereas for a larger block, more differences can be tolerated, and therefore the sixth threshold is increased to improve robustness. With such a dynamic adjustment mechanism, it is possible to optimize performance of a matching algorithm under different sizes, thereby improving flexibility and adaptability of the algorithm.

In some embodiments of the disclosure, the decoding method further includes the following. A fourth reference value is adjusted according to the block-level flag for the reference block indicated by the j^{th} candidate block vector to obtain the sixth threshold. The fourth reference value is adjusted according to the block-level flag for the reference block indicated by the j^{th} candidate block vector to obtain the sixth threshold as follows. The fourth reference value is decreased to obtain the sixth threshold if the block-level flag indicates that the reference block corresponding to the j^{th} candidate block vector satisfies a preset prediction mode and/or a preset block feature. Alternatively, the fourth reference value is increased to obtain the sixth threshold if the block-level flag indicates that the reference block corresponding to the j^{th} candidate block vector does not satisfy the preset prediction mode and/or the preset block feature.

In embodiments of the disclosure, if the block-level flag indicates that the reference block corresponding to the j^{th} candidate block vector satisfies the preset prediction mode and/or the preset block feature, the sixth threshold is obtained by decreasing the fourth reference value; conversely, if the block-level flag indicates that the reference block corresponding to the j^{th} candidate block vector does not satisfy the preset prediction mode and/or the preset block feature, the sixth threshold is obtained by increasing the fourth reference value. With such mechanism, the sixth threshold can be adaptively adjusted according to the characteristics of the reference block. If the reference block satisfies the preset condition, by decreasing the fourth reference value, the sixth threshold can be decreased, and as such, a matching algorithm can be more demanding; conversely, if the reference block does not satisfy the preset condition, by increasing the fourth reference value, the sixth threshold can be increased, and as such, the matching algorithm can be more tolerant. With such mechanism, it is possible to adjust the sensitivity of the matching algorithm according to the characteristics of the reference block, such that matching is more accurate and adaptable to different types of reference blocks.

In some embodiments of the disclosure, candidate block vectors in the first block vector candidate list and the second block vector candidate list are all in integer-sample accuracy, and the decoding method further includes the following. If any candidate block vector in the first block vector candidate list and the second block vector candidate list is in fractional-sample accuracy, accuracy conversion is performed on the candidate block vector such that the candidate block vector is in integer-sample accuracy.

In embodiments of the disclosure, for any candidate block vector in the first block vector candidate list and the second block vector candidate list, if the candidate block vector is originally represented in fractional-sample accuracy, accuracy conversion is performed to convert the candidate block vector to integer-sample accuracy representation. Fractional-sample accuracy typically means that the value of a coordinate or vector can be a decimal, i.e., including a fractional part. Integer-sample accuracy representation includes only an integer value without a fractional part.

In embodiments of the disclosure, the purpose of accuracy conversion may be to standardize coordinates or vectors so as to better adapt to or satisfy requirements of picture processing. Such process may include operations such as rounding a coordinate or vector that is originally in fractional accuracy to obtain an integer value, such that subsequent processing is simpler or meets specific algorithm requirements.

It can be understood that, on one hand, in many picture processing algorithms, integer-sample coordinates are easier to compute and process. By performing accuracy conversion on coordinates, it is possible to reduce computational complexity and improve execution efficiency of the algorithm. On one hand, integer-sample coordinates generally require less storage space, because there is no need to store a fractional part, which may be beneficial for application scenarios that are sensitive to memory consumption. On one hand, in some picture processing tasks, integer-sample coordinates may be easier to align with a sample grid of a picture, which may be beneficial for matching and alignment tasks. If an entire algorithm or flow requires that coordinates of inputs or intermediate results are all in integer-sample accuracy, then the consistency of the algorithm can be maintained by performing conversion.

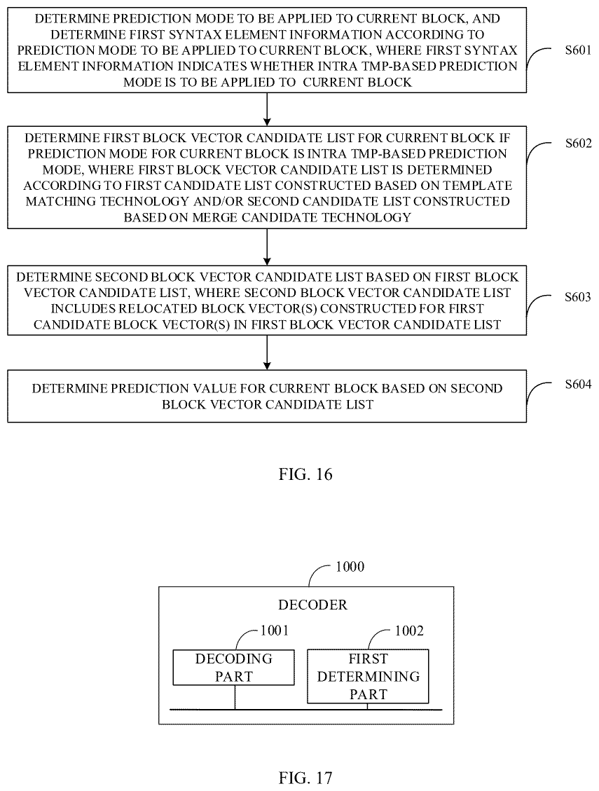

In another embodiment of the disclosure, referring to FIG. 16, which is a schematic flowchart of an encoding method provided in embodiments of the disclosure. As illustrated in FIG. 16, the method can include S601 to S604.

S601, a prediction mode to be applied to a current block is determined, and first syntax element information is determined according to the prediction mode to be applied to the current block, where the first syntax element information indicates whether an IntraTMP-based prediction mode is to be applied to the current block.

It should be noted that, the encoding method in embodiments of the disclosure is applied to an encoder. In addition, the encoding method can specifically refer to a method for extending intra template matching candidates. In an IntraTMP-based prediction mode, the encoding method is mainly aimed at improvement of technology for constructing a candidate list, and more specifically, may be an IntraTMP technology-based prediction method, so as to solve the problem of low diversity of candidate block vectors in the related art which affects encoding efficiency.

In some embodiments of the disclosure, the implementation of determining the prediction mode to be applied to the current block can include S6011 to S6013.

S6011, the current block is pre-encoded by applying multiple candidate prediction modes to obtain loss values corresponding to the multiple candidate prediction modes, where the multiple candidate prediction modes include the IntraTMP-based prediction mode.

S6012, rate-distortion cost calculation is performed on the loss values corresponding to the multiple candidate prediction modes, to obtain rate-distortion cost values corresponding to the multiple candidate prediction modes.

S6013, the prediction mode to be applied to the current block is determined according to the rate-distortion cost values corresponding to the multiple candidate prediction modes.

In some embodiments of the disclosure, the prediction mode to be applied to the current block can be determined according to the rate-distortion cost values corresponding to the multiple candidate prediction modes in S6013 as follows. If a rate-distortion cost value corresponding to the IntraTMP-based prediction mode is less than or equal to a rate-distortion cost value corresponding to each of the multiple candidate prediction modes other than the IntraTMP-based prediction mode, determine that the IntraTMP-based prediction mode is to be applied to the current block. Alternatively, if the rate-distortion cost value corresponding to the IntraTMP-based prediction mode is greater than a rate-distortion cost value corresponding to any one of the multiple candidate prediction modes other than the IntraTMP-based prediction mode, determine that the IntraTMP-based prediction mode is not to be applied to the current block.

In some embodiments of the disclosure, the first syntax element information can be determined according to the prediction mode to be applied to the current block as follows. If it is determined that the IntraTMP-based prediction mode is to be applied to the current block, a value of the first syntax element information is set to a first value. Alternatively, if it is determined that the IntraTMP-based prediction mode is not to be applied to the current block, the value of the first syntax element information is set to a second value.

It should be noted that, in embodiments of the disclosure, the first value is different from the second value, and the first value and the second value each can be in a parameter form or in a numerical form. Specifically, the first syntax element information can be a parameter written in a profile, or can be a value of a flag, which is not specifically limited herein.

Exemplarily, for the first value and the second value, the first value can be set to 1, and the second value can be set to 0; alternatively, the first value can be set to 0, and the second value can be set to 1; alternatively, the first value can be set to true, and the second value can be set to false; alternatively, the first value can be set to false, and the second value can be set to true. However, no specific limitation is imposed herein.

In embodiments of the disclosure, taking a flag signalled in the bitstream as an example, assuming that the first value is set to 1 (true) and the second value is set to 0 (false), if the value of the first syntax element information is 0 (false), then it can be determined that the IntraTMP-based prediction mode is not to be applied to the current block, i.e., the encoding method in embodiments of the disclosure does not need to be performed; if the value of the first syntax element information is 1 (true), then it can be determined that the IntraTMP-based prediction mode is to be applied to the current block, i.e., the encoding method in embodiments of the disclosure may need to be performed.

In some embodiments of the disclosure, the encoding method further includes the following. The first syntax element information is encoded, and encoded bits obtained are signalled into a bitstream.

In some embodiments of the disclosure, the encoding method further includes the following. If the prediction mode to be applied to the current block is the IntraTMP-based prediction mode, second syntax element information is determined, where the second syntax element information indicates an IntraTMP-based prediction mode to be applied to the current block. The second syntax element information is encoded, and encoded bits obtained are signalled into the bitstream.

In some embodiments of the disclosure, the encoding method further includes the following. A residual value of the current block is determined according to the prediction value for the current block and an original value of the current block. A reconstructed value of the current block is determined according to the prediction value for the current block and the residual value of the current block.

In embodiments of the disclosure, the prediction value for the current block and the residual value of the current block can be added to obtain the reconstructed value of the current block.

In embodiments of the disclosure, a difference between the original value of the current block and the prediction value of the current block is taken as the residual value of the current block.

It can be understood that, on one hand, the residual value is one of key pieces of information transmitted during encoding. By predicting an original block and transmitting only the difference, the size of the bitstream can be reduced, thereby achieving video compression. On one hand, at an encoding end, by performing addition on the prediction value and the residual value, the original block can be reconstructed more efficiently, thereby reducing computation overhead and storage overhead required for encoding. On one hand, through appropriate addition on the prediction value and the residual value, it is possible to maintain video quality while achieving compression, such that an encoded picture is similar to an original picture.

In some embodiments of the disclosure, the encoding method further includes the following. The residual value is encoded, and encoded bits obtained are signalled into the bitstream.

S602, if the prediction mode for the current block is the IntraTMP-based prediction mode, a first block vector candidate list for the current block is determined, where the first block vector candidate list is determined according to a first candidate list constructed based on a template matching technology and/or a second candidate list constructed based on a merge candidate technology.

In embodiments of the disclosure, the construction of the first block vector candidate list relies on two key information sources, which are respectively as follows:

1) First candidate list: the first candidate list is obtained by searching for a block most similar to the current block within a reference picture through the template matching technology. With the template matching technology, the most similar block can be found by comparing blocks in terms of sample values or other features, and the first candidate list is generated, which includes multiple block vectors obtained through template matching.

2) Second candidate list: the merge candidate technology may also be applied for the construction of the first block vector candidate. In video encoding, the merge technology generally refers to merging information of neighbouring blocks or other blocks to reduce redundancy and improve encoding efficiency. With the merge candidate technology, the second candidate list including multiple merge block vectors can be constructed.

In some embodiments of the disclosure, the first block vector candidate list includes any one of: a first candidate list, a second candidate list, or a third candidate list. The first candidate list is determined by performing intra template matching within a preset search range corresponding to the current block. The second candidate list is determined by merging block vectors corresponding to one or more candidate blocks having similar motion to the current block. The third candidate list is determined based on the first candidate list and the second candidate list.

In embodiments of the disclosure, the first candidate list is determined by performing intra template matching within a preset search range corresponding to the current block. That is, the system (encoder) performs intra template matching within a predefined search range, to find a block most similar to the current block and thus construct the first candidate list.

It can be understood that, the first candidate list is a list including multiple candidate block vectors generated by searching for similar blocks within an intra search range and calculating block vectors, so as to provide options of different motion hypotheses. The construction of such list is part of motion estimation in video encoding, and helps improve accuracy of motion of the current block.

In embodiments of the disclosure, the second candidate list is determined by merging block vectors corresponding to one or more candidate blocks having similar motion to the current block. The manner for merging may involve neighbouring blocks, history buffer blocks, and the like, and the second candidate list is obtained by merging the block vectors.

It can be understood that, with regard to the construction of the second candidate list, by merging block vectors corresponding to candidate blocks of similar motion, it is possible to provide more comprehensive motion information, so as to enhance modeling and prediction of the motion of the current block. The construction of such list is part of motion estimation in video encoding, and helps improve encoding efficiency and video quality.

In embodiments of the disclosure, the third candidate list is determined based on the first candidate list and the second candidate list. This means that when constructing the third candidate list, information from the former two may be combined, which comprehensively takes results of intra template matching and motion merging into consideration.

It can be understood that, the third candidate list is constructed in order to provide richer and more diverse motion vector options by combining information from different sources, thereby improving performance of video encoding. In this way, it helps predict motion more accurately in different scenarios, thereby improving encoding efficiency and video quality.

It can be understood that, on one hand, by comprehensively applying intra template matching and merging technology, accuracy of motion of the current block can be improved. In Intra template matching, spatial similarity is taken into consideration, while in merging technology, richer motion information can be obtained from neighbouring blocks. On one hand, by combining different candidate lists, it helps adapt to different scenarios and motion characteristics. Intra template matching is more suitable for static or slowly varying regions, while merging technology may be more effective for regions with fast motion or dynamic changes. On one hand, by comprehensively taking different candidate lists into consideration, a block vector can be selected more effectively, thereby improving efficiency of video encoding. By reducing a residual between a block and a reference block, it helps reduce a bit rate. With the comprehensive method in which multiple information sources are adopted, complex scenarios, such as fast motion, richly textured regions, etc. can be better handled. In general, the above process aims to fully utilize different technologies and information, so as to improve video encoding performance, reduce distortion, and provide better visual quality. However, the specific effect also depends on implementation details and application scenarios.

In some embodiments of the disclosure, with regard to the first block vector candidate list, there can be the following cases.

Case 1: if the first block vector candidate list is the first candidate list, the first candidate block vector includes: all candidate block vectors in the first candidate list; or M candidate block vectors having the smallest template costs in the first candidate list, where M is a positive integer and M≥1.

It can be understood that, on one hand, all candidate block vectors in the first candidate list are taken into consideration, and as such, more comprehensive motion vector options are provided, which helps simulate and predict motion of a video block more accurately during encoding, thereby improving encoding efficiency and video quality. On the other hand, by limiting the number of candidate block vectors taken into consideration, it helps reduce computational burden, especially for the case of limited computational resources. By selecting M candidate block vectors having the smallest template costs, it is possible to maintain encoding efficiency to a certain extent and reduce computational complexity.

Case 2: if the first block vector candidate list is the second candidate list, the first candidate block vector includes: all candidate block vectors in the second candidate list; or N candidate block vectors having the smallest template costs in the second candidate list, where N is a positive integer and N≥1.

Case 3: if the first block vector candidate list is the third candidate list, the first candidate block vector includes: all candidate block vectors in the first candidate list and all candidate block vectors in the second candidate list; or M candidate block vectors having the smallest template costs in the first candidate list and all candidate block vectors in the second candidate list; or all candidate block vectors in the first candidate list and N candidate block vectors having the smallest template costs in the second candidate list; or M candidate block vectors having the smallest template costs in the first candidate list and N candidate block vectors having the smallest template costs in the second candidate list; or H candidate block vectors having the smallest template costs among candidate block vectors obtained by merging all candidate block vectors in the first candidate list with all candidate block vectors in the second candidate list, where H is a positive integer and H≥1.

More specifically, if the first block vector candidate list is the third candidate list, the encoder can firstly construct the first candidate list, then construct the second candidate list, perform relocated block construction on first candidate block vectors in the second candidate list to obtain an updated second candidate list, and then merge the updated second candidate list with the first candidate list, so as to obtain a final second block vector candidate list.

It can be understood that, on one hand, all candidate block vectors in the first candidate list and the second candidate list are provided, and as such, more motion information is included, which helps improve comprehensiveness and accuracy of motion estimation, thereby improving efficiency and quality of video encoding. On one hand, by limiting the number of candidate block vectors in the first candidate list, computational burden can be reduced to a certain extent. However, all candidate block vectors in the second candidate list are retained, which provides more motion information. On one hand, all candidate block vectors in the first candidate list are provided, whereas computational complexity is reduced by limiting the number of candidate block vectors in the second candidate list. In addition, the optimal candidate block vector(s) in the second candidate list are still taken into consideration. On one hand, in such combination manner in which the numbers of candidate block vectors in both of the two lists are limited, it is possible to control computational complexity more finely. In addition, the candidate block vector having the smallest template costs in the two lists are retained. On one hand, by merging the candidate block vectors in the two lists and selecting H candidate block vectors having the smallest template costs obtained after merging, information from the two lists is integrated. This is conducive to more comprehensive and accurate motion estimation. To summarize, the advantages of these selection manners is to provide different trade-off choices, so as to meet different requirements of an encoding system in aspects such as computational burden, motion estimation accuracy, and real-time performance. By selecting the most suitable manner for a specific application scenario, it helps optimize performance of video encoding. S603, a second block vector candidate list is determined based on the first block

vector candidate list, where the second block vector candidate list includes a relocated block vector(s) constructed for a first candidate block vector(s) in the first block vector candidate list.

In an embodiment of the disclosure, with regard to the composition of the second block vector candidate list, there can be the following cases.

Case 1: block vectors in the first candidate list (a list obtained through template matching), and relocated block vectors corresponding to first candidate block vectors in the first candidate list.

Case 2: block vectors in the second candidate list (a Merge list), and relocated block vectors corresponding to first candidate block vectors in the second candidate list.

Case 3: block vectors in the first candidate list (a list obtained through template matching), block vectors in the second candidate list (a Merge list), and relocated block vectors corresponding to first candidate block vectors in the second candidate list.

Case 4: block vectors in the first candidate list (a list obtained through template matching), block vectors in the second candidate list (a Merge list), and relocated block vectors corresponding to first candidate block vectors in the first candidate list.

Case 5: block vectors in the first candidate list (a list obtained through template matching), block vectors in the second candidate list (a Merge list), relocated block vectors corresponding to first candidate block vectors in the second candidate list, and relocated block vectors corresponding to first candidate block vectors in the first candidate list.

It should be noted that, the above-listed composition of the second block vector candidate list is only exemplary, and other manners can also be included in practice, and no limitation is imposed thereon in embodiments of the disclosure.

S604, a prediction value for the current block is determined based on the second block vector candidate list.

In some embodiments of the disclosure, the implementation of determining the prediction value for the current block based on the second block vector candidate list in S604 can include S6041 to S6043.

S6041, an IntraTMP-based prediction mode to be applied to the current block is determined.

S6042, template matching is performed on second candidate block vectors in the second block vector candidate list to obtain a third block vector candidate list.

In some embodiments of the disclosure, template matching can be performed on each second candidate block vector in the second block vector candidate list to obtain the third block vector candidate list in S6042 as follows. For any second candidate block vector in the second candidate block vectors, a neighbouring region of the second candidate block vector is determined according to index flag information for the second candidate block vector; search in the neighbouring region of the second candidate block vector at a preset step size to obtain second matching block vectors corresponding to the second candidate block vector; a third block vector having the smallest template cost is determined from the second matching block vectors corresponding to the second candidate block vector; and the third block vector candidate list is determined according to the third block vector corresponding to the second candidate block vector.

It should be noted that, for the relevant explanation of S6042, reference can be made to the illustration of S3042 in the foregoing elaboration, and details thereof are not repeated herein.

It can be understood that, on one hand, by performing refined searching and template matching within the neighbouring region of the second candidate block vector, the third block vector can be estimated more accurately, thereby improving overall accuracy of motion estimation. On one hand, for each second candidate block vector, the neighbouring region is dynamically determined according to the index flag information for the second candidate block vector, which helps adapt to changes of different video contents and motion characteristics. As such, an algorithm can be more versatile, and can have good performance in different scenarios. On one hand, searching at a preset step size can be performed within a relatively large neighbouring region, but after the second matching block vector is obtained, the third block vector having the smallest template cost is typically located within a relatively small region, thereby reducing a range for further search and thus improving search efficiency. On one hand, by determining the third block vector having the smallest template cost through template matching within a neighbouring region of the second matching block vector, it facilitates refining matching results and ensuring that motion estimation is more accurate. In summary, in the above process, accuracy and robustness of motion estimation are improved through multiple rounds of searching and matching, which helps improve effectiveness of video encoding.

S6043, the prediction value for the current block is determined according to the IntraTMP-based prediction mode to be applied to the current block and the third block vector candidate list.

In embodiments of the disclosure, the IntraTMP-based prediction mode to be applied to the current block can be: an IntraTMP fusion prediction technology, an IntraTMP multi-candidate technology, etc., and no limitation is imposed thereon in embodiments of the disclosure.

In embodiments of the disclosure, by using a result of template matching and the prediction mode, the content of the current block is estimated by matching and predicting information of neighbouring blocks, which helps improve video encoding efficiency and compression performance, especially for the case where scenario changes are relatively slight.

It can be understood that, on one hand, by performing template matching on the second candidate block vectors in the second block vector candidate list, the third block vector candidate list is obtained. Through such a multi-round searching process, it helps select the best matching block vector from candidate blocks, thereby improving prediction accuracy. On one hand, for generation of the third block vector candidate list, matching results of multiple candidate blocks are taken into account, thereby improving robustness to noise and interference. By integrating multiple candidate block vectors, influence of a single matching result can be reduced. On one hand, by using the IntraTMP-based prediction mode in combination with the third block vector candidate list, the content of the current block can be estimated more accurately, thereby improving video encoding efficiency and compression performance. The prediction value is generated based on multiple rounds of template matching and accurate block vector selection, which helps improve video quality and reduce estimation errors, such that a encoded picture is more similar to an original picture.

In embodiments of the disclosure, an encoding method is provided. The method includes the following. The prediction mode to be applied to the current block is determined, and the first syntax element information is determined according to the prediction mode to be applied to the current block, where the first syntax element information indicates whether the IntraTMP-based prediction mode is to be applied to the current block. If the prediction mode for the current block is the IntraTMP-based prediction mode, the first block vector candidate list for the current block is determined, where the first block vector candidate list is determined according to the first candidate list constructed based on the template matching technology and/or the second candidate list constructed based on the merge candidate technology. The second block vector candidate list is determined based on the first block vector candidate list, where the second block vector candidate list includes the relocated block vector(s) constructed for the first candidate block vector(s) in the first block vector candidate list. The prediction value for the current block is determined based on the second block vector candidate list. On one hand, by constructing a relocated block vector for each first candidate block vector in the first block vector candidate list to determine the second block vector candidate list, further refinement or adjustment of the first candidate block vectors in the first block vector candidate list is achieved. As such, it is conducive to diversity of candidate block vectors, accuracy in describing motion information, and accuracy of motion estimation. On the other hand, by determining the first block vector candidate list according to the first candidate list constructed based on the template matching technology and/or the second candidate list constructed based on the merge candidate technology, diversity of candidate lists can be improved, which is beneficial for subsequent extension of candidate block vectors. As such, appropriate block vectors can be selected more effectively during encoding, which improves diversity of candidate block vectors, reduces transmission of redundant information, and thus improves encoding efficiency.

It can be understood that, by means of the first candidate list constructed based on the template matching technology and/or the second candidate list constructed based on the merge candidate technology, prediction of the content of the current block can be performed more accurately, which helps estimate the content of the block more precisely in video prediction and reduce prediction errors. For generation of the first block vector candidate list, multiple factors are taken into account, which include the template matching technology and merge candidate technology. Through such comprehensive consideration, it helps adapt to different video scenarios, and as such, a prediction mode is more flexible and adaptive. During generation of the first block vector candidate list, through multiple rounds of searching and matching, it is possible to better capture motion relationships between blocks, thereby reducing overhead during prediction and improving prediction efficiency. With a more accurate prediction value, an original block can be reconstructed more accurately at an encoding end, thereby improving video quality. This helps reduce distortion and maintain a high-quality visual experience. By using the second block vector candidate list, especially the relocated block vectors, motion information of the current block can be represented more effectively, thereby achieving better compression performance while maintaining video quality. In general, through the above process, it is possible to improve prediction accuracy, adapt to different scenarios, reduce prediction overhead, improve video quality, and optimize overall compression performance.

In some embodiments of the disclosure, the second block vector candidate list can be determined based on the first block vector candidate list as follows. First candidate block vectors are determined from the first block vector candidate list, where the first candidate block vectors are all or some candidate block vectors in the first block vector candidate list. Relocated block vector construction is performed on the first candidate block vectors to obtain the second block vector candidate list.

In some embodiments of the disclosure, the implementation of performing relocated block vector construction on the first candidate block vectors to obtain the second block vector candidate list can include S701~S704.

S701, guiding block vectors for a current round that satisfy a first preset condition are determined from the first candidate block vectors.

In some embodiments of the disclosure, the first preset condition includes one or more of the following conditions: a template cost value corresponding to a guiding block vector is less than or equal to a second threshold, where the second threshold is obtained according to template cost values corresponding to block vectors added in the first block vector candidate list and/or the second block vector candidate list; a reference block corresponding to the guiding block vector is reconstructed; a reference block corresponding to the guiding block vector does not exceed a search range for IntraTMP; or the reference block corresponding to the guiding block vector does not exceed a search range for an IBC mode.

In embodiments of the disclosure, determination of the second threshold depends on the template cost values corresponding to the block vectors added in the first block vector candidate list and/or the second block vector candidate list. Such relationship may be used to dynamically adjust the second threshold according to previous searching and matching results, so as to adapt to specific conditions of a current video picture.

It should be understood that, through the above mechanism, the system can adaptively determine the second threshold at runtime according to actual needs, which can better cope with different video pictures and motion scenarios, thereby improving performance and adaptability of a template matching prediction mode.

It can be understood that, on one hand, the second threshold in the first preset condition is obtained by taking template cost values corresponding to added block vectors into consideration, which helps control accuracy of template matching, avoid unnecessary computation, and select block vectors with smaller template costs, thereby improving encoding efficiency. On one hand, if the reference block corresponding to the guiding block vector is reconstructed in a previous encoding process, repeated computation can be avoided, and thus redundant operations can be reduced, thereby improving encoding efficiency. On one hand, the search range for the reference block is limited so as not to exceed the search range for IntraTMP or the IBC mode. This helps reduce the search space, increase search speed, and on the other hand, ensure that the selected reference block is within an appropriate range, thereby improving encoding performance.

S702, relocated block vectors corresponding to the guiding block vectors for the current round are added to a current second block vector candidate list, to obtain an updated current second block vector candidate list.

In embodiments of the disclosure, the relocated block vectors corresponding to the guiding block vectors for the current round are added to the current second block vector candidate list to update the list. Generally, the current second block vector candidate list may contain multiple block vectors, and each block vector corresponds to a different reference block. By adding the relocated block vectors corresponding to the guiding block vectors for the current round to the current second block vector candidate list, more block vector options can be taken into consideration, so as to improve matching accuracy and effect.

It can be understood that, by using information of the guiding block vectors and the relocated block vectors previously obtained, block vector options can be taken into consideration more comprehensively, which helps improve matching accuracy. By adding more block vectors to a candidate list, it is possible to provide more options for subsequent template matching or other prediction processes, thereby increasing the probability of finding the best match.

It should be noted that, the current second block vector candidate list may further include all or some of block vectors inherited from the first block vector candidate list.

S703, for any current guiding block vector in the guiding block vectors for the current round, a relocated block vector(s) corresponding to the current guiding block vector is determined according to a current reference block and/or a current block corresponding to the current guiding block vector.

In some embodiments of the disclosure, the implementation of determining the relocated block vector corresponding to the current guiding block vector according to the current reference block and/or the current block corresponding to the current guiding block vector in S703 can include S7031~S7032.

S7031, the current guiding block vector is offset according to the current reference block and/or the current block, to obtain a guiding block offset vector(s) corresponding to the current guiding block vector.

It should be understood that, by considering the offset, the position of the current block relative to a reference picture can be estimated more accurately, thereby improving accuracy of position. Objects in a video may have motion and changes, and through the offsetting process, it can help a model better adapt to these changes.

In some embodiments of the disclosure, the guiding block offset vector includes one or more of: a first guiding block offset vector, a second guiding block offset vector, a third guiding block offset vector, a fourth guiding block offset vector, or a fifth guiding block offset vector. The first guiding block offset vector indicates a first candidate reference block located at a center position of the current reference block. The second guiding block offset vector indicates a second candidate reference block located at a top-left position of the current reference block. The third guiding block offset vector indicates a third candidate reference block located at a bottom-left position of the current reference block. The fourth guiding block offset vector indicates a fourth candidate reference block located at a top-right position of the current reference block. The fifth guiding block offset vector indicates a fifth candidate reference block located at a bottom-right position of the current reference block.

In embodiments of the disclosure, the first guiding block offset vector can be represented by CTR, the second guiding block offset vector can be represented by LT, the third guiding block offset vector can be represented by LB, the fourth guiding block offset vector can be represented by RT, and the fifth guiding block offset vector can be represented by RB.

In embodiments of the disclosure, the first guiding block offset vector is used to guide the encoder to look up a reference block at a center position corresponding to the current reference block. With the setting of the second guiding block offset vector, the encoder can be guided to take a reference block at a top-left position into consideration. The third guiding block offset vector can be used to guide the encoder to take a reference block at a bottom-left position into consideration. The fourth guiding block offset vector helps the encoder take a reference block at a top-right position into consideration. The fifth guiding block offset vector can be used to guide the encoder to take a reference block at a bottom-right position into consideration. With the setting of these guiding block offset vectors, it is conducive to exploring possible reference block positions more comprehensively within a search region, so as to improve accuracy and adaptability of motion estimation. In practice, the setting of these guiding block offset vectors can be adjusted according to characteristics and requirements of a scenario.

S7032, the relocated block vector corresponding to the current guiding block vector is determined based on the guiding block offset vector.

In some embodiments of the disclosure, the relocated block vector corresponding to the current guiding block vector can be determined based on the guiding block offset vector in S7032 as follows. A current guiding block offset vector is determined from the guiding block offset vector. If the current guiding block offset vector is available, a relocated block vector corresponding to the current guiding block offset vector is determined according to a block vector for a candidate reference block corresponding to the current guiding block offset vector, where the relocated block vector corresponding to the current guiding block offset vector is one of the relocated block vectors corresponding to the current guiding block vector. Alternatively, if the current guiding block offset vector is unavailable, the current guiding block offset vector is skipped and proceed to determining a next guiding block offset vector from the guiding block offset vector.

In some embodiments of the disclosure, determine that the current guiding block offset vector is available if one or more of the following conditions are satisfied: the current guiding block offset vector exists; a candidate reference block indicated by the current guiding block offset vector is reconstructed; a template cost value corresponding to the current guiding block offset vector is less than or equal to a first threshold; the candidate reference block indicated by the current guiding block offset vector is within a preset range; or a prediction mode for the candidate reference block indicated by the current guiding block offset vector is an IBC mode or an IntraTMP mode. Alternatively, determine that the current guiding block offset vector is unavailable if one or more of the following conditions are satisfied: the current guiding block offset vector does not exist; the candidate reference block indicated by the current guiding block offset vector is not reconstructed; the template cost value corresponding to the current guiding block offset vector is greater than the first threshold; the candidate reference block indicated by the current guiding block offset vector is not within the preset range; or the prediction mode for the candidate reference block indicated by the current guiding block offset vector is not an IBC mode or an IntraTMP mode.

In embodiments of the disclosure, based on the above conditions, if the current guiding block offset vector satisfies these conditions, then the vector is considered to be “available” and can be used for subsequent processing steps, such as block reconstruction, block vector list update, etc. The purpose of this process is to select a candidate block with better performance in template matching, so as to improve overall prediction accuracy.

It can be understood that, on one hand, when a series of conditions are satisfied, it is possible to ensure that a candidate reference block corresponding to a selected guiding block offset vector meets requirements in all aspects, including template matching cost, position, prediction mode, etc. As such, it is conducive to improving reconstruction accuracy of a block, thereby improving overall video encoding performance. On one hand, by selectively using a guiding block offset vector that satisfies the conditions, computational complexity of subsequent processing is reduced. Block vectors and candidate reference blocks that do not satisfy the conditions can be excluded, thereby optimizing overall performance of an algorithm. On one hand, by excluding unsuitable candidate reference blocks and block vectors, chances of possible errors are reduced, which helps improve stability and reliability. On one hand, by excluding block vectors that do not satisfy the conditions at an early stage, the speed of video encoding is increased. This is especially important for speed-sensitive applications such as real-time video encoding and streaming media transmission. By selectively using high-quality block vectors and candidate reference blocks, encoder resources can be better utilized, thereby optimizing video encoding performance.

In embodiments of the disclosure, the current guiding block offset vector is firstly determined. Guiding block offset vectors are a set of vectors, where each vector represents an offset relative to a position of a current reference block. The guiding block offset vectors herein typically include offsets in multiple directions, for example, top-left, bottom-left, top-right, bottom-right, etc. Then, the relocated block vector corresponding to the current guiding block offset vector is determined according to the block vector for the candidate reference block corresponding to the current guiding block offset vector and the current guiding block offset vector. This process can include two cases.

Case 1: if the current guiding block offset vector is available, then the relocated block vector corresponding to the current guiding block offset vector is determined according to the block vector for the candidate reference block corresponding to the current guiding block offset vector. This relocated block vector can be one of the relocated block vectors corresponding to any current guiding block vector.

Case 2: if the current guiding block offset vector is unavailable, the current guiding block offset vector is skipped, and proceed to determining the next guiding block offset vector among the guiding block offset vectors. This means that in the current case, the current guiding block offset vector is not taken into consideration, and instead, proceed to attempting other available guiding block offset vectors.

In some embodiments of the disclosure, the implementation of determining the relocated block vector corresponding to the current guiding block offset vector according to the block vector for the candidate reference block corresponding to the current guiding block offset vector and the current guiding block offset vector can include the following two cases.

Case 1: if a bi-predictive IBC mode is not to be applied to the candidate reference block, vector addition is performed on the block vector for the candidate reference block corresponding to the current guiding block offset vector and the current guiding block vector, to obtain the relocated block vector corresponding to the current guiding block offset vector.

In embodiments of the disclosure, vector addition is performed on the block vector for the candidate reference block corresponding to the current guiding block offset vector and the current guiding block vector. The purpose of such operation is to refine the block vector for the candidate reference block by taking into account offset for the current guiding block vector. Exemplarily, if the block vector for the candidate reference block is represented by BV1 and the current guiding block vector is represented by BV2, then a refined block vector, i.e., the relocated block vector corresponding to the current guiding block offset vector, will be obtained through vector addition BV1+BV2. The result of the vector addition is the relocated block vector corresponding to the current guiding block offset vector.

It should be understood that, in the above process, the block vector for the candidate reference block is refined according to offset information of the current guiding block vector, so as to predict the position of the current block more accurately.

Case 2: if a bi-predictive IBC mode is to be applied to the candidate reference block, a first reference block vector and a second reference block vector corresponding to the candidate reference block are determined. Vector addition is performed on the first reference block vector and the current guiding block vector to determine a first relocated block vector corresponding to the current guiding block offset vector. Vector addition is performed on the second reference block vector and the current guiding block vector to determine a second relocated block vector corresponding to the current guiding block offset vector.

In embodiments of the disclosure, for bi-predictive IBC, each block may have two reference blocks, i.e., a first reference block and a second reference block. Both reference blocks have corresponding block vectors. Therefore, the encoder needs to obtain the first reference block vector and the second reference block vector corresponding to the candidate reference block.

In embodiments of the disclosure, the first relocated block vector=the first reference block vector+the current guiding block vector. The second relocated block vector=the second reference block vector+the current guiding block vector. Through the two vector addition operations, the first relocated block vector and the second relocated block vector corresponding to the current guiding block offset vector are obtained. In this way, the position of the candidate reference block under the bi-predictive IBC mode can be represented more accurately, which helps improve block prediction accuracy.

It can be understood that, on one hand, by applying the bi-predictive IBC mode, reference blocks in two different directions are considered, which helps capture motion information of a target block more accurately. As such, it is possible to improve prediction accuracy, especially for the case where there is complex motion. On one hand, by means of bi-predictive IBC, modeling can be performed in two directions of the target block, and for the scenario where there is complex motion, it is conducive to better adaptation to various motion patterns, thereby improving overall video encoding efficiency. Since motion information of two directions is taken into consideration in bi-predictive IBC, a wider variety of possible motion can be captured, which is possible to better adapt to motion characteristics of different blocks in a video sequence during encoding.

S704, proceed to determining, from the relocated block vectors corresponding to the guiding block vectors for the current round, a guiding block vector for a next round that satisfies the first preset condition, to obtain a next updated second block vector candidate list until the guiding block vector for the next round satisfies a second preset condition, and the last updated second block vector candidate list is taken as the second block vector candidate list.

It should be understood that, the above flow is a process of determining appropriate block vectors according to a preset condition through multiple rounds of iterative selection and updating, so as to generate the final second block vector candidate list, which helps to predict more accurately motion information of the current block during video coding.

In embodiments of the disclosure, the second preset condition is a termination condition for multiple rounds of iterative selection.

In some embodiments of the disclosure, the second preset condition includes one or more of: the next round exceeds or reaches an iteration threshold; the number of guiding block vectors for the next round is less than or equal to a third threshold; a template cost value corresponding to each of at least one guiding block vector in the guiding block vectors for the next round is greater than or equal to a fourth threshold; or a list length of the next updated second block vector candidate list corresponding to the next round is greater than or equal to a maximum list-length threshold.

It should be noted that, the second preset condition listed above is merely an example, and in actual application scenarios, other condition settings can also be included, which is not limited in the disclosure.

It can be understood that, on one hand, through an iterative process, guiding block vectors that satisfy a certain condition can be selected in each round, which may lead to higher accuracy in block vector selection, thereby improving accuracy of motion estimation for the current block. By adding the relocated block vectors corresponding to the guiding block vectors for the current round to the current second block vector candidate list, it helps to concentrate the selected block vectors into the second block vector candidate list, which reduces selection of redundant block vectors, thereby improving computational efficiency. On one hand, by adjusting selection of guiding block vectors and relocated block vectors in each round, such method may have certain flexibility and can better adapt to variation and complexity of motion in a video. By selecting and updating block vectors according to a preset condition(s), it is possible to perform motion estimation more efficiently in terms of computational cost, thereby avoiding processing a large amount of redundant information.

In some embodiments of the disclosure, if the first block vector candidate list is the first candidate list, the first block vector candidate list for the current block can be determined in as follows. The first candidate list is determined, and the first candidate list is taken as the first block vector candidate list. The first candidate list is determined as follows. Search within a preset search range at a preset step size to obtain first matching block vectors. A first block vector having the smallest template cost is determined from the first matching block vectors. The first candidate list is determined according to the first block vector.

In embodiments of the disclosure, the preset search range is a parameter that balances encoding performance and computational complexity. By setting the search range appropriately, a video coder can meet performance requirements while maintaining low computational overhead.

In embodiments of the disclosure, searching is performed within a given search range at a preset step size to find blocks that match the current block. During searching, blocks most similar to the current block are found, and the first matching block vectors are obtained, where the vectors represent positional offsets for the matching blocks found during searching. For the first matching block vectors, template matching costs are calculated in neighbouring regions of the matching blocks. The first block vector having the smallest template cost is found, which represents the best match. According to the first block vector, the first candidate list can be determined. For example, the first block vector and related information of the first block vector are added to the candidate list in order for subsequent processing.

It can be understood that, on one hand, by searching for the best matching block within the preset search range, the motion of the current block can be described more accurately. This helps improve encoding efficiency, because in video compression, motion estimation is intended to reduce redundant information. On one hand, by finding the best match, similarity between neighbouring pictures can be exploited, thereby better utilizing spatial correlation. This helps improve video compression performance and reduce video file size. By estimating motion more accurately, a video encoder can better reconstruct pictures, thereby improving video quality and detail restoration.

In some embodiments of the disclosure, if the first block vector candidate list is the second candidate list, the first block vector candidate list for the current block can be determined in S302 as follows. The second candidate list is determined, and the second candidate list is taken as the first block vector candidate list. The second candidate list is determined as follows. The second candidate list is determined according to second block vectors, where a matching block corresponding to each of the second block vectors has similar motion to the current block.

In embodiments of the disclosure, the matching block corresponding to each of the second block vector is a block that has similar motion to the current block in the first round of search. This means that the second block vectors are selected during the first round of search, which indicates that the matching blocks corresponding to the second block vectors have similar motion to the current block. According to these matching blocks having similar motion, the second candidate list can be constructed. Specifically, the second block vector together with the corresponding matching block thereof typically forms a candidate block pair. The matching block of the candidate block pair has similar motion to the current block, and thus the second block vector can be considered as a potential motion vector. Information of these candidate block pairs is arranged into the second candidate list for use in subsequent steps. The purpose of construction of the second candidate list is to locate more finely blocks having similar motion, so as to improve accuracy of motion estimation. With such a two-round search strategy, it is possible to better adapt to a scenario where there are different motions in a video while ensuring computational efficiency.

In some embodiments of the disclosure, the second candidate list includes one or more of: block vectors corresponding to one or more spatial neighbouring candidate blocks; block vectors corresponding to one or more spatial non-neighbouring candidate blocks; block vectors obtained according to one or more IBC history block vector buffers; an average block vector of one or more existing block vectors in a current second candidate list; one or more block vectors predefined based on the size of the current block; one or more relocated block vectors constructed for the first candidate block vector.

It can be understood that, the foregoing content of the second candidate list provides diversified block vectors. By selecting appropriate block vectors from these sources according to actual needs, it is possible to improve accuracy and stability of motion estimation, so as to improve the effectiveness of video encoding or picture processing.

In some embodiments of the disclosure, determining the second candidate list according to the second block vectors includes S801~S804.

S801, a first maximum list length is determined.

In embodiments of the disclosure, the first maximum list length indicates a maximum list length of the second candidate list.

In some embodiments of the disclosure, the first maximum list length is encoded, and encoded bits obtained are signalled into the bitstream.

S802, for a current second block vector in the second block vectors, the current second block vector is added to a current second candidate list to obtain an updated current second candidate list.

In some embodiments of the disclosure, the current second block vector can be added to the current second candidate list to obtain the updated current second candidate list in S802 as follows. If the current second block vector satisfies a third preset condition, the current second block vector is added to the current second candidate list to obtain the updated current second candidate list. Alternatively, if the current second block vector does not satisfy the third preset condition, the current second block vector is skipped and proceed to adding a next second block vector to the updated current second candidate list to obtain a next updated second candidate list.

It can be understood that, when the third preset condition is satisfied, the current second block vector is added to the current second candidate list, which helps to ensure that block vectors in the list have certain quality and accuracy, thereby improving performance of subsequent video encoding steps, in that it can optimize picture encoding and reconstruction by selecting more reliable and accurate motion information.

In some embodiments of the disclosure, the third preset condition includes one or more of: a reference block corresponding to the current second block vector does not exceed a search range for an IntraTMP mode; the reference block corresponding to the current second block vector does not exceed the size of a picture boundary of the current block; the reference block corresponding to the current second block vector does not exceed the size of a reconstructed region in a current picture; the reference block corresponding to the current second block vector does not exceed the size of a CTU corresponding to the current block; or a template cost value corresponding to the current second block vector is less than or equal to a preset threshold, where the preset threshold is obtained according to template cost values corresponding to block vectors added in the first block vector candidate list and/or the second block vector candidate list.

It can be understood that, the above conditions help to optimize selection of the reference block, thereby ensuring that good performance can be achieved by using the selected vector and reference block in video encoding. By restricting the position, quality, and search range of the reference block, it is conducive to preventing selecting an inappropriate motion vector, thereby improving effectiveness of video encoding.

S803, if the number of second block vectors in the updated current second candidate list is less than the first maximum list length, proceed to adding a next second block vector to the updated current second candidate list to obtain a next updated second candidate list until the number of second block vectors in the next updated second candidate list is equal to the first maximum list length, and the last updated second candidate list is taken as the second candidate list

S804, if the number of second block vectors in the updated current second candidate list is equal to the first maximum list length, the updated current second candidate list is taken as the second candidate list.

It should be understood that, the purpose of the above process is to limit the length of the second candidate list, so as to control computational complexity and ensure efficient processing in subsequent steps. By adding second block vectors one by one and determining whether the condition is satisfied, the updated second candidate list can be dynamically constructed, thereby ensuring that the list length is within a controllable range.

It should be noted that, S803 and S804 are parallel schemes, that is, the encoder can perform S803, or can perform S804, and no limitation is imposed thereon in the disclosure.

It can be understood that, by constructing the second candidate list gradually, the encoder can flexibly control the length of the list and obtain a set of second block vectors that can be used for subsequent processing if the condition is satisfied, thereby improving performance and effectiveness of applications such as video encoding.

In some embodiments of the disclosure, the encoding method further includes the following. Redundancy removal is performed on the second block vectors added in the current second candidate list.

In some embodiments of the disclosure, redundancy removal can be performed on the second block vectors added in the current second candidate list as follows. For any second block vector added in the current second candidate list, the current second block vector is added to the current second candidate list to obtain the updated current second candidate list, if a difference value in a horizontal direction between the current second block vector and the second block vector added is less than or equal to a fifth threshold and a difference value in a vertical direction between the current second block vector and the second block vector added is less than or equal to the fifth threshold; alternatively, the current second block vector is skipped and proceed to adding the next second block vector to the updated current second candidate list to obtain the next updated second candidate list, if the difference value in a horizontal direction between the current second block vector and the second block vector added is greater than the fifth threshold or the difference value in a vertical direction between the current second block vector and the second block vector added is greater than the fifth threshold.

It can be understood that, through this step, the encoder can further perform selection and update the current second candidate list according to a determination on neighbourhood in a horizontal direction and in a vertical direction, so as to ensure that the second block vectors in the current second candidate list are more consistent or similar in position, which helps to improve stability and quality of applications such as video encoding.

In some embodiments of the disclosure, redundancy removal can be performed on the second block vectors added in the current second candidate list as follows. If the first candidate list is constructed, redundancy removal is performed on the second block vectors added in the current second candidate list according to the first candidate list.

In some embodiments of the disclosure, redundancy removal can be performed on the second block vectors added in the current second candidate list according to the first candidate list as follows. For any second block vector added in the current second candidate list and any first block vector added in the first candidate list, the current second block vector is added to the current second candidate list to obtain the updated current second candidate list, if a difference value in a horizontal direction between the current second block vector and the second block vector added and a difference value in a horizontal direction between the current second block vector and the first block vector added each are less than or equal to a fifth threshold, and a difference value in a vertical direction between the current second block vector and the second block vector added and a difference value in a vertical direction between the current second block vector and the first block vector added each are less than or equal to the fifth threshold; alternatively, the current second block vector is skipped and proceed to adding a next second block vector to the updated current second candidate list to obtain the next updated second candidate list, if the difference value in a horizontal direction between the current second block vector and the second block vector added and the difference value in a horizontal direction between the current second block vector and the first block vector added each are greater than the fifth threshold, or the difference value in a vertical direction between the current second block vector and the second block vector added and the difference value in a vertical direction between the current second block vector and the first block vector added is greater than the fifth threshold.

It can be understood that, the encoder can comprehensively consider a difference between second block vectors and a difference between the second block vector and the first block vector according to a determination on neighbourhood in a horizontal direction and a vertical direction, and further perform selection and update the current second candidate list, which helps to improve stability and quality of applications such as video encoding.

In some embodiments of the disclosure, the fifth threshold depends on the size of the current block and/or a vector precision of the current second block vector.

It can be understood that, by adjusting the fifth threshold, the encoder can adapt flexibly to different video processing requirements under different scenarios and configurations, so as to achieve better performance and quality.

In some embodiments of the disclosure, the encoding method further includes the following. A first reference value is adjusted according to the size of the current block to obtain the fifth threshold. The first reference value is adjusted according to the size of the current block to obtain the fifth threshold as follows. If the size of the current block is greater than or equal to a first preset value, the first reference value is increased to obtain the fifth threshold. Alternatively, if the size of the current block is less than the first preset value, the first reference value is decreased to obtain the fifth threshold.

It can be understood that, with such method for dynamic adjustment, it is conducive to achieving better performance and adaptability on blocks of different sizes. According to the size of a block, the encoder can flexibly adjust the threshold so as to perform matching and processing more effectively.

In some embodiments of the disclosure, the encoding method further includes the following. A second reference value is adjusted according to the vector precision of the current second block vector to obtain the fifth threshold. The second reference value is adjusted according to the vector precision of the current second block vector to obtain the fifth threshold as follows. If the vector precision of the current second block vector is greater than or equal to a second preset value, the second reference value is decreased to obtain the fifth threshold. Alternatively, if the vector precision of the current second block vector is less than the second preset value, the second reference value is increased to obtain the fifth threshold.

It can be understood that, with such dynamic adjustment method, it helps to achieve better performance and adaptability under different vector precision conditions. By adjusting the threshold according to the vector precision, the encoder can handle more flexibly vectors of different precision, so as to better match characteristics between blocks. As such, it is conducive to improving robustness and performance of the encoder.

In some embodiments of the disclosure, if the first block vector candidate list is the third candidate list, the first block vector candidate list for the current block can be determined in S302 as follows. The first candidate list is determined and the second candidate list is determined. The third candidate list is determined according to the first candidate list and the second candidate list, and the third candidate list is taken as the first block vector candidate list. The third candidate list is determined according to the first candidate list and the second candidate list as follows. K first block vectors in the first candidate list are merged with L second block vectors in the second candidate list to obtain the third candidate list, where K and L each are a positive integer, K≥1, and L≥1.

In some embodiments of the disclosure, the implementation of merging K first block vectors in the first candidate list with L second block vectors in the second candidate list to obtain the third candidate list can include the following two cases.

Case 1: P candidate block vectors having the smallest template costs are determined from the K first block vectors and the L second block vectors, where P is a positive integer and 1≤P≤K+L. The third candidate list is determined according to the P candidate block vectors.

In embodiments of the disclosure, given K first block vectors and L second block vectors, in order to determine P candidate block vectors having the smallest template costs, it is typically necessary to perform template matching or other cost calculation operations on the K first block vectors and L second block vectors. Exemplarily, for each combination of first block vector and second block vector, a template matching cost or other related cost values of the combination is calculated. P combinations having the smallest costs are selected from all combinations, which may involve arrangement or other selection algorithms to ensure that the selected P combinations have the smallest costs. Based on the selected P combinations, the third candidate list is constructed, where the list includes the P candidate block vectors having the smallest template costs. The above process involves calculating and selecting vector combinations to find the P combinations having the smallest costs, and then using the P combinations as part of the third candidate list.

Case 2: for a j^{th} candidate block vector among the K first block vectors and the L second block vectors, the j^{th} candidate block vector is added to a current third candidate list to obtain an updated current third candidate list, where j is a positive integer and 1≤j≤K+L. If the number of candidate block vectors in the updated current third candidate list is less than a second maximum list length, proceed to adding a (j+1)^{th} candidate block vector to the updated current third candidate list to obtain a next updated third candidate list until the number of candidate block vectors in the next updated third candidate list is equal to the second maximum list length, and the last updated third candidate list is taken as the third candidate list. Alternatively, if the number of candidate block vectors in the updated current third candidate list is equal to the second maximum list length, the updated current third candidate list is taken as the third candidate list.

It can be understood that, on one hand, by selecting P candidate block vectors having the smallest template costs, it is possible to ensure that candidate block vectors in the current third candidate list are spatially similar to an actual scenario, thereby improving picture quality. On one hand, by taking the combinations of K first block vectors and L second block vectors into consideration, it helps to improve matching diversity, such that the algorithm can cope with different scenarios and motion situations. On one hand, by adjusting the fifth threshold, the size of the current block and the vector precision of the second block vectors are taken into account, so that the selected candidate blocks can better adapt to picture blocks of different sizes and precision, thereby improving adaptability of the algorithm. On one hand, when generating the current third candidate list, by controlling the list length, it is possible to avoid excessive redundant information, thereby improving efficiency and speed of the algorithm. In summary, with the above process, it helps to select an optimal set of candidate blocks from multiple candidate block vectors taken into consideration, thereby providing better input for subsequent steps so as to perform picture processing and encoding more accurately.

In some embodiments of the disclosure, the decoding method further includes the following. Redundancy removal is performed on candidate block vectors added in the current third candidate list.

In some embodiments of the disclosure, redundancy removal can be performed on the candidate block vectors added in the current third candidate list as follows. For any first block vector and any second block vector added in the current third candidate list, the j^{th} candidate block vector is added to the current third candidate list to obtain the updated current third candidate list, if a difference value in a horizontal direction between the j^{th} candidate block vector and the second block vector is less than or equal to a fifth threshold, a difference value in a vertical direction between the j^{th} candidate block vector and the second block vector is less than or equal to the fifth threshold, a difference value in a horizontal direction between the j^{th} candidate block vector and the first block vector is less than or equal to a sixth threshold, and a difference value in a vertical direction between the j^{th} candidate block vector and the first block vector is less than or equal to the sixth threshold, where the first block vector is from the first candidate list, and the second block vector is from the second candidate list; alternatively, the j^{th} candidate block vector is skipped and proceed to adding the (j+1)^{th} candidate block vector to the updated current third candidate list to obtain the next updated third candidate list, if the difference value in a horizontal direction between the j^{th} candidate block vector and the second block vector is greater than the fifth threshold, or the difference value in a vertical direction between the j^{th} candidate block vector and the second block vector is greater than the fifth threshold, or the difference value in a horizontal direction between the j^{th} candidate block vector and the first block vector is greater than the sixth threshold, or the difference value in a vertical direction between the j^{th} candidate block vector and the first block vector is greater than the sixth threshold.

It can be understood that, on one hand, by setting difference value thresholds in a horizontal direction and a vertical direction, selection can be performed finely on candidate block vectors in the third candidate list. As such, candidate block vectors that do not meet a specific condition can be excluded, thereby improving matching accuracy. By introducing the fifth threshold and the sixth threshold, the risk of false matching caused by factors such as picture noise or motion blur can be reduced. With such design of difference values, it is possible to better adapt to different picture scenarios and motion situations, thereby making matching results more reliable. On one hand, by adjusting the fifth threshold and the sixth threshold, it is possible to flexibly adapt to different scenarios and requirements. With such adjustability, the algorithm can have good performance under different conditions, and thus have wider applicability. By finely controlling the matching condition, it is more likely to perform matching still robustly under poor picture quality or partial occlusion by means of an algorithm, thereby improving robustness of the algorithm. In summary, through the above steps, it is beneficial to improving accuracy, robustness, and adaptability of the matching process, such that in subsequent steps, further processing can be performed based on information that is more reliable, thereby improving the effectiveness of video encoding and picture processing.

In some embodiments of the disclosure, the fifth threshold depends on the size of the current block and/or a block-level flag for a reference block indicated by the j^{th} candidate block vector.

It can be understood that, by considering the size of the current block and the block-level flag for the reference block, accuracy and robustness of matching can be better balanced in different scenarios, thereby improving adaptability of an algorithm.

In some embodiments of the disclosure, the encoding method further includes the following. A third reference value is adjusted according to the size of the current block to obtain the sixth threshold. The third reference value is adjusted according to the size of the current block to obtain the sixth threshold as follows. The third reference value is increased to obtain the sixth threshold if the size of the current block is greater than or equal to a third preset value. The third reference value is decreased to obtain the sixth threshold if the size of the current block is less than the third preset value.

In some embodiments of the disclosure, the decoding method further includes the following. A fourth reference value is adjusted according to the block-level flag for the reference block indicated by the j^{th} candidate block vector to obtain the sixth threshold. The fourth reference value is adjusted according to the block-level flag for the reference block indicated by the j^{th} candidate block vector to obtain the sixth threshold as follows. The fourth reference value is decreased to obtain the sixth threshold if the block-level flag indicates that the reference block corresponding to the j^{th} candidate block vector satisfies a preset prediction mode and/or a preset block feature. Alternatively, the fourth reference value is increased to obtain the sixth threshold if the block-level flag indicates that the reference block corresponding to the j^{th} candidate block vector does not satisfy the preset prediction mode and/or the preset block feature.

In some embodiments of the disclosure, candidate block vectors in the first block vector candidate list and the second block vector candidate list are all in integer-sample accuracy, and the encoding method further includes the following. If any candidate block vector in the first block vector candidate list and the second block vector candidate list is in fractional-sample accuracy, accuracy conversion is performed on the candidate block vector such that the candidate block vector is in integer-sample accuracy.

In embodiments of the disclosure, for any candidate block vector in the first block vector candidate list and the second block vector candidate list, if the candidate block vector is originally represented in fractional-sample accuracy, accuracy conversion is performed to convert the candidate block vector to integer-sample accuracy representation. Fractional-sample accuracy typically means that the value of a coordinate or vector can be a decimal, i.e., including a fractional part. Integer-sample accuracy representation includes only an integer value without a fractional part.

It can be understood that, on one hand, in many picture processing algorithms, integer-sample coordinates are easier to compute and process. By performing accuracy conversion on coordinates, it is possible to reduce computational complexity and improve execution efficiency of the algorithm. On one hand, integer-sample coordinates generally require less storage space, because there is no need to store a fractional part, which may be beneficial for application scenarios that are sensitive to memory consumption. On one hand, in some picture processing tasks, integer-sample coordinates may be easier to align with a sample grid of a picture, which may be beneficial for matching and alignment tasks. If an entire algorithm or flow requires that coordinates of inputs or intermediate results are all in integer-sample accuracy, then the consistency of the algorithm can be maintained by performing conversion.

The decoding method and the encoding method provided in the disclosure is described below in an embodiment.

In embodiments of the disclosure, with an IntraTMP technology, prediction can be completed through template matching within a predefined search region, where a search region can depend on factors such as the position and size of a current block. In an IntraTMP with merge candidates technology, it is proposed that a merge list is constructed to serve as candidate blocks for a search process, and motion information of neighbouring coded blocks is utilized, which effectively improves performance of IntraTMP search, thereby improving encoding efficiency. In an AR-BVP technology, it is proposed that for an IBC prediction block, a block vector for a reference block can be utilized to construct a new candidate block vector, which effectively improves diversity of block vector prediction and thus improves encoding efficiency of IBC. In combination with the above two technologies, it is proposed in the disclosure that for an IntraTMP coding block, motion information of neighbouring coded blocks and reference blocks can be exploited to extend a template matching search process, thereby improving encoding efficiency.

In embodiments of the disclosure, in an IntraTMP mode, a merge candidate list (Merge list) is constructed for a current coding block, and the intra template matching process is extended according to candidate block vectors in the list. The decoding process is as follows.

1) A flag cu_intra_tmp_flag (equivalent to first syntax element information) is decoded. If cu_intra_tmp_flag is true, it indicates that the IntraTMP mode is to be applied to the current block.

2) The first round of search is performed within a predefined search region at a certain step size, for example, both a horizontal step size and a vertical step size are 3, to obtain N best matching block vectors with a certain interval (first N matching block vectors having the smallest template error values) as the first candidate list, where the first candidate list includes candidate block vectors T₁-T_{N}.

3) A Merge list is constructed. The Merge list can include a spatial neighbouring candidate, a spatial non-neighbouring candidate, a history candidate, an average candidate, a predefined candidate, etc. All or some of candidates used for constructing a merge list for an IBC mode can be included.

4) When constructing the Merge list, whether a candidate block vector is redundant can be determined based on a first candidate list and an existing Merge list. For example, an n^{th} candidate block vector Cₙ is obtained from a coded block or a history buffer. Cₙ needs to be compared with existing candidates C₁-Cₙ₋₁ in the merge list. If a horizontal absolute difference between Cₙ and any candidate Cᵢ and a vertical absolute difference between Cₙ and any candidate Cᵢ each are less than threshold X (a fifth threshold), Cₙ is considered as redundant and will not be added to the merge list. Similarly, Cₙ can be compared with T₁-T_{N}. If a horizontal absolute difference between Cₙ and Tᵢ and a vertical absolute difference between Cₙ and Tᵢ each are less than threshold Y (a sixth threshold), Cₙ is considered redundant and will not be added to the merge list. Threshold Y (the sixth threshold) may depend on information such as block size, block-level flag, and the like.

5) When constructing the Merge list, the maximum length of the merge list can be indicated by a sequence-level parameter. For example, sps_intra_tmp_merge_num indicates the maximum length when constructing the merge list under the IntraTMP mode. If the IntraTMP mode is to be applied to the current block and the list length reaches sps_intra_tmp_merge_num when constructing the merge list, construction will be terminated.

6) When constructing the Merge list, whether a candidate block vector can be added can be determined based on a predefined IntraTMP search region. For example, if a candidate block vector to-be-added exceeds the search region for a current coding block, the candidate block vector will not be not added. In addition, whether a spatial candidate is available can be determined based on the predefined IntraTMP search region. For example, if the position of a certain spatial candidate is beyond a search region for the current coding block, skip obtaining a candidate block vector from the spatial candidate.

7) When constructing AR-BVP candidate block vectors, block vectors in the first candidate list and existing block vectors in the Merge list can be used as guiding block vectors. For example, first N block vectors having the smallest template errors in the first candidate list and M existing block vectors in the Merge list are selected and taken as guiding block vectors, to derive AR-BVPs (relocated block vectors). For each of the guiding block vectors, the guiding block vector is combined with a block vector(s) for a reference block(s) determined according to the guiding block vector to obtain an AR-BVP(s).

8) When constructing AR-BVP candidate block vectors, multiple different offset values can be applied to a guiding block vector, and whether a block vector for a reference block exists at each of these positions is determined, thereby constructing multiple AR-BVPs.

9) Construction of AR-BVPs can be performed in multiple rounds. For example, the first round is the same as step 7: AR-BVPs_1 are obtained according to step 7 and step 8, where AR-BVPs_1 represent all AR-BVPs constructed and added to the Merge list in the first round. In the second round, AR-BVPs_1 are used as guiding block vectors, and AR-BVPs 2 are obtained according to step 8. If the Merge list reaches the maximum length or the number of AR-BVP n in a certain round is 0, construction will be terminated.

10) When constructing the Merge list, if bi-predictive IBC is to be applied to motion information to-be-merged, two block vectors used for bi-prediction can be added sequentially. For example, when merging motion information corresponding to spatial or history buffer candidates, two block vectors for bi-prediction are added sequentially. For example, when constructing AR-BVPs, if a guiding block vector points to a bi-predictive IBC block, two AR-BVPs will be constructed sequentially according to two block vectors for bi-prediction.

11) The merge list is obtained according to step 3~step 10. The merge list and the first candidate list can be merged to obtain a second candidate list. The second candidate list can be used to determine a search region for the second round of template matching. Merging can be performed based on template errors of block vectors. For example, the merge list has m candidates, and the first candidate list has n candidates. Based on the template errors of these m+n block vectors, first k block vectors are obtained, and the k block vectors form the second candidate list.

12) Based on block vectors in the second candidate list, a neighbouring region of each of these block vectors is determined, and the second round of template matching is performed to obtain x optimal block vectors (which can include block vectors in the second candidate list). Candidate block vectors obtained through different processes (e.g., obtained from different search regions, obtained from the Merge list) can be identified by indexes. Block vectors with different indexes in the second candidate list can have neighbouring regions of different sizes and shapes.

13) The same construction process is applied to an encoding end and a decoding end to obtain consistent optimal block vector lists. An IntraTMP-based prediction method is determined according to decoded information, and how to use the block vector list is determined to complete decoding of the current block.

In embodiments of the disclosure, a method (i.e., a decoding method and an encoding method) for combining IntraTMP template matching and Merge list construction is proposed, and a method for constructing AR-BVP candidates in an IntraTMP mode is provided, which can improve accuracy of candidate block vectors in the Merge list, thereby improving encoding efficiency.

In embodiments of the disclosure, there is no need to perform the first round of template matching, i.e., a Merge list is constructed and the Merge list is used as the first candidate list. Then, based on the first candidate list, a search region for a next round of template matching is determined. The Merge list can be rearranged according to template errors. For example, when constructing the Merge list, candidates are added up to a maximum length N; these N candidates are rearranged according to template errors, and first n candidates are retained to obtain the first candidate list.

In embodiments of the disclosure, there is no need to construct a Merge list. Instead, block vectors obtained through template matching can be used as guiding block vectors, thereby constructing AR-BVPs to expand the search region. For example, the first candidate list is obtained through the first round of search, and block vectors in the first candidate list can be sequentially used as guiding block vectors to construct AR-BVPs. These AR-BVPs are merged with the first candidate list to obtain the second candidate list, so as to perform the second round of search.

In embodiments of the disclosure, conditions can be set with regard to a guiding block vector: a template error of the guiding block vector is less than a threshold, a reference block is available (reconstructed, not beyond a boundary), and a reference region (IBC) (which can be determined according to a template region size, template errors of existing block vector candidates, etc.). If the conditions are not satisfied, skip constructing an AR-BVP for the current guiding block vector.

In embodiments of the disclosure, the condition of availability of an AR-BVP can include: the AR-BVP is within an IntraTMP search region or is within an IBC reference region; a template error less than a threshold (which can be determined according to a template region size, template errors of existing block vector candidates, etc.).

In embodiments of the disclosure, construction of the Merge list can be independent of the first candidate list. For example, the first candidate list will not be used to check redundancy; the first candidate list will not be used as guiding block vectors, and so on.

In embodiments of the disclosure, the block vectors involved shall be in integer-sample accuracy. For example, if the precision of a block vector is fractional-sample accuracy, the block vector can be converted to integer-sample accuracy through rounding.

In an embodiment of the disclosure, based on the same inventive concept as the foregoing embodiments, a bitstream is provided. The bitstream is generated by performing bit encoding according to information to-be-encoded, where the information to-be-encoded includes at least one of: first syntax element information, second syntax element information, a first maximum list length, and a residual value, where the first syntax element information indicates whether an IntraTMP-based prediction mode is to be applied to a current block, and the second syntax element information indicates an IntraTMP-based prediction mode to be applied to the current block.

In another embodiment of the disclosure, based on the same inventive concept as the foregoing embodiments, referring to FIG. 17, which is a schematic structural diagram of a decoder provided in embodiments of the disclosure. As illustrated in FIG. 17, the decoder 1000 includes a decoding part 1001 and a first determining part 1002. The decoding part 1001 is configured to parse a bitstream to determine first syntax element information. The first determining part 1002 is configured to: determine a first block vector candidate list for a current block if the first syntax element information indicates that an IntraTMP-based prediction mode is to be applied to the current block, where the first block vector candidate list is determined according to a first candidate list constructed based on a template matching technology and/or a second candidate list constructed based on a merge candidate technology; determine a second block vector candidate list based on the first block vector candidate list, where the second block vector candidate list includes a relocated block vector constructed for a first candidate block vector in the first block vector candidate list; and determine a prediction value for the current block based on the second block vector candidate list.

In some embodiments, the first determining part 1002 is further configured to: determine first candidate block vectors from the first block vector candidate list, where the first candidate block vectors are all or some candidate block vectors in the first block vector candidate list; and perform relocated block vector construction on the first candidate block vectors to obtain the second block vector candidate list.

In some embodiments, the first determining part 1002 is further configured to: determine, from the first candidate block vectors, guiding block vectors for a current round that satisfy a first preset condition; add relocated block vectors corresponding to the guiding block vectors for the current round to a current second block vector candidate list, to obtain an updated current second block vector candidate list; for any current guiding block vector in the guiding block vectors for the current round, determine a relocated block vector corresponding to the current guiding block vector according to a current reference block and/or a current block corresponding to the current guiding block vector; and determine, from the relocated block vectors corresponding to the guiding block vectors for the current round, a guiding block vector for a next round that satisfies the first preset condition, to obtain a next updated second block vector candidate list until the guiding block vector for the next round satisfies a second preset condition, and take the last updated second block vector candidate list as the second block vector candidate list.

In some embodiments, the first determining part 1002 is further configured to: offset the current guiding block vector according to the current reference block and/or the current block, to obtain a guiding block offset vector corresponding to the current guiding block vector; and determine the relocated block vector corresponding to the current guiding block vector based on the guiding block offset vector.

In some embodiments, the guiding block offset vector includes one or more of: a first guiding block offset vector, a second guiding block offset vector, a third guiding block offset vector, a fourth guiding block offset vector, or a fifth guiding block offset vector. The first guiding block offset vector indicates a first candidate reference block located at a center position of the current reference block. The second guiding block offset vector indicates a second candidate reference block located at a top-left position of the current reference block. The third guiding block offset vector indicates a third candidate reference block located at a bottom-left position of the current reference block. The fourth guiding block offset vector indicates a fourth candidate reference block located at a top-right position of the current reference block. The fifth guiding block offset vector indicates a fifth candidate reference block located at a bottom-right position of the current reference block.

In some embodiments, the first determining part 1002 is further configured to: determine a current guiding block offset vector from the guiding block offset vector; and if the current guiding block offset vector is available, determine a relocated block vector corresponding to the current guiding block offset vector according to a block vector for a candidate reference block corresponding to the current guiding block offset vector, where the relocated block vector corresponding to the current guiding block offset vector is one of the relocated block vectors corresponding to the current guiding block vector; or if the current guiding block offset vector is unavailable, skip the current guiding block offset vector and determine a next guiding block offset vector from the guiding block offset vector.

In some embodiments, the first determining part 1002 is further configured to: if a bi-predictive IBC mode is not to be applied to the candidate reference block, perform vector addition on the block vector for the candidate reference block corresponding to the current guiding block offset vector and the current guiding block vector, to obtain the relocated block vector corresponding to the current guiding block offset vector.

In some embodiments, the first determining part 1002 is further configured to: if a bi-predictive IBC mode is to be applied to the candidate reference block, determine a first reference block vector and a second reference block vector corresponding to the candidate reference block; perform vector addition on the first reference block vector and the current guiding block vector to determine a first relocated block vector corresponding to the current guiding block offset vector; and perform vector addition on the second reference block vector and the current guiding block vector to determine a second relocated block vector corresponding to the current guiding block offset vector.

In some embodiments, the first determining part 1002 is further configured to: determine that the current guiding block offset vector is available if one or more of the following conditions are satisfied: the current guiding block offset vector exists; a candidate reference block indicated by the current guiding block offset vector is reconstructed; a template cost value corresponding to the current guiding block offset vector is less than or equal to a first threshold; the candidate reference block indicated by the current guiding block offset vector is within a preset range; or a prediction mode for the candidate reference block indicated by the current guiding block offset vector is an IBC mode or an IntraTMP mode; or determine that the current guiding block offset vector is unavailable if one or more of the following conditions are satisfied: the current guiding block offset vector does not exist; the candidate reference block indicated by the current guiding block offset vector is not reconstructed; the template cost value corresponding to the current guiding block offset vector is greater than the first threshold; the candidate reference block indicated by the current guiding block offset vector is not within the preset range; or the prediction mode for the candidate reference block indicated by the current guiding block offset vector is not an IBC mode or an IntraTMP mode.

In some embodiments, the first preset condition includes one or more of: a template cost value corresponding to a guiding block vector is less than or equal to a second threshold, where the second threshold is obtained according to template cost values corresponding to block vectors added in the first block vector candidate list and/or the second block vector candidate list; a reference block corresponding to the guiding block vector is reconstructed; a reference block corresponding to the guiding block vector does not exceed a search range for IntraTMP; or the reference block corresponding to the guiding block vector does not exceed a search range for an IBC mode.

In some embodiments, the second preset condition includes one or more of: the next round exceeds or reaches an iteration threshold; the number of guiding block vectors for the next round is less than or equal to a third threshold; a template cost value corresponding to each of at least one guiding block vector in the guiding block vectors for the next round is greater than or equal to a fourth threshold; or a list length of the next updated second block vector candidate list corresponding to the next round is greater than or equal to a maximum list-length threshold.

In some embodiments, the first block vector candidate list includes any one of: a first candidate list, a second candidate list, or a third candidate list. The first candidate list is determined by performing intra template matching within a preset search range corresponding to the current block. The second candidate list is determined by merging block vectors corresponding to one or more candidate blocks having similar motion to the current block. The third candidate list is determined based on the first candidate list and the second candidate list.

In some embodiments, if the first block vector candidate list is the first candidate list, the first candidate block vector includes: all candidate block vectors in the first candidate list; or M candidate block vectors having the smallest template costs in the first candidate list, where M is a positive integer and M≥1.

In some embodiments, if the first block vector candidate list is the second candidate list, the first candidate block vector includes: all candidate block vectors in the second candidate list; or N candidate block vectors having the smallest template costs in the second candidate list, where N is a positive integer and N≥1.

In some embodiments, if the first block vector candidate list is the third candidate list, the first candidate block vector includes: all candidate block vectors in the first candidate list and all candidate block vectors in the second candidate list; or M candidate block vectors having the smallest template costs in the first candidate list and all candidate block vectors in the second candidate list; or all candidate block vectors in the first candidate list and N candidate block vectors having the smallest template costs in the second candidate list; or M candidate block vectors having the smallest template costs in the first candidate list and N candidate block vectors having the smallest template costs in the second candidate list; or H candidate block vectors having the smallest template costs among candidate block vectors obtained by merging all candidate block vectors in the first candidate list with all candidate block vectors in the second candidate list, where H is a positive integer and H≥1.

In some embodiments, the first determining part 1002 is further configured to: determine the first candidate list, and take the first candidate list as the first block vector candidate list.

In some embodiments, the first determining part 1002 is further configured to: search within a preset search range at a preset step size to obtain first matching block vectors; determine, from the first matching block vectors, a first block vector having the smallest template cost; and determine the first candidate list according to the first block vector.

In some embodiments, the first determining part 1002 is further configured to: determine the second candidate list, and take the second candidate list as the first block vector candidate list.

In some embodiments, the first determining part 1002 is further configured to: determine the second candidate list according to second block vectors, where a matching block corresponding to each of the second block vectors has similar motion to the current block.

In some embodiments, the second candidate list includes one or more of: block vectors corresponding to one or more spatial neighbouring candidate blocks; block vectors corresponding to one or more spatial non-neighbouring candidate blocks; block vectors obtained according to one or more IBC history block vector buffers; an average block vector of one or more existing block vectors in a current second candidate list; one or more block vectors predefined based on the size of the current block; one or more relocated block vectors constructed for the first candidate block vector.

In some embodiments, the first determining part 1002 is further configured to: parse a bitstream to determine a first maximum list length; for a current second block vector in the second block vectors, add the current second block vector to a current second candidate list to obtain an updated current second candidate list; and if the number of second block vectors in the updated current second candidate list is less than the first maximum list length, add a next second block vector to the updated current second candidate list to obtain a next updated second candidate list until the number of second block vectors in the next updated second candidate list is equal to the first maximum list length, and take the last updated second candidate list as the second candidate list; or if the number of second block vectors in the updated current second candidate list is equal to the first maximum list length, take the updated current second candidate list as the second candidate list.

In some embodiments, the first determining part 1002 is further configured to: if the current second block vector satisfies a third preset condition, add the current second block vector to the current second candidate list to obtain the updated current second candidate list; or if the current second block vector does not satisfy the third preset condition, skip the current second block vector and add a next second block vector to the updated current second candidate list to obtain a next updated second candidate list.

In some embodiments, the third preset condition includes one or more of: a reference block corresponding to the current second block vector does not exceed a search range for an IntraTMP mode; the reference block corresponding to the current second block vector does not exceed the size of a picture boundary of the current block; the reference block corresponding to the current second block vector does not exceed the size of a reconstructed region in a current picture; the reference block corresponding to the current second block vector does not exceed the size of a CTU corresponding to the current block; or a template cost value corresponding to the current second block vector is less than or equal to a preset threshold, where the preset threshold is obtained according to template cost values corresponding to block vectors added in the first block vector candidate list and/or the second block vector candidate list.

In some embodiments, the first determining part 1002 is further configured to: perform redundancy removal on the second block vectors added in the current second candidate list.

In some embodiments, the first determining part 1002 is further configured to: for any second block vector added in the current second candidate list, add the current second block vector to the current second candidate list to obtain the updated current second candidate list, if a difference value in a horizontal direction between the current second block vector and the second block vector added is less than or equal to a fifth threshold and a difference value in a vertical direction between the current second block vector and the second block vector added is less than or equal to the fifth threshold; or skip the current second block vector and add the next second block vector to the updated current second candidate list to obtain the next updated second candidate list, if the difference value in a horizontal direction between the current second block vector and the second block vector added is greater than the fifth threshold or the difference value in a vertical direction between the current second block vector and the second block vector added is greater than the fifth threshold.

In some embodiments, the first determining part 1002 is further configured to: if the first candidate list is constructed, performing redundancy removal on the second block vectors added in the current second candidate list according to the first candidate list.

In some embodiments, the first determining part 1002 is further configured to: for any second block vector added in the current second candidate list and any first block vector added in the first candidate list, add the current second block vector to the current second candidate list to obtain the updated current second candidate list, if a difference value in a horizontal direction between the current second block vector and the second block vector added and a difference value in a horizontal direction between the current second block vector and the first block vector added each are less than or equal to a fifth threshold, and a difference value in a vertical direction between the current second block vector and the second block vector added and a difference value in a vertical direction between the current second block vector and the first block vector added each are less than or equal to the fifth threshold; or skip the current second block vector and adding a next second block vector to the updated current second candidate list to obtain the next updated second candidate list, if the difference value in a horizontal direction between the current second block vector and the second block vector added and the difference value in a horizontal direction between the current second block vector and the first block vector added each are greater than the fifth threshold, or the difference value in a vertical direction between the current second block vector and the second block vector added and the difference value in a vertical direction between the current second block vector and the first block vector added is greater than the fifth threshold.

In some embodiments, the fifth threshold depends on the size of the current block and/or a vector precision of the current second block vector.

In some embodiments, the first determining part 1002 is further configured to: adjust a first reference value according to the size of the current block to obtain the fifth threshold.

In some embodiments, the first determining part 1002 is further configured to: increase the first reference value to obtain the fifth threshold if the size of the current block is greater than or equal to a first preset value; or decrease the first reference value to obtain the fifth threshold if the size of the current block is less than the first preset value.

In some embodiments, the first determining part 1002 is further configured to: adjust a second reference value according to the vector precision of the current second block vector to obtain the fifth threshold.

In some embodiments, the first determining part 1002 is further configured to: decrease the second reference value to obtain the fifth threshold if the vector precision of the current second block vector is greater than or equal to a second preset value; or increase the second reference value to obtain the fifth threshold if the vector precision of the current second block vector is less than the second preset value.

In some embodiments, the first determining part 1002 is further configured to: determine the first candidate list and determine the second candidate list; and determine a third candidate list according to the first candidate list and the second candidate list, and take the third candidate list as the first block vector candidate list.

In some embodiments, the first determining part 1002 is further configured to: merge K first block vectors in the first candidate list with L second block vectors in the second candidate list to obtain the third candidate list, where K and L each are a positive integer, K≥1, and L≥1.

In some embodiments, the first determining part 1002 is further configured to: determine, from the K first block vectors and the L second block vectors, P candidate block vectors having the smallest template costs, where P is a positive integer and 1≤P≤K+L; and determine the third candidate list according to the P candidate block vectors.

In some embodiments, the first determining part 1002 is further configured to: for a j^{th} candidate block vector among the K first block vectors and the L second block vectors, add the j^{th} candidate block vector to a current third candidate list to obtain an updated current third candidate list, where j is a positive integer and 1≤j≤K+L; and if the number of candidate block vectors in the updated current third candidate list is less than a second maximum list length, add a (j+1)^{th} candidate block vector to the updated current third candidate list to obtain a next updated third candidate list until the number of candidate block vectors in the next updated third candidate list is equal to the second maximum list length, and take the last updated third candidate list as the third candidate list; or if the number of candidate block vectors in the updated current third candidate list is equal to the second maximum list length, take the updated current third candidate list as the third candidate list.

In some embodiments, the first determining part 1002 is further configured to: perform redundancy removal on candidate block vectors added in the current third candidate list.

In some embodiments, the first determining part 1002 is further configured to: for any first block vector and any second block vector added in the current third candidate list, add the j^{th} candidate block vector to the current third candidate list to obtain the updated current third candidate list, if a difference value in a horizontal direction between the j^{th} candidate block vector and the second block vector is less than or equal to a fifth threshold, a difference value in a vertical direction between the j^{th} candidate block vector and the second block vector is less than or equal to the fifth threshold, a difference value in a horizontal direction between the j^{th} candidate block vector and the first block vector is less than or equal to a sixth threshold, and a difference value in a vertical direction between the j^{th} candidate block vector and the first block vector is less than or equal to the sixth threshold, where the first block vector is from the first candidate list, and the second block vector is from the second candidate list; or skip the j^{th} candidate block vector and adding the (j+1)^{th} candidate block vector to the updated current third candidate list to obtain the next updated third candidate list, if the difference value in a horizontal direction between the j^{th} candidate block vector and the second block vector is greater than the fifth threshold, or the difference value in a vertical direction between the j^{th} candidate block vector and the second block vector is greater than the fifth threshold, or the difference value in a horizontal direction between the j^{th} candidate block vector and the first block vector is greater than the sixth threshold, or the difference value in a vertical direction between the j^{th} candidate block vector and the first block vector is greater than the sixth threshold.

In some embodiments, the sixth threshold depends on the size of the current block and/or a block-level flag for a reference block indicated by the j^{th} candidate block vector.

In some embodiments, the first determining part 1002 is further configured to: adjust a third reference value according to the size of the current block to obtain the sixth threshold.

In some embodiments, the first determining part 1002 is further configured to: increase the third reference value to obtain the sixth threshold if the size of the current block is greater than or equal to a third preset value; or decrease the third reference value to obtain the sixth threshold if the size of the current block is less than the third preset value.

In some embodiments, the first determining part 1002 is further configured to: adjust a fourth reference value according to the block-level flag for the reference block indicated by the j^{th} candidate block vector to obtain the sixth threshold.

In some embodiments, the first determining part 1002 is further configured to: decrease the fourth reference value to obtain the sixth threshold if the block-level flag indicates that the reference block corresponding to the j^{th} candidate block vector satisfies a preset prediction mode and/or a preset block feature; or increase the fourth reference value to obtain the sixth threshold if the block-level flag indicates that the reference block corresponding to the j^{th} candidate block vector does not satisfy the preset prediction mode and/or the preset block feature.

In some embodiments, the first determining part 1002 is further configured to: if any candidate block vector in the first block vector candidate list and the second block vector candidate list is in fractional-sample accuracy, perform accuracy conversion on the candidate block vector such that the candidate block vector is in integer-sample accuracy.

In some embodiments, the first determining part 1002 is further configured to: parse a bitstream to determine second syntax element information; perform template matching on second candidate block vectors in the second block vector candidate list to obtain a third block vector candidate list; and determine the prediction value for the current block according to an IntraTMP-based prediction mode to be applied to the current block indicated by the second syntax element information and the third block vector candidate list.

In some embodiments, the first determining part 1002 is further configured to: for any second candidate block vector in the second candidate block vectors, determine a neighbouring region of the second candidate block vector according to index flag information for the second candidate block vector; search in the neighbouring region of the second candidate block vector at a preset step size to obtain second matching block vectors corresponding to the second candidate block vector; determine, from the second matching block vectors corresponding to the second candidate block vector, a third block vector having the smallest template cost; and determine the third block vector candidate list according to the third block vector corresponding to the second candidate block vector.

In some embodiments, the decoding part 1001 is further configured to: if a value of the first syntax element information is a first value, determine that the IntraTMP-based prediction mode is to be applied to the current block; or if the value of the first syntax element information is a second value, determine that the IntraTMP-based prediction mode is not to be applied to the current block.

In some embodiments, the first determining part 1002 is further configured to: parse the bitstream to determine a residual value of the current block; and determine a reconstructed value of the current block according to the prediction value for the current block and the residual value of the current block.

It can be understood that, in embodiments of the disclosure, the term “part” can be a portion of circuit, a portion of a processor, a portion of a program or software, or can be modular or non-modular. In addition, various components described in various embodiments of the disclosure may be integrated into one processing unit or may be present as a number of physically separated units, and two or more units may be integrated into one. The integrated unit may take the form of hardware or a software functional unit.

If the integrated unit is implemented as software functional modules and not sold or used as standalone products, it may be stored in a computer-readable storage medium. Based on such an understanding, the essential technical solutions of embodiments, or the portion that contributes to the related art, or all or part of the technical solutions may be embodied as software products. The computer software products can be stored in a storage medium and may include multiple instructions that, when executed, can cause a computer device, e.g., a personal computer, a server, a network device, a processor, etc., to execute some or all operations of the methods described in various embodiments of the disclosure. The above storage medium may include various kinds of media that can store program codes, such as a universal serial bus (USB) flash disk, a mobile hard drive, a read-only memory (ROM), a random access memory (RAM), a mobile hard drive, a magnetic disk, an optical disk, etc.

Therefore, embodiments of the disclosure provide a computer-readable storage medium. The computer-readable storage medium is applied to a decoder 1000. The computer-readable storage medium stores computer programs which, when executed by a first processor, implement the method according to any of the foregoing embodiments.

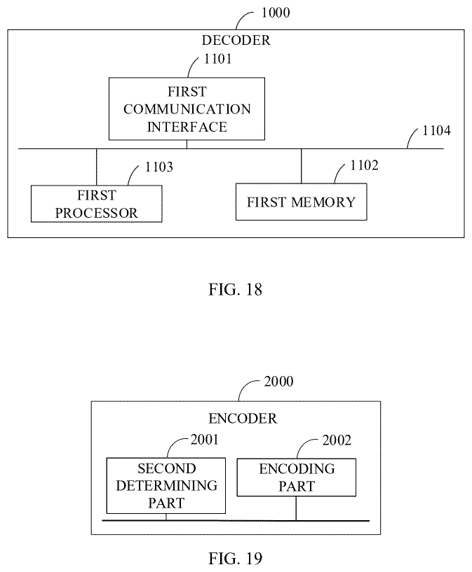

Based on the composition of the decoder 1000 and the computer-readable storage medium described above, referring to FIG. 18, FIG. 18 is a schematic diagram illustrating the hardware structure of the decoder 1000 provided in embodiments of the disclosure. As illustrated in FIG. 18, the decoder 1000 may include: a first communication interface 1101, a first memory 1102, and a first processor 1103. These components are coupled together via a first bus system 1104. It can be understood that, the first bus system 1104 is configured for connection and communication between these components. In addition to a data bus, the first bus system 1104 further includes a power bus, a control bus, and a status signal bus. However, for clarity of illustration, all buses are labeled as the first bus system 1104 in FIG. 14. The first communication interface 1101 is configured for signal reception and transmission during information reception and transmission with other external network elements. The first memory 1102 is configured to store computer programs executable by the first processor 1103. The first processor 1103 is configured to, when running the computer programs, perform the following operations: parse a bitstream to determine first syntax element information; determine a first block vector candidate list for a current block if the first syntax element information indicates that an IntraTMP-based prediction mode is to be applied to the current block, where the first block vector candidate list is determined according to a first candidate list constructed based on a template matching technology and/or a second candidate list constructed based on a merge candidate technology; determine a second block vector candidate list based on the first block vector candidate list, where the second block vector candidate list includes a relocated block vector constructed for a first candidate block vector in the first block vector candidate list; and determine a prediction value for the current block based on the second block vector candidate list.

It can be understood that, the first memory 1102 in embodiments of the disclosure may be a volatile memory or a non-volatile memory, or may include both the volatile memory and the non-volatile memory. The non-volatile memory may be a ROM, a PROM, an erasable PROM (EPROM), an electrically EPROM (EEPROM), or flash memory. The volatile memory can be a RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that, the first memory 1102 of the systems and methods described in the disclosure is intended to include, but is not limited to, these and any other suitable types of memory.

The first processor 1103 in embodiments of the disclosure may be an integrated circuit chip with signal processing capabilities. During implementation, each step of the foregoing method embodiments may be completed by an integrated logic circuit of hardware in the first processor 1103 or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium such as a RAM, a flash memory, a ROM, a PROM, or an electrically erasable programmable memory, registers, and the like. The storage medium is located in the first memory 1102. The first processor 1103 reads the information in the first memory 1102, and completes the steps of the method described above with the hardware thereof.

It is understandable that the embodiments described in the disclosure may be implemented in hardware, software, firmware, middleware, microcode, or any combination thereof. For a hardware implementation, the processing unit may be implemented within one or more ASICs, DSPs, DSP devices (DSPDs), PLDs, FPGAs, general-purpose processors, controllers, microcontrollers, microprocessors, other electronic units designed to perform the functions described in the disclosure, or a combination thereof. For a software implementation, the techniques described in the disclosure may be realized through modules (e.g., procedures, functions, etc.) for performing the functions described in the disclosure. Software codes may be stored in a memory and executed by a processor. The memory may be implemented within the processor or externally to the processor.

Optionally, as another embodiment, the first processor 1103 is further configured to perform the method according to any of the foregoing embodiments when running the computer programs.

In another embodiment of the disclosure, based on the same inventive concept as the foregoing embodiments, referring to FIG. 19, which is a schematic structural diagram of an encoder provided in embodiments of the disclosure. As illustrated in FIG. 19, the encoder 2000 can include a second determining part 2001 and an encoding part 2002. The second determining part 2001 is configured to: determine a prediction mode to be applied to a current block, and determine first syntax element information according to the prediction mode to be applied to the current block; where the first syntax element information indicates whether an IntraTMP-based prediction mode is to be applied to the current block; determine a first block vector candidate list for the current block if the prediction mode for the current block is IntraTMP-based prediction mode, where the first block vector candidate list is determined according to a first candidate list constructed based on a template matching technology and/or a second candidate list constructed based on a merge candidate technology; determine a second block vector candidate list based on the first block vector candidate list, where the second block vector candidate list includes a relocated block vector constructed for a first candidate block vector in the first block vector candidate list; and determine a prediction value for the current block based on the second block vector candidate list.

In some embodiments, the second determining part 2001 is further configured to: determine first candidate block vectors from the first block vector candidate list, where the first candidate block vectors are all or some candidate block vectors in the first block vector candidate list; and perform relocated block vector construction on the first candidate block vectors to obtain the second block vector candidate list.

In some embodiments, the second determining part 2001 is further configured to: determine, from the first candidate block vectors, guiding block vectors for a current round that satisfy a first preset condition; add relocated block vectors corresponding to the guiding block vectors for the current round to a current second block vector candidate list, to obtain an updated current second block vector candidate list; for any current guiding block vector in the guiding block vectors for the current round, determine a relocated block vector corresponding to the current guiding block vector according to a current reference block and/or a current block corresponding to the current guiding block vector; and determine, from the relocated block vectors corresponding to the guiding block vectors for the current round, a guiding block vector for a next round that satisfies the first preset condition, to obtain a next updated second block vector candidate list until the guiding block vector for the next round satisfies a second preset condition, and take the last updated second block vector candidate list as the second block vector candidate list.

In some embodiments, the second determining part 2001 is further configured to: offset the current guiding block vector according to the current reference block and/or the current block, to obtain a guiding block offset vector corresponding to the current guiding block vector; and determine the relocated block vector corresponding to the current guiding block vector based on the guiding block offset vector.

In some embodiments, the guiding block offset vector includes one or more of: a first guiding block offset vector, a second guiding block offset vector, a third guiding block offset vector, a fourth guiding block offset vector, or a fifth guiding block offset vector. The first guiding block offset vector indicates a first candidate reference block located at a center position of the current reference block. The second guiding block offset vector indicates a second candidate reference block located at a top-left position of the current reference block. The third guiding block offset vector indicates a third candidate reference block located at a bottom-left position of the current reference block. The fourth guiding block offset vector indicates a fourth candidate reference block located at a top-right position of the current reference block. The fifth guiding block offset vector indicates a fifth candidate reference block located at a top-right position of the current reference block.

In some embodiments, the second determining part 2001 is further configured to: determine a current guiding block offset vector from the guiding block offset vector; and if the current guiding block offset vector is available, determine a relocated block vector corresponding to the current guiding block offset vector according to a block vector for a candidate reference block corresponding to the current guiding block offset vector, where the relocated block vector corresponding to the current guiding block offset vector is one of the relocated block vectors corresponding to the current guiding block vector; or if the current guiding block offset vector is unavailable, skip the current guiding block offset vector and determine a next guiding block offset vector from the guiding block offset vector.

In some embodiments, the second determining part 2001 is further configured to: if a bi-predictive IBC mode is not to be applied to the candidate reference block, perform vector addition on the block vector for the candidate reference block corresponding to the current guiding block offset vector and the current guiding block vector, to obtain the relocated block vector corresponding to the current guiding block offset vector.

In some embodiments, the second determining part 2001 is further configured to: if a bi-predictive IBC mode is to be applied to the candidate reference block, determine a first reference block vector and a second reference block vector corresponding to the candidate reference block; perform vector addition on the first reference block vector and the current guiding block vector to determine a first relocated block vector corresponding to the current guiding block offset vector; and perform vector addition on the second reference block vector and the current guiding block vector to determine a second relocated block vector corresponding to the current guiding block offset vector.

In some embodiments, the second determining part 2001 is further configured to: determine that the current guiding block offset vector is available if one or more of the following conditions are satisfied: the current guiding block offset vector exists; a candidate reference block indicated by the current guiding block offset vector is reconstructed; a template cost value corresponding to the current guiding block offset vector is less than or equal to a first threshold; the candidate reference block indicated by the current guiding block offset vector is within a preset range; or a prediction mode for the candidate reference block indicated by the current guiding block offset vector is an IBC mode or an IntraTMP mode; or determine that the current guiding block offset vector is unavailable if one or more of the following conditions are satisfied: the current guiding block offset vector does not exist; the candidate reference block indicated by the current guiding block offset vector is not reconstructed; the template cost value corresponding to the current guiding block offset vector is greater than the first threshold; the candidate reference block indicated by the current guiding block offset vector is not within the preset range; or the prediction mode for the candidate reference block indicated by the current guiding block offset vector is not an IBC mode or an IntraTMP mode.

In some embodiments, the first preset condition includes one or more of: a template cost value corresponding to a guiding block vector is less than or equal to a second threshold, where the second threshold is obtained according to template cost values corresponding to block vectors added in the first block vector candidate list and/or the second block vector candidate list; a reference block corresponding to the guiding block vector is reconstructed; a reference block corresponding to the guiding block vector does not exceed a search range for IntraTMP; or the reference block corresponding to the guiding block vector does not exceed a search range for an IBC mode.

In some embodiments, the second preset condition includes one or more of: the next round exceeds or reaches an iteration threshold; the number of guiding block vectors for the next round is less than or equal to a third threshold; a template cost value corresponding to each of at least one guiding block vector in the guiding block vectors for the next round is greater than or equal to a fourth threshold; or a list length of the next updated second block vector candidate list corresponding to the next round is greater than or equal to a maximum list-length threshold.

In some embodiments, the first block vector candidate list includes any one of: a first candidate list, a second candidate list, or a third candidate list. The first candidate list is determined by performing intra template matching within a preset search range corresponding to the current block. The second candidate list is determined by merging block vectors corresponding to one or more candidate blocks having similar motion to the current block. The third candidate list is determined based on the first candidate list and the second candidate list.

In some embodiments, if the first block vector candidate list is the first candidate list, the first candidate block vector includes: all candidate block vectors in the first candidate list; or M candidate block vectors having the smallest template costs in the first candidate list, where M is a positive integer and M≥1.

In some embodiments, if the first block vector candidate list is the second candidate list, the first candidate block vector includes: all candidate block vectors in the second candidate list; or N candidate block vectors having the smallest template costs in the second candidate list, where N is a positive integer and N≥1.

In some embodiments, if the first block vector candidate list is the third candidate list, the first candidate block vector includes: all candidate block vectors in the first candidate list and all candidate block vectors in the second candidate list; or M candidate block vectors having the smallest template costs in the first candidate list and all candidate block vectors in the second candidate list; or all candidate block vectors in the first candidate list and N candidate block vectors having the smallest template costs in the second candidate list; or M candidate block vectors having the smallest template costs in the first candidate list and N candidate block vectors having the smallest template costs in the second candidate list; or H candidate block vectors having the smallest template costs among candidate block vectors obtained by merging all candidate block vectors in the first candidate list with all candidate block vectors in the second candidate list, where H is a positive integer and H≥1.

In some embodiments, the second determining part 2001 is further configured to: determine the first candidate list, and take the first candidate list as the first block vector candidate list.

In some embodiments, the second determining part 2001 is further configured to: searching within a preset search range at a preset step size to obtain first matching block vectors; determining, from the first matching block vectors, a first block vector having the smallest template cost; and determining the first candidate list according to the first block vector.

In some embodiments, the second determining part 2001 is further configured to: determine the second candidate list, and take the second candidate list as the first block vector candidate list.

In some embodiments, the second determining part 2001 is further configured to: determine the second candidate list according to second block vectors, where a matching block corresponding to each of the second block vectors has similar motion to the current block.

In some embodiments, the second candidate list includes one or more of: block vectors corresponding to one or more spatial neighbouring candidate blocks; block vectors corresponding to one or more spatial non-neighbouring candidate blocks; block vectors obtained according to one or more IBC history block vector buffers; an average block vector of one or more existing block vectors in a current second candidate list; one or more block vectors predefined based on the size of the current block; one or more relocated block vectors constructed for the first candidate block vector.

In some embodiments, the second determining part 2001 is further configured to: for a current second block vector in the second block vectors, add the current second block vector to a current second candidate list to obtain an updated current second candidate list; and if the number of second block vectors in the updated current second candidate list is less than a first maximum list length, add a next second block vector to the updated current second candidate list to obtain a next updated second candidate list until the number of second block vectors in the next updated second candidate list is equal to the first maximum list length, and take the last updated second candidate list as the second candidate list; or if the number of second block vectors in the updated current second candidate list is equal to the first maximum list length, take the updated current second candidate list as the second candidate list.

In some embodiments, the encoding part 2002 is configured to: encode the first maximum list length, and signalling obtained encoded bits into a bitstream.

In some embodiments, the second determining part 2001 is further configured to: if the current second block vector satisfies a third preset condition, adding the current second block vector to the current second candidate list to obtain the updated current second candidate list; or if the current second block vector does not satisfy the third preset condition, skipping the current second block vector and adding a next second block vector to the updated current second candidate list to obtain a next updated second candidate list.

In some embodiments, the third preset condition includes one or more of: a reference block corresponding to the current second block vector does not exceed a search range for an IntraTMP mode; the reference block corresponding to the current second block vector does not exceed the size of a picture boundary of the current block; the reference block corresponding to the current second block vector does not exceed the size of a reconstructed region in a current picture; the reference block corresponding to the current second block vector does not exceed the size of a CTU corresponding to the current block; or a template cost value corresponding to the current second block vector is less than or equal to a preset threshold, where the preset threshold is obtained according to template cost values corresponding to block vectors added in the first block vector candidate list and/or the second block vector candidate list.

In some embodiments, the second determining part 2001 is further configured to: perform redundancy removal on the second block vectors added in the current second candidate list.

In some embodiments, the second determining part 2001 is further configured to: for any second block vector added in the current second candidate list, add the current second block vector to the current second candidate list to obtain the updated current second candidate list, if a difference value in a horizontal direction between the current second block vector and the second block vector added is less than or equal to a fifth threshold and a difference value in a vertical direction between the current second block vector and the second block vector added is less than or equal to the fifth threshold; or skip the current second block vector and add the next second block vector to the updated current second candidate list to obtain the next updated second candidate list, if the difference value in a horizontal direction between the current second block vector and the second block vector added is greater than the fifth threshold or the difference value in a vertical direction between the current second block vector and the second block vector added is greater than the fifth threshold.

In some embodiments, the second determining part 2001 is further configured to: if the first candidate list is constructed, perform redundancy removal on the second block vectors added in the current second candidate list according to the first candidate list.

In some embodiments, the second determining part 2001 is further configured to: for any second block vector added in the current second candidate list and any first block vector added in the first candidate list, add the current second block vector to the current second candidate list to obtain the updated current second candidate list, if a difference value in a horizontal direction between the current second block vector and the second block vector added and a difference value in a horizontal direction between the current second block vector and the first block vector added each are less than or equal to a fifth threshold, and a difference value in a vertical direction between the current second block vector and the second block vector added and a difference value in a vertical direction between the current second block vector and the first block vector added each are less than or equal to the fifth threshold; or skip the current second block vector and add a next second block vector to the updated current second candidate list to obtain the next updated second candidate list, if the difference value in a horizontal direction between the current second block vector and the second block vector added and the difference value in a horizontal direction between the current second block vector and the first block vector added each are greater than the fifth threshold, or the difference value in a vertical direction between the current second block vector and the second block vector added and the difference value in a vertical direction between the current second block vector and the first block vector added is greater than the fifth threshold.

In some embodiments, the fifth threshold depends on the size of the current block and/or a vector precision of the current second block vector.

In some embodiments, the second determining part 2001 is further configured to: adjust a first reference value according to the size of the current block to obtain the fifth threshold.

In some embodiments, the second determining part 2001 is further configured to: increase the first reference value to obtain the fifth threshold if the size of the current block is greater than or equal to a first preset value; or decrease the first reference value to obtain the fifth threshold if the size of the current block is less than the first preset value.

In some embodiments, the second determining part 2001 is further configured to: adjust a second reference value according to the vector precision of the current second block vector to obtain the fifth threshold.

In some embodiments, the second determining part 2001 is further configured to: decrease the second reference value to obtain the fifth threshold if the vector precision of the current second block vector is greater than or equal to a second preset value; or increase the second reference value to obtain the fifth threshold if the vector precision of the current second block vector is less than the second preset value.

In some embodiments, the second determining part 2001 is further configured to: determine the first candidate list and determine the second candidate list; and determine a third candidate list according to the first candidate list and the second candidate list, and take the third candidate list as the first block vector candidate list. The second determining part 2001 configured to determine the third candidate list according to the first candidate list and the second candidate list is configured to merge K first block vectors in the first candidate list with L second block vectors in the second candidate list to obtain the third candidate list, where K and L each are a positive integer, K≥1, and L≥1.

In some embodiments, the second determining part 2001 is further configured to: determine, from the K first block vectors and the L second block vectors, P candidate block vectors having the smallest template costs, where P is a positive integer and 1≤P≤K+L; and determine the third candidate list according to the P candidate block vectors.

In some embodiments, the second determining part 2001 is further configured to: for a j^{th} candidate block vector among the K first block vectors and the L second block vectors, add the j^{th} candidate block vector to a current third candidate list to obtain an updated current third candidate list, where j is a positive integer and 1≤j≤K+L; and if the number of candidate block vectors in the updated current third candidate list is less than a second maximum list length, add a (j+1)^{th} candidate block vector to the updated current third candidate list to obtain a next updated third candidate list until the number of candidate block vectors in the next updated third candidate list is equal to the second maximum list length, and take the last updated third candidate list as the third candidate list; or if the number of candidate block vectors in the updated current third candidate list is equal to the second maximum list length, take the updated current third candidate list as the third candidate list.

In some embodiments, the second determining part 2001 is further configured to: perform redundancy removal on candidate block vectors added in the current third candidate list.

In some embodiments, the second determining part 2001 is further configured to: for any first block vector and any second block vector added in the current third candidate list, add the j^{th} candidate block vector to the current third candidate list to obtain the updated current third candidate list, if a difference value in a horizontal direction between the j^{th} candidate block vector and the second block vector is less than or equal to a fifth threshold, a difference value in a vertical direction between the j^{th} candidate block vector and the second block vector is less than or equal to the fifth threshold, a difference value in a horizontal direction between the j^{th} candidate block vector and the first block vector is less than or equal to a sixth threshold, and a difference value in a vertical direction between the j^{th} candidate block vector and the first block vector is less than or equal to the sixth threshold, where the first block vector is from the first candidate list, and the second block vector is from the second candidate list; or skip the j^{th} candidate block vector and add the (j+1)^{th} candidate block vector to the updated current third candidate list to obtain the next updated third candidate list, if the difference value in a horizontal direction between the j^{th} candidate block vector and the second block vector is greater than the fifth threshold, or the difference value in a vertical direction between the j^{th} candidate block vector and the second block vector is greater than the fifth threshold, or the difference value in a horizontal direction between the j^{th} candidate block vector and the first block vector is greater than the sixth threshold, or the difference value in a vertical direction between the j^{th} candidate block vector and the first block vector is greater than the sixth threshold.

In some embodiments, the sixth threshold depends on the size of the current block and/or a block-level flag for a reference block indicated by the j^{th} candidate block vector.

In some embodiments, the second determining part 2001 is further configured to: adjusting a third reference value according to the size of the current block to obtain the sixth threshold.

In some embodiments, the second determining part 2001 is further configured to: increase the third reference value to obtain the sixth threshold if the size of the current block is greater than or equal to a third preset value; or decrease the third reference value to obtain the sixth threshold if the size of the current block is less than the third preset value.

In some embodiments, the second determining part 2001 is further configured to: adjusting a fourth reference value according to the block-level flag for the reference block indicated by the j^{th} candidate block vector to obtain the sixth threshold.

In some embodiments, the second determining part 2001 is further configured to: decreasing the fourth reference value to obtain the sixth threshold if the block-level flag indicates that the reference block corresponding to the j^{th} candidate block vector satisfies a preset prediction mode and/or a preset block feature; or increasing the fourth reference value to obtain the sixth threshold if the block-level flag indicates that the reference block corresponding to the j^{th} candidate block vector does not satisfy the preset prediction mode and/or the preset block feature.

In some embodiments, the second determining part 2001 is further configured to: if any candidate block vector in the first block vector candidate list and the second block vector candidate list is in fractional-sample accuracy, perform accuracy conversion on the candidate block vector such that the candidate block vector is in integer-sample accuracy.

In some embodiments, the second determining part 2001 is further configured to: perform template matching on second candidate block vectors in the second block vector candidate list to obtain a third block vector candidate list; and determine the prediction value for the current block according to an IntraTMP-based prediction mode to be applied to the current block and the third block vector candidate list.

In some embodiments, the second determining part 2001 is further configured to: for any second candidate block vector in the second candidate block vectors, determine a neighbouring region of the second candidate block vector according to index flag information for the second candidate block vector; search in the neighbouring region of the second candidate block vector at a preset step size to obtain second matching block vectors corresponding to the second candidate block vector; determine, from the second matching block vectors corresponding to the second candidate block vector, a third block vector having the smallest template cost; and determine the third block vector candidate list according to the third block vector corresponding to the second candidate block vector.

In some embodiments, the second determining part 2001 is further configured to: pre-encode the current block by applying multiple candidate prediction modes to obtain loss values corresponding to the multiple candidate prediction modes, where the multiple candidate prediction modes include the IntraTMP-based prediction mode; perform rate-distortion cost calculation on the loss values corresponding to the multiple candidate prediction modes, to obtain rate-distortion cost values corresponding to the multiple candidate prediction modes; and determine the prediction mode to be applied to the current block according to the rate-distortion cost values corresponding to the multiple candidate prediction modes.

In some embodiments, the encoding part 2002 is configured to: encode the first syntax element information, and signal obtained encoded bits into the bitstream.

In some embodiments, the second determining part 2001 is further configured to: determine that the IntraTMP-based prediction mode is to be applied to the current block, if a rate-distortion cost value corresponding to the IntraTMP-based prediction mode is less than or equal to a rate-distortion cost value corresponding to each of the multiple candidate prediction modes other than the IntraTMP-based prediction mode; or determine that the IntraTMP-based prediction mode is not to be applied to the current block, if the rate-distortion cost value corresponding to the IntraTMP-based prediction mode is greater than a rate-distortion cost value corresponding to any one of the multiple candidate prediction modes other than the IntraTMP-based prediction mode.

In some embodiments, the second determining part 2001 is further configured to: set a value of the first syntax element information to a first value if it is determined that the IntraTMP-based prediction mode is to be applied to the current block; or set the value of the first syntax element information to a second value if it is determined that the IntraTMP-based prediction mode is not to be applied to the current block.

In some embodiments, the second determining part 2001 is further configured to: determine second syntax element information if the prediction mode to be applied to the current block is the IntraTMP-based prediction mode, where the second syntax element information indicates an IntraTMP-based prediction mode to be applied to the current block; and encode the second syntax element information, and signalling obtained encoded bits into the bitstream.

In some embodiments, the second determining part 2001 is further configured to: determine a residual value of the current block according to the prediction value for the current block and an original value of the current block; and determine a reconstructed value of the current block according to the prediction value for the current block and the residual value of the current block.

In some embodiments, the encoding part 2002 is configured to: encode the residual value, and signal obtained encoded bits into the bitstream.

It can be understood that, in the embodiments, the term “part” can be a portion of circuit, a portion of a processor, a portion of a program or software, or can be modular or non-modular. In addition, various components described in various embodiments of the disclosure may be integrated into one processing unit or may be present as a number of physically separated units, and two or more units may be integrated into one. The integrated unit may take the form of hardware or a software functional unit.

If the integrated units are implemented in the form of software functional modules and are not sold or used as standalone products, they may be stored in a computer-readable storage medium. Based on such understanding, embodiments provide a computer-readable storage medium. The computer-readable storage medium is applied to an encoder 2000. The computer-readable storage medium stores computer programs which, when executed by a second processor, implement the method according to any of the foregoing embodiments.

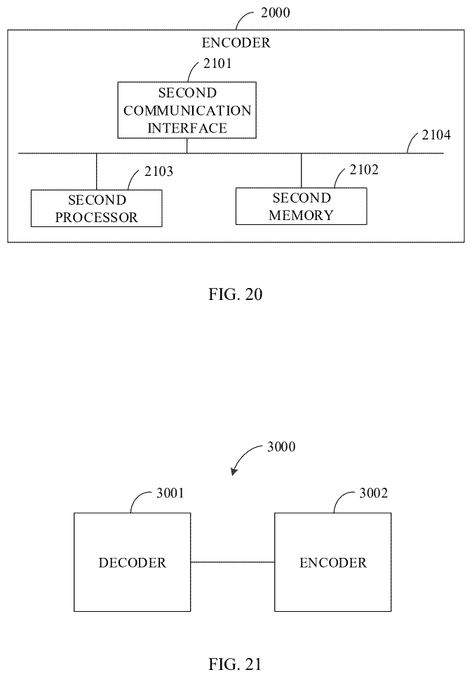

Based on the composition of the encoder 2000 and the computer-readable storage medium, referring to FIG. 20, FIG. 20 is a schematic diagram illustrating the hardware structure of the encoder 2000 provided in embodiments of the disclosure. As illustrated in FIG. 20, the encoder 2000 may include: a second communication interface 2101, a second memory 2102, and a second processor 2103. These components are coupled together via a second bus system 2104. It can be understood that, the second bus system 2104 is configured for connection and communication between these components. In addition to a data bus, the second bus system 2104 further includes a power bus, a control bus, and a status signal bus. However, for clarity of illustration, all buses are labeled as the second bus system 2104 in FIG. 20. The second communication interface 2101 is configured for signal reception and transmission during information reception and transmission with other external network elements. The second memory 2102 is configured to store computer programs executable by the second processor 2103. The second processor 2103 is configured to perform the following operations when running the computer programs: determine a prediction mode to be applied to a current block, and determine first syntax element information according to the prediction mode to be applied to the current block, where the first syntax element information indicates whether an IntraTMP-based prediction mode is to be applied to the current block; determine a first block vector candidate list for the current block if the prediction mode for the current block is the IntraTMP-based prediction mode, where the first block vector candidate list is determined according to a first candidate list constructed based on a template matching technology and/or a second candidate list constructed based on a merge candidate technology; determine a second block vector candidate list based on the first block vector candidate list, where the second block vector candidate list includes a relocated block vector constructed for a first candidate block vector in the first block vector candidate list; and determine a prediction value for the current block based on the second block vector candidate list.

Optionally, as another embodiment, the second processor 2103 is further configured to perform the encoding method according to any of the foregoing embodiments when running the computer programs.

It is understandable that, the hardware functionality of the second memory 2102 is similar to that of the first memory 1102, and the hardware functionality of the second processor 2103 is similar to that of the first processor 1103, which will not be elaborated in detail herein.

In another embodiment of the disclosure, referring to FIG. 21, which is a schematic structural diagram of a coding system provided in embodiments of the disclosure. As illustrated in FIG. 21, the coding system 3000 may include a decoder 3001 and an encoder 3002.

In embodiments of the disclosure, the decoder 3001 can be the decoder described in any one of the foregoing embodiments, and the encoder 3002 can be the encoder described in any one of the foregoing embodiments.

It should be noted that, in the disclosure, the terms “include”, “include”, or any other variants thereof are intended to cover non-exclusive inclusion. This means that a process, method, article, or apparatus that includes a series of elements not only includes those elements but may further include other elements not explicitly listed, or further include elements inherent to such process, method, article, or apparatus. In the absence of more limitations, an element defined by the phrase “include/include a . . . ” does not exclude the existence of additional identical elements in the process, method, article, or apparatus that includes said element.

The serial numbers in embodiments of the disclosure are merely for illustrative purposes and do not represent the superiority or inferiority of the embodiments.

The methods disclosed in the several method embodiments provided in the disclosure may be arbitrarily combined without conflict to obtain new method embodiments.

The features disclosed in the several product embodiments provided in the disclosure may be arbitrarily combined without conflict to obtain new product embodiments.

The features disclosed in the several method or device embodiments provided in the disclosure may be arbitrarily combined without conflict to obtain new method embodiments or device embodiments.

The foregoing elaborations are merely implementations of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of embodiments of the disclosure.

### INDUSTRIAL APPLICABILITY

In embodiments of the disclosure, a decoding method, an encoding method, a bitstream, a decoder, an encoder, and a storage medium are provided. At a decoding end, a bitstream is parsed to determine first syntax element information. If the first syntax element information indicates that an Intra template matching prediction (IntraTMP)-based prediction mode is to be applied to a current block, a first block vector candidate list for the current block is determined, where the first block vector candidate list is determined according to a first candidate list constructed based on a template matching technology and/or a second candidate list constructed based on a merge candidate technology. A second block vector candidate list is determined based on the first block vector candidate list, where the second block vector candidate list includes a relocated block vector(s) constructed for a first candidate block vector(s) in the first block vector candidate list. A prediction value for the current block is determined based on the second block vector candidate list. At an encoding end, a prediction mode to be applied to a current block is determined, and first syntax element information is determined according to the prediction mode to be applied to the current block, where the first syntax element information indicates whether an IntraTMP-based prediction mode is to be applied to the current block. A first block vector candidate list for the current block is determined when the prediction mode for the current block is the IntraTMP-based prediction mode, where the first block vector candidate list is determined according to a first candidate list constructed based on a template matching technology and/or a second candidate list constructed based on a merge candidate technology. A second block vector candidate list is determined based on the first block vector candidate list, where the second block vector candidate list includes a relocated block vector constructed for a first candidate block vector in the first block vector candidate list. A prediction value for the current block is determined based on the second block vector candidate list. As such, on one hand, by constructing a relocated block vector for each first candidate block vector in the first block vector candidate list to determine the second block vector candidate list, further refinement or adjustment of the first candidate block vectors in the first block vector candidate list is achieved. As such, it is possible to improve diversity of candidate block vectors, improve accuracy in describing motion information, and improve accuracy of motion estimation. In addition, by determining the first block vector candidate list according to the first candidate list constructed based on the template matching technology and/or the second candidate list constructed based on the merge candidate technology, diversity of candidate lists can be improved, which is beneficial for subsequent extension of candidate block vectors. As such, appropriate block vectors can be selected more effectively during coding, which improves diversity of candidate block vectors, reduces transmission of redundant information, and thus improves coding efficiency.

What is claimed is:

1. A decoding method, applied to a decoder and comprising:
parsing a bitstream to determine first syntax element information;
determining at least one first block vector candidate for a current block when the first syntax element information indicates that a template matching prediction (TMP)-based prediction mode is to be applied to the current block, wherein the at least one first block vector candidate is determined according to a first type of candidate determined based on template matching and/or a second type of candidate determined based on a merge candidate;
determining at least one second block vector candidate based on the at least one first block vector candidate, wherein the at least one second block vector candidate comprises a relocated block vector constructed for a first candidate in the at least one first block vector candidate; and
determining a prediction value for the current block based on the at least one second block vector candidate.

2. The method of claim 1, wherein determining the at least one second block vector candidate based on the at least one first block vector candidate comprises:
determining first candidates from the at least one first block vector candidate, wherein the first candidates are all or some candidates in the at least one first block vector candidate; and
performing relocated block vector construction on the first candidates to obtain the at least one second block vector candidate.

3. The method of claim 2, wherein performing relocated block vector construction on the first candidates to obtain the at least one second block vector candidate comprises:
determining, from the first candidates, guiding block vectors that satisfy a first preset condition; and
adding relocated block vectors corresponding to the guiding block vectors to the at least one second block vector candidate.

4. The method of claim 3, further comprising:
for any current guiding block vector in the guiding block vectors, determining a relocated block vector corresponding to the current guiding block vector according to a current reference block and/or a current block corresponding to the current guiding block vector; and
determining, from the relocated block vectors corresponding to the guiding block vectors for a current round, a guiding block vector for a next round that satisfies the first preset condition, to obtain a next updated at least one second block vector candidate until the guiding block vector for the next round satisfies a second preset condition, and taking the last updated at least one second block vector candidate as the at least one second block vector candidate.

5. The method of claim 4, wherein determining the relocated block vector corresponding to the current guiding block vector according to the current reference block and/or the current block corresponding to the current guiding block vector comprises:
offsetting the current guiding block vector according to the current reference block and/or the current block, to obtain a guiding block offset vector corresponding to the current guiding block vector; and
determining the relocated block vector corresponding to the current guiding block vector based on the guiding block offset vector.

6. The method of claim 5, wherein the guiding block offset vector comprises one or more of:
a first guiding block offset vector, wherein the first guiding block offset vector indicates a first candidate reference block located at a center position of the current reference block;
a second guiding block offset vector, wherein the second guiding block offset vector indicates a second candidate reference block located at a top-left position of the current reference block;
a third guiding block offset vector, wherein the third guiding block offset vector indicates a third candidate reference block located at a bottom-left position of the current reference block;
a fourth guiding block offset vector, wherein the fourth guiding block offset vector indicates a fourth candidate reference block located at a top-right position of the current reference block; or
a fifth guiding block offset vector, wherein the fifth guiding block offset vector indicates a fifth candidate reference block located at a bottom-right position of the current reference block.

7. The method of claim 5, wherein determining the relocated block vector corresponding to the current guiding block vector based on the guiding block offset vector comprises:
determining a current guiding block offset vector from the guiding block offset vector; and
when the current guiding block offset vector is available, determining a relocated block vector corresponding to the current guiding block offset vector according to a block vector for a candidate reference block corresponding to the current guiding block offset vector, wherein the relocated block vector corresponding to the current guiding block offset vector is one of the relocated block vectors corresponding to the current guiding block vector; or
when the current guiding block offset vector is unavailable, skipping the current guiding block offset vector and determining a next guiding block offset vector from the guiding block offset vector.

8. The method of claim 7, wherein determining the relocated block vector corresponding to the current guiding block offset vector according to the block vector for the candidate reference block corresponding to the current guiding block offset vector comprises:
when a bi-predictive IBC mode is to be applied to the candidate reference block, determining a first reference block vector and a second reference block vector corresponding to the candidate reference block;
performing vector addition on the first reference block vector and the current guiding block vector to determine a first relocated block vector corresponding to the current guiding block offset vector; and
performing vector addition on the second reference block vector and the current guiding block vector to determine a second relocated block vector corresponding to the current guiding block offset vector.

9. The method of claim 7, further comprising:
determining that the current guiding block offset vector is available when one or more of the following conditions are satisfied: the current guiding block offset vector exists; a candidate reference block indicated by the current guiding block offset vector is reconstructed; a template cost value corresponding to the current guiding block offset vector is less than or equal to a first threshold; the candidate reference block indicated by the current guiding block offset vector is within a preset range; or a prediction mode for the candidate reference block indicated by the current guiding block offset vector is an IBC mode or a TMP mode; or
determining that the current guiding block offset vector is unavailable when one or more of the following conditions are satisfied: the current guiding block offset vector does not exist;
the candidate reference block indicated by the current guiding block offset vector is not reconstructed; the template cost value corresponding to the current guiding block offset vector is greater than the first threshold; the candidate reference block indicated by the current guiding block offset vector is not within the preset range; or the prediction mode for the candidate reference block indicated by the current guiding block offset vector is not an IBC mode or a TMP mode.

10. The method of claim 3, wherein the first preset condition comprises one or more of:
a template cost value corresponding to a guiding block vector is less than or equal to a second threshold, wherein the second threshold is obtained according to template cost values corresponding to block vectors added in the at least one first block vector candidate and/or the at least one second block vector candidate;
a reference block corresponding to the guiding block vector is reconstructed;
a reference block corresponding to the guiding block vector does not exceed a search range for TMP; or
the reference block corresponding to the guiding block vector does not exceed a search range for an IBC mode.

11. The method of claim 3, wherein the second preset condition comprises one or more of:
the next round exceeds or reaches an iteration threshold;
the number of guiding block vectors for the next round is less than or equal to a third threshold;
a template cost value corresponding to each of at least one guiding block vector in the guiding block vectors for the next round is greater than or equal to a fourth threshold; or
a number of the next updated at least one second block vector candidate corresponding to the next round is greater than or equal to a maximum list-length threshold.

12. The method of claim 1, wherein the at least one first block vector candidate comprises any one of:
a first type of candidate, wherein the first type of candidate is determined by performing template matching within a preset search range corresponding to the current block;
a second type of candidate, wherein the second type of candidate is determined by merging block vectors corresponding to one or more candidate blocks having similar motion to the current block; or
a third type of candidate, wherein the third type of candidate is determined based on the first type of candidate and the second type of candidate.

13. The method of claim 1, wherein determining the at least one first block vector candidate for the current block comprises:
determining the first type of candidate, and taking the first type of candidate as the at least one first block vector candidate;
wherein determining the first type of candidate comprises:
searching within a preset search range at a preset step size to obtain first matching block vectors;
determining, from the first matching block vectors, a first block vector having the smallest template cost; and
determining the first type of candidate according to the first block vector.

14. The method of claim 1, wherein determining the at least one first block vector candidate for the current block comprises:
determining the second type of candidate, and taking the second type of candidate as the at least one first block vector candidate;
wherein determining the second type of candidate comprises:
determining the second type of candidate according to second block vectors, wherein a matching block corresponding to each of the second block vectors has similar motion to the current block.

15. The method of claim 1, wherein determining the prediction value for the current block based on the at least one second block vector candidate comprises:
parsing a bitstream to determine second syntax element information;
performing template matching on second candidates in the at least one second block vector candidate to obtain at least one third block vector candidate; and
determining the prediction value for the current block according to a TMP-based prediction mode to be applied to the current block indicated by the second syntax element information and the at least one third block vector candidate.

16. The method of claim 1, wherein parsing the bitstream to determine the first syntax element information comprises:
when a value of the first syntax element information is a first value, determining that the TMP-based prediction mode is to be applied to the current block; or
when the value of the first syntax element information is a second value, determining that the TMP-based prediction mode is not to be applied to the current block.

17. An encoding method, applied to an encoder, the method comprising:
determining a prediction mode to be applied to a current block, and determining first syntax element information according to the prediction mode to be applied to the current block, wherein the first syntax element information indicates whether a template matching prediction (TMP)-based prediction mode is to be applied to the current block;
determining at least one first block vector candidate for the current block when the prediction mode for the current block is the TMP-based prediction mode, wherein the at least one first block vector candidate is determined according to a first type of candidate determined based on template matching and/or a second type of candidate determined based on a merge candidate;
determining at least one second block vector candidate based on the at least one first block vector candidate, wherein the at least one second block vector candidate comprises a relocated block vector constructed for a first candidate in the at least one first block vector candidate; and
determining a prediction value for the current block based on the at least one second block vector candidate.

18. The method of claim 17, wherein determining the at least one second block vector candidate based on the at least one first block vector candidate comprises:
determining first candidates from the at least one first block vector candidate, wherein the first candidates are all or some candidates in the at least one first block vector candidate; and
performing relocated block vector construction on the first candidates to obtain the at least one second block vector candidate.

19. The method of claim 18, wherein performing relocated block vector construction on the first candidates to obtain the at least one second block vector candidate comprises:
determining, from the first candidates, guiding block vectors that satisfy a first preset condition; and
adding relocated block vectors corresponding to the guiding block vectors to the at least one second block vector candidate.

20. A non-transitory computer-readable storage medium storing a computer program and a bitstream, wherein when executed by a processor, the computer program causes the processor to implement an encoding method to generate the bitstream, the encoding method comprising:
determining a prediction mode to be applied to a current block, and determining first syntax element information according to the prediction mode to be applied to the current block, wherein the first syntax element information indicates whether a template matching prediction (TMP)-based prediction mode is to be applied to the current block;
determining at least one first block vector candidate for the current block when the prediction mode for the current block is the TMP-based prediction mode, wherein the at least one first block vector candidate is determined according to a first type of candidate determined based on template matching and/or a second type of candidate determined based on a merge candidate;
determining at least one second block vector candidate based on the at least one first block vector candidate, wherein the at least one second block vector candidate comprises a relocated block vector constructed for a first candidate in the at least one first block vector candidate; and
determining a prediction value for the current block based on the at least one second block vector candidate.
